(19) United States
(12) Patent Application Publication
(10) Pub. No.: US 2017/0161625 A1
(43) Pub. Date: Jun. 8, 2017

(54) INTEGRATIVE SOFTWARE SYSTEM, DEVICE, AND METHOD

(71) Applicant: Physical Optics Corporation, Torrance, CA (US)

(72) Inventors: Tomasz Jannson, Torrance, CA (US); Wenjian Wang, Torrance, CA (US); Thomas Forrester, Hacienda Heights, CA (US); Andrew Kostrzweski, Garden Grove, CA (US); Joanna Jannson, Torrance, CA (US); Thomas Nielsen, Torrance, CA (US); Christian Veeris, Torrance, CA (US)

(73) Assignee: Physical Optics Corporation, Torrance, CA (US)

(21) Appl. No.: 15/442,370

(22) Filed: Feb. 24, 2017

Related U.S. Application Data
(62) Division of application No. 14/147,247, filed on Jan. 3, 2014.
(60) Provisional application No. 61/780,695, filed on Mar. 13, 2013.
(60) Provisional application No. 61/808,514, filed on Apr. 4, 2013.

(51) Int. Cl. G06N 7/00; G06F 17/16

(52) U.S. Cl. CPC G06N 7/00; G06F 17/16

(57) ABSTRACT

A non-transitory computer readable medium for storing one or more sequences of one or more instructions for execution by one or more processors in a processing system to perform a method for determining a dichotomy for a parametric decision process, the instructions when executed by the one or more processors are presented. Embodiments can be configured to define a network having a plurality of members as inter-member coherency coupling represented by elements of a coherency matrix, wherein for each i^{th} member the network includes an intensity value, Iᵢ. Further embodiments may include determining non-diagonal elements Tᵢⱼ of the coherency matrix in which i≠j and in which i and j represent i^{th} and j^{th} members of the network, and constructing diagonal kernels Kᵢ or non-diagonal kernels Hᵢ based on the non-diagonal elements Tᵢⱼ of the coherency matrix and intensity values (Iᵢ) of the members.

### CROSS-REFERENCE TO RELATED APPLICATIONS

This application is a divisional application of U.S. patent application Ser. No. 14/147,247, filed Jan. 3, 2014, which claims the benefit of U.S. Provisional Application Nos. 61/780,695, titled Bayesian Inter-cloud Coherency System and Method and filed on Mar. 13, 2013; and 61/808,514, titled Bayesian Inter-cloud Coherency System and Method and filed on Apr. 4, 2013.

### TECHNICAL FIELD

The present invention relates generally to detection and prediction systems, and more particularly, some embodiments relate to systems and methods for adverse network detection.

### DESCRIPTION OF THE RELATED ART

Conventional Artificial Intelligence (AI) software systems used to identify adverse networks, such as organized crime networks, or IED (Improvised Explosive Device) networks, for example, are typically based on some kind of statistical passive code analysis and machine learning solution. Others use computer database structurization. In general, such software systems can be either “probabilistic,” or “logicist,” or some combination of both. In the case of probabilistic networks, such as Bayesian networks, for example, the usual challenge faced is the “actionality” problem—i.e., actional impotency. That is, although data knowledge is collected by such systems, there is no action methodology leading to a machine-learned conclusion or result. On the other hand, in the case of logicist networks, there are often contradictions and difficulties separating hard facts (e.g., facts that must be true) from soft facts (e.g., data or information that may be true).

In addition, conventional approaches using AI systems not only suffer from the division between probabilistic and logicist approaches to AI, but also from a controversy between Bayesian and Dempster-Shafer inferences. Bayesian inferences are generally used for exclusive events, while Dempster-Shafer inferences are generally used for correlated events, respectively. Furthermore, there is a fundamental challenge between correlation and causation of facts. A still further challenge arises when dealing with non-monotonic events (i.e., events contradictory to previous experience).

Historically, artificial intelligence and intelligent computing have been verified by the so-called Turing's test; i.e., a successful intelligent machine (computer) communicating with a human (either by voice, by playing some game, or in some other way) should be not recognizable from communication between humans. So far, several machines have passed the Turing test, including the IBM computer “Deep Blue” as a champion-level chess player, as well as a number of machine-learned card players (in hearts, bridge, etc.). In medicine, computer-based network structures based on binary databases have been developed to evaluate patient symptoms and diagnose conditions. Based on sophisticated mathematics and Monte Carlo simulations, these networks have been able to identify hidden variables in the causal chain. They have been restricted to a very limited number of variables, however.

More success has been achieved using neural networks with the ability for effective pattern recognition. These, for example, are systems based on training of synaptic weights. Such training, however, has been based on “black box” principles with no insight to synaptic buildup internal mechanisms.

Therefore, although AI machine-learning has been successful, its successes have been somewhat limited to rather narrow context cases, where the Concept of Operations (CONOPS), or the field of application has been heavily restricted. One of the typical difficulties encountered is a difficulty correlating between various causes. This has led to a redundancy problem with elements such as: improper handling of bidirectional inference; difficulties in retracting conclusions (due to non-monotonic events, for example); improper treatment of correlated sources of evidence, etc. In parallel, however, recent technological advances in parallel computation, natural language processing (NLP), and in object-oriented computer languages, such as: C++ and Java, have stimulated interest in viewing a network not merely as passive code for sorting factual knowledge, but also as a computational architecture (heuristic) reasoning about that knowledge.

### BRIEF SUMMARY OF THE EMBODIMENTS

The technology disclosed herein relates to Integrative Software System (ISS) technology, which in various embodiments combines two AI schools: probabilistic and logicist, together with Bayesian Inference and Binary Sensing, in the form of Bayesian Truthing Inference (BTI). The ISS, which can include digital decision generation tools, can be configured to detect, recognize and identify adverse networks by detecting Bayesian anomalous events, or BAEVENTS, in cyberspace, through the inspection of professional (or pseudo-professional) databases, or PRO-CLOUDS (could also be referred to as “CYBER-CLOUDS”).

In various embodiments, a discrete truthing space can be included with targets that might be of interest—referred to as High Value Individual Candidates (HVICs)—as sample units, and targets that are confirmed by the system as targets of interest—referred to as High Value Individuals (HVIs). In the examples provided herein, these targets can be individuals (e.g., people), while in other embodiments, targets can be other entities. Various embodiments can be configured to evaluate data and information about HVICs to determine whether they are actually HVIs.

The ISS architecture can, in some embodiments, be configured as a chain structure with elemental tasks as its nodes. It can be configured with two or more software engines. For example, in the case of two engines, one may be an intra-cloud engine, and the other an inter-cloud engine. In various embodiments, these can be supported by multiple (e.g., 2, 3, 4, a dozen, or more) supportive elemental tasks (modules).

The ISS chain can be fully actionable and can be configured to avoid the correlation/causation contradiction by applying a natural binary sensor scheme that is unidirectional, with a well-defined causation relation. This scheme can be based exclusively on sensor events and readouts (thus, avoiding correlation problems). There can also be an intra-cloud software engine (e.g., to select HVIs as yellow alarms), in parallel with a 2^{nd} inter-cloud graph (software) engine for selecting cyber networks. Such cyber networks can be, for example, in the form of graphitis (defined in Section 2.2).

A Compound Association Identifier (CAI) can be included to identify parameters of interest (e.g., cyberphone numbers or other parameters) obtained from multiple engines, in parallel, as belonging to the same target candidates (e.g. for the same HVIC). For example, multiple engines working in parallel evaluating different data (e.g. 1 intra-cloud and the other inter-cloud) using different inferences can arrive at the same conclusion that a target candidate is one of interest. This can result in a target candidate being identified as a target or high value individual. In some embodiments, when this occurs, this can result in a red-alarm, or a flag associated with that individual, or other alert. In other embodiments, a higher level of alert may be required before reaching such a red-alarm state. In such embodiments, the alert generated as a result of 2 engines working in parallel may be an orange alarm or other mid-level alert. As will be apparent to one of ordinary skill in the art after reading this description, multiple levels of alarms can be utilized depending on the level of correlation.

The ISS can, in some embodiments, be fully autonomous, or semi-autonomous. The semi-autonomous system can be implemented working with the help of experts. The ISS intra-cloud software engine can be configured to work with the support of Object-Oriented-Rules (OORs), which in various embodiments are mini-computer-programs, developed in an Object-Oriented-Language such as Java, C++, or others.

Both engines can also be configured to work with the support of two novel computer tools: a Network Synthesizer System (NSS), and a Context-based Synonymous Object (CONSYN) scheme. While the OORs are non-heuristic, they can produce intra, or inter columns of daughter-OORs, or DOORs, which as heuristic OORs, can be developed semi-automatically, or automatically. The ISS can also be configured to provide automatic machine (heuristic) learning, as well as intra-cloud and inter-cloud feedback to maximize system performance, by minimizing its cost function using basic Bayesian Figures of Merit, such as, for example Positive Predictive Value (PPV). This training process can be provided in a macroscopic and microscopic way, the latter avoiding “black box” limitation. In addition to the above outer (inter-network) concept, the novel complementary inner (intra-network) concept can also be addressed.

PPVs can be automated (e.g., based on past information and positive hits, without human intervention), or they may be based at least in part on human-supplied information, such as, for example, a human score. PPV scores can provide a ‘confidence factor’ in the identification of an HVIC as an HVI.

Inner Networks.

It should be noted that the adverse networks, such as terrorist and organized crime networks, represent groups that are non-adverse from an intra-group perspective. That is, within the group the members are not typically adverse to one another. From this perspective, they can be considered as inner networks, where the decision process modeling is important. This is also addressed by the technology disclosed herein, based on a so-called moral skew factor, and parametric decision process, as explained in Sections 1, 3 and 7, and in FIG. 48 and Table 1.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to specific spatial orientations, such references are merely descriptive and do not imply or require that the invention be implemented or used in a particular spatial orientation unless explicitly stated otherwise.

FIG. 1 is a diagram depicting an exemplary Integrative Software System logic scheme with an intra-cloud engine and a graphiti engine.

FIG. 2 is a diagram depicting exemplary graphitis.

FIG. 3 is a diagram depicting Bayesian inter-cloud coherency.

FIG. 4 is a diagram depicting an Integrative Software System chain structure with an intra-cloud engine and an inter-cloud engine.

FIG. 5 is a diagram depicting a heuristic learning chain sub-structure.

FIG. 6 is a diagram depicting an intra-cloud engine producing output using a plurality of cybersensors and associated readout sub-modules.

FIG. 7 is a diagram depicting two exemplary High Value Individual (HVI) recommendation processes based on Figure of Merit (FoM) values.

FIG. 8 is a diagram depicting AND and OR logic operations using set theory.

FIG. 9 is a diagram depicting OR and XOR logic operations using Boolean algebra.

FIG. 10 is a diagram depicting modulo-algebras, including: (a) an example of modulo-2 (Boolean) algebra; and (b) an example of modulo-7 algebra.

FIG. 11 is a diagram depicting an exemplary process creating a Daughter Object-Oriented Rule (DOOR) by applying Boolean logic to Object-Oriented Rules (OORs).

FIG. 12 is a diagram depicting another exemplary process creating a Daughter DOOR by applying Boolean logic to OORs.

FIG. 13 is a diagram depicting an exemplary process creating a DOOR by applying Boolean logic to two other DOORs and an equivalent logic circuit.

FIG. 14 is a diagram depicting a Context-based Synonymous Object (CONSYN) sub-system and algorithm.

FIG. 15 is a diagram depicting a Network Synthesizer System (NSS) structure at a 1^{st} layer and a 2^{nd} layer of description.

FIG. 16 is a diagram depicting a NSS structure at a 3^{rd} layer of description.

FIG. 17 is a diagram depicting an exemplary compound association process.

FIG. 18 is a chart depicting an exemplary time event correlation.

FIG. 19 is a graph depicting an exemplary social network.

FIG. 20 is a coherency matrix for N=3.

FIG. 21 is a graph depicting normal parametric order for N=3.

FIG. 22 is a graph depicting normal parametric order.

FIG. 23 is a graph depicting the NPO (Normal Parametric Order) case for N=3.

FIG. 24 is a coherency matrix with elements defined by equations 21a-c.

FIG. 25 is a diagram depicting inter-group coherency.

FIG. 26 is a diagram depicting causation for a Binary Sensor.

FIG. 27 is a graph depicting the Bayesian Paradox.

FIG. 28 is a diagram depicting Bayesian truthing sets.

FIG. 29 is a diagram depicting a Lossless Multi-Alarm (LMA) method.

FIG. 30 is a graph depicting (a) Positive Predictive Values (PPVs) over time and (b) a Cost Function (CF) over time during a training process.

FIG. 31 is a diagram depicting a dual engine connection method.

FIG. 32 is graph depicting an example of a relation between i-indexing and l-indexing during a parametric decision process.

FIG. 33 is a diagram depicting multi-dimensional decision space generalizations from: (a) single parametric space into (b) a multitude of parametric spaces.

FIG. 34 is an example (RISK)-parametric decision scale.

FIG. 35 is a diagram depicting an exemplary parametric ensemble.

FIG. 36 is a diagram depicting a simple parametric prognosis.

FIG. 37 is a diagram depicting a logic structure for a Parametric Cost Function (PCF) construction.

FIG. 38 is a diagram depicting a logic structure for Parametric Intensity Prognosis.

FIG. 39 is a diagram depicting a Parametric Decision Ensemble (PDE) architecture.

FIG. 40 is a diagram depicting PDE phenomenology.

FIG. 41 is a diagram depicting a thermodynamics gas analogy to a PDE.

FIG. 42 is a diagram depicting a comparison in 2D-space of: (a) a PDE orthogonal base and (b) a non-orthogonal base.

FIG. 43 is a diagram depicting a scales product of two parametric decision vectors.

FIG. 44 is a diagram depicting a parametric decision and kernel unit vectors' scalar product defined in orthogonal unit vector base.

FIG. 45 is a diagram depicting a parametric decision and kernel unit vectors' scalar product defined in non-orthogonal unit vector base.

FIG. 46 is a graph depicting quantitative analysis of a moral skew factor.

FIG. 47 is a diagram depicting network inner coherency.

FIG. 48 is a graph depicting geometric modeling of non-diagonal kernel vector algebra.

FIG. 49 is a diagram illustrating an exemplary computing module that may be used to implement any of the embodiments disclosed herein.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION

Table of Contents

| Section 1: | | ISS Inner and Outer Network Structures | 17 |
|---|---|---|---|
| | 1.1 | Network Inner and Outer Structures Summary | 17 |

| | | |
|---|---|---|
| 1.1.1 | The Importance of Outer and Inner Network Structures | 17 |
| 1.1.2 | An example role for the Moral Skew Factor Help in | 18 |
| | Network Surveillance | |
| 1.1.3 | Use of a Parametric Decision | 19 |
| 1.1.4 | Differentiation Between the Coherency Matrix and the | 19 |
| | Moral Skew Factor | |
| 1.1.5 | Role of Inter-Ego and Intra-Ego Kernel Elements | 20 |
| 1.1.6 | Role of Correlation (Coherence) and Experts in Inner and | 20 |
| | Outer Network Structures | |
| 1.1.7 | Geometry of Non-Diagonal Kernel Algebra | 21 |
| 1.1.8 | Role of Mathematics in the Integrative Software System | |
| | (ISS) 23 | |
| 1.1.9 | Reduction and Re-Normalization of Unit Vector Bases | 23 |
| 1.1.10 | Radicalization Level as Decision Parameter | 24 |
| 1.1.11 | Comparison Summary | 25 |

| Section 2: | | Example ISS Concepts, Components and Architecture (Outer | 26 |
|---|---|---|---|
| | | Network) | |
| | 2.1 | ISS Logic Scheme | 26 |
| | 2.2 | Graphitis | 27 |
| | 2.3 | System Architecture | 28 |
| | 2.4 | ISS Cyberspace, Truthing (Sample) Space and System Envelope | 29 |
| Section 3: | | Example System Chain Structure (Outer and Inner Network) | 31 |
| | 3.1 | System Chain Structure | 31 |
| | 3.2 | System Engines and Feedback | 33 |
| | 3.3 | Intra-Cloud Engine Set | 34 |
| | 3.4 | HVI Recommendation Process | 35 |
| | 3.5 | Object-Oriented Rules | 38 |
| | 3.6 | DOORs based on AND-operation | 40 |
| | 3.7 | Context-Based Synonymous Object | 42 |
| | 3.8 | Link Analysis (Network Synthesizer System) | 45 |
| | 3.9 | Compound Association Identifier and Identification (ID) Method | 47 |
| | 3.10 | Clock Anomaly | 48 |
| | 3.11 | Parametric Decision and Coherent Coupling | 50 |

| | | |
|---|---|---|
| 3.11.1 | Mathematical Model | 52 |
| 3.11.2 | Anomalous Coupling | 57 |
| 3.11.3 | Dynamic Coupling | 58 |
| 3.11.4 | Inter-Group Coupling | 59 |

| Section 4: | | Bayesian Truthing Inference (Outer Network) | 60 |
|---|---|---|---|
| | 4.1 | Bayesian Inference and Binary Sensors | 60 |
| | 4.2 | Positive Predictive Value and Bayesian Paradox | 62 |
| | 4.3 | Bayesian Truthing | 64 |

| | | |
|---|---|---|
| 4.3.1 | Truthing Sampling Space | 64 |

| | 4.4 | Bayesian Truthing Theorem (BTT) | 67 |
|---|---|---|---|
| | 4.5 | Analogy between X-Ray Luggage Inspection and the ISS | 68 |
| | 4.6 | Numerical Examples Illustrating ISS Bayesian Truthing | 69 |
| | 4.7 | Relations Between Non-Diagonal Statistical and Truthing | 72 |
| | | Parameters | |
| | 4.8 | Lossless Multi-Alarm Method | 74 |
| Section 5: | | System Performance Components (Outer Network) | 75 |
| | 5.1 | Cost Function | 75 |
| | 5.2 | System Feedback | 77 |
| | 5.3 | Dual Engine Connection | 78 |
| Section 6: | | Network Inner Coherency (Inner Network) | 80 |
| | 6.1 | Inner Network Coherency | 80 |
| | 6.2 | Comparison of Diagonal and Non-Diagonal Kernel Vectors | 82 |
| | 6.3 | Moral Skew Effect and Psychoanalysis | 83 |
| Section 7: | | Inner Network Analysis (Inner Network) | 84 |
| | 7.1 | Inter-Adverse vs. Intra-Friendly | 84 |
| | 7.2 | Parametric Statistical Ensemble | 85 |
| | 7.3 | Parametric Prognosis | 89 |

| | | |
|---|---|---|
| 7.3.1 | Parametric Intensity Prognosis | 90 |

| | | |
|---|---|---|
| 7.4 | Coherent Coupling Engineering | 91 |
| 7.5 | Application Scenarios for PDE Systems | 94 |
| 7.6 | Phenomenology of PDE System | 99 |

| | | |
|---|---|---|
| 7.6.1 | Origin of the systems and methods described herein | 99 |
| 7.6.2 | Thermodynamic Gas Analogy | 101 |
| 7.6.3 | Moral Sociology Analogy | 104 |

| | | |
|---|---|---|
| 7.7 | Moral Skew Factor | 106 |

| | | | |
|---|---|---|---|
| | 7.7.1 | Inter-Ego vs. Intra-Ego | 106 |
| | 7.7.2 | Unit Vector Bases | 107 |
| | 7.7.3 | Primary Color Analogies | 107 |
| | 7.7.4 | Scalar Product of Parametric Decision and Kernel Unit | 108 |
| | | Vectors | |
| | 7.7.5 | Scalar Product of Parametric Decision and Kernel Vectors | 110 |
| | 7.7.6 | Diagonal and Non-Diagonal Kernel Vectors | 110 |
| | 7.7.7 | Quantitative Analysis of the Moral Skew Factor | 114 |
| Section 8: | | Example Computer Program Product Embodiments | 116 |

Section 1: ISS Inner and Outer Network Structures

1.1 Network Inner and Outer Structures Summary

This Section discusses both inner and outer network structures, which can be viewed in some contexts as “different sides of the same coin.” The outer and inner network structures are each discussed in greater detail in later Sections of this document.

1.1.1 the Importance of Outer and Inner Network Structures

As described above, although adverse (or, hostile) networks such as terrorist and organized crime networks may be externally adverse, internally, they may not be adverse because the network members often cooperate among themselves to achieve their objectives. Therefore, any network, whether or not adverse, has some internal dynamics, which can influence its efficiency. In particular, a higher level of coherency between adverse-network members typically leads to a more successful network operation. Also, surveillance of such adverse networks may be difficult due to legal constraints. Accordingly, an understanding of the motivation of network members (Groups of Interest, or individuals) typically does help in network surveillance and improves prognostics of their action. The Inner Network structure taxonomy typically includes a network (group) and network members. As also described above, the network members may be either individuals, or sub-groups referred to as Groups of Interest (GOIs).

1.1.2 an Example Role for the Moral Skew Factor Help in Network Surveillance

As stated above, “people see us differently from how we see ourselves.” Therefore, processes in various embodiments can be implemented with an understanding as to why people make certain decisions (preferably, without asking them about it). Accordingly, with this understanding, the system can better predict the actions of these individuals in general, and some hostile operations, in particular. The moral skew factor is a mathematical tool that may be used to predict, or better prognose such decision. This can be accomplished, for example, by adding a vectorial scalar product into network coherence coupling modeling.

1.1.3 Use of a Parametric Decision

The network decision process in various embodiments can be difficult to present in mathematical form for a generalized case. Therefore, to aid in the reader's understanding, it is presented herein in terms of a specific context or example. By introducing a Parametric Decision Ensemble (PDE) (i.e., by adding a statistical ensemble, which specifies a class of decisions that can be described by the same decision parameter), various embodiments can be presented to preserve both specificity and maximum generality within the network decision process.

1.1.4 Differentiation Between the Coherency Matrix and the Moral Skew Factor

The Moral Skew Effect (MSE) in general, and the moral skew factor in particular, describe a moral dichotomy between the Freudian super-ego (or ISS inter-ego) and the Freudian id (or ISS intra-ego). This may be manifested in various embodiments by moral tastes (or, senses), and self-interest tastes (or, senses). The moral skew factor is defined as cos(θᵢ) where θᵢ is the angle between unit vectors and \hat{k}ᵢ in which ŝᵢ represents a parametric decision, Sᵢ, and \hat{k}ᵢ represents coherent couplings. It can be assumed that ŝᵢ is inclinated into intra-ego (self-interest), while \hat{k}ᵢ is inclinated into inter-ego moral senses (tastes). As such, cos(θᵢ) is projected, globally, onto all network members, while coherency matrix elements, Tᵢⱼ, are specific for each network member.

1.1.5 Role of Inter-Ego and Intra-Ego Kernel Elements

Eq. (142) in Section 7.76, below, defines a non-diagonal kernel vector, \vec{H}ᵢ, which is characterized by two unit vectors, intra-ego-vector, ŝᵢ, and inter-ego-vector, \hat{k}ᵢ (the name “non-diagonal” is related to “kernel,” not to “vector”). The scalar, Gᵢ, is described by both intra-ego intensities, Iᵢ, and inter-ego non-diagonal coherency matrix elements, Rᵢⱼ, as in Eq. (141), also in paragraph [0366].

1.1.6 Role of Correlation (Coherence) and Experts in Inner and Outer Network Structures

Because the outer network ISS structure may be either automated or semi-automated, it is preferably configured to avoid dichotomy between correlation and causation. Therefore, in various embodiments it is based on a non-correlated binary sensor chain structure in which anomalous events are separated from regular events (binary sensors are based on exclusive (non-correlated) events). The outer ISS system in various embodiments has two separate software engines, the intra-cloud engine and the inter-cloud engine. These can be configured, for example, such that the 1^{st} software engine does not avoid un-correlated events, while the 2^{nd} software engine uses correlated events.

In contrast, the inner network ISS structure is heavily based on experts' involvement, which can be used, for example, to determine Tᵢⱼ, and cos(θᵢ)-values, in which correlation, or coherent coupling is the predominant effect. However, the role of experts is not necessarily supervisory and may be advisory, while the network mathematical structure can be configured to provide a supervision process itself.

1.1.7 Geometry of Non-Diagonal Kernel Algebra

This mathematical section describes relationships between geometry and algebra of a non-diagonal kernel, Gᵢ, defined by Eq. (143), where the non-diagonal kernel pseudo-vector (the term “pseudo” describes the fact that only part of the kernel \vec{H}ᵢ vector is included, but \vec{G}ᵢ is still a vector itself) \vec{G}ᵢ, is:

\vec{G}ᵢ=\hat{k}ᵢGᵢ (1)

We also define the intensity vector, \vec{I}ᵢ, which, according to Eq. (3), is

\vec{I}ᵢ=ŝᵢIᵢ. (2)

We see that scalar product of these vectors, is

\vec{G}ᵢ·\vec{I}ᵢ=\hat{k}ᵢ·ŝᵢGᵢIᵢ=GᵢIᵢ cos θᵢ (3)

while non-normalized weight, Wᵢ, of the weighted average mean of parametric decision, Sᵢ, has according to Eq. (141) the following form:

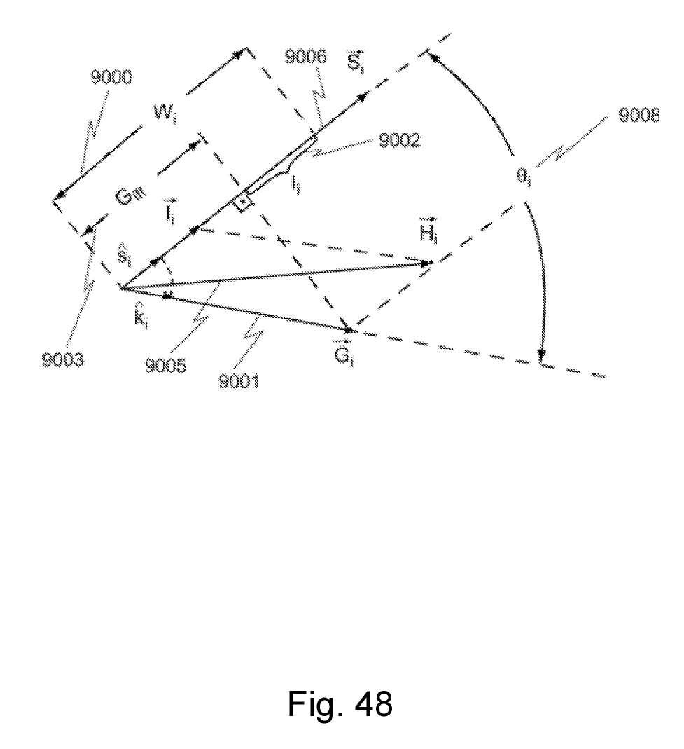

Wᵢ=Iᵢ+Gᵢ cos θᵢ=I₁+G_{i∥} (4)

where G_{i∥} is \vec{G}ᵢ-vector projection onto ŝᵢ-vector direction, as illustrated in FIG. 48. It is also evident from Eq. (141) that the normalized weight, is

$${w}_{i} = \frac{{W}_{i}}{{\sum }_{i = 1}^{N} ( {I}_{i} + {G}_{i} cos {θ}_{i} )} ; {\sum }_{i = 1}^{N} {w}_{i} = 1 \qquad ( 5 ab )$$

In FIG. 48, an example of non-diagonal kernel vector algebra, defined by Eqs. (1), (2), (3), (4), (5), (141), (142), (143), (144), and (145) is shown. This geometry of non-diagonal kernel vector algebra defines the non-normalized weight, 9000, denoted as Wᵢ, which is the sum of non-diagonal kernel pseudo-vector 9001, denoted as \vec{G}ᵢ, projected into ŝᵢ-direction and intensity scalar, 9002, denoted as Iᵢ. The \vec{G}ᵢ-projection, 9003, is denoted as G_{i∥}. According to FIG. 48, we see that the non-diagonal kernel vector, 9005, denoted as \vec{H}, is less important than pseudo-vector, \vec{G}, because, only \vec{G}-vector is projected to parametric decision vector, 9006, (denoted as \vec{S}ᵢ), by θᵢ-angle, denoted as 9008. Higher weight value, 9000, higher influence of ith-member on parametric decision mean, <S>.

1.1.8 Role of Mathematics in the Integrative Software System (ISS)

The role of mathematics in the ISS is important, and is shown in FIG. 48, for example, where the relation between the ISS geometry and algebra is shown, as an illustration of parametric decision process, which is a particular case of an inner network structure. However, the role of mathematical formalism is also important in the outer network structure, as discussed in Section 4.0, for example.

In general, in the case of ISS, the mathematical formalism does allow both the inner and outer network processes to be more automated. Although the inner network structure is less automated than the outer one, it provides a skeleton of how to supervise the process. For example, in various embodiments, the role of experts is reduced to an advisory role, rather than a supervisory one.

1.1.9 Reduction and Re-Normalization of Unit Vector Bases

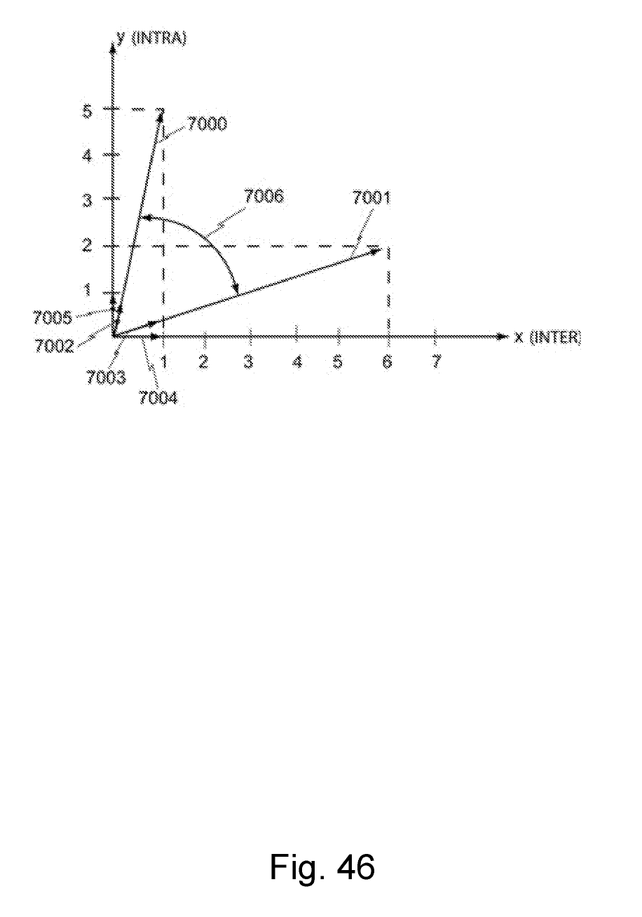

In the 1^{st} approximation, the inter-ego and intra-ego unit vector bases can be considered as mutually orthogonal and internally orthogonal. In such a case, they can be reduced to single dimensions, as in FIG. 46, resulting in 2D-space reduction. Then, both unit vectors, ŝᵢ and \hat{k}ᵢ, can be analyzed in the 2D space, for sake of simplicity. For the sake of generality, however, we may consider different dimensionalities, nₓ, and n_{y} of inter-ego and intra-ego unit vector bases related, in FIG. 46, to x-coordinate and y-coordinate, respectively. Because, typically, nₓ>n_{y}, the scale of inter-ego unit vector basis, Zₓ, should be smaller than the scale of intra-ego unit vector basis, Z_{y}:Zₓ<Z_{y}; thus, satisfying the following relation: Zₓ\sqrt{nₓ}=Z_{y}\sqrt{n_{y}}. For example, for nₓ=6, and n_{y}=3, we obtain: Z_{y}/Zₓ=\sqrt{6/3}=\sqrt{2}=1.414≅=1.4 (it should be rather approximated to lower value). Then it can be assumed that Z_{y}=14 and Zₓ=10, for example. An example of the re-normalization procedure is as follows. First, we use: 1=10 scale for both bases, and then we re-normalize both scales, according to a given Z_{y}/Zₓ-ratio, resulting in such exemplary numbers as those used in FIG. 46.

1.1.10 Radicalization Level as Decision Parameter

A parametric decision space such as a Parametric Radicalization Level (PRL), defining ensemble with parameter values, Sᵢ, can be a good example of how to narrow the context while preserving generality. Consider a young population of some country (state) as an inner network, represented by individuals and Groups of Interest (Influence). By experiment, find relevant kernel components can be found: Iᵢ, and Tᵢⱼ. The process can then formulate a non-diagonal vector, \vec{Hᵢ}, including pseudo-vector \vec{Gᵢ} and intensity vector Iᵢ. Then, by applying a construction as in FIG. 48, we can find the PRL response in the form of a weighted average <S>.

1.1.11 Comparison Summary

In Table 1, a comparison of ISS outer and inner network structures is presented. Table 1 summarizes the analysis provided in this Section.

TABLE 1
Comparison of ISS Outer and Inner Network Structures

| No. | Feature | Outer | Inner |
|---|---|---|---|
| 1. | Correlation | Partial | Strong |
| 2. | Cost Function | Yes | Yes |
| 3. | Generality | More Specific | More General |
| 4. | Automation | High | Medium |
| 5. | Basic Mathematics | Bayesian Inference | Vector Algebra |
| 6. | Network Relation | Inter-Network | Intra-Network |
| 7. | Basic FoM | Bayesian PPV | <S>-Accuracy |
| 8. | Experts' | Minor | Advisory |
| | Involvement | | |
| 9. | Software Structure | Two engines and | Algorithm |
| | | several algorithms | |
| 10. | Basic Methodology | Anomalous Events | Moral Skew Factor |

Referring now to Table 1 the correlation (No. 1) is predominant in the inner network structure, mostly through a coherency matrix. In contrast, in the outer case, the correlation is dominant only within the inter-cloud (graphic) engine. In both cases, cost functions (No. 2) may be applied for system metrics purposes. The inner network structure may also be more general (No. 3) since it may be applied not only to adverse (hostile) networks but also to general social networks. On the other hand, the automation (No. 4) is higher in outer case, and, in parallel, the experts' involvement (No. 8) is lower, in the outer case. The basic mathematics (No. 5) of the outer structure are based on Bayesian inference (Section 4), while, in the inner structure case, the vector algebra is a basic mathematical tool. Of course, the network relation (No. 6) is inter-network, and intra-network for outer and inner cases, respectively, while the basic FoM (Figure of Merit) is Bayesian Positive Predictive Value (PPV) for outer, and prognostic accuracy of the parametric decision weighted mean, for the inner network structure (No. 7).

The software system structure (No. 9) is more complex in the outer case (two software engines). Finally, the basic methodology (No. 10) of the outer structure is based on anomalous events (BAEVENTS) extraction, while, the inner case phenomenology is mostly based on Moral Skew Effect (MSE), in general, and on Moral Skew Factor, in particular.

Section 2: Example ISS Concepts, Components and Architecture (Outer Network)

2.1 ISS Logic Scheme

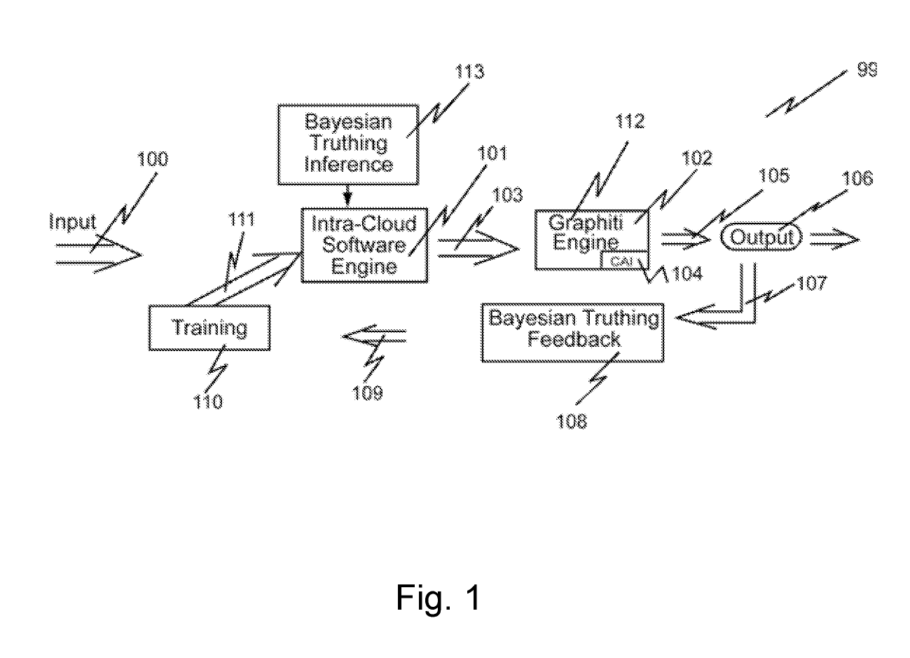

FIG. 1 is a diagram illustrating an example logic scheme in accordance with one embodiment of the technology described herein. Referring now to FIG. 1, the example ISS Logic Scheme 99 shown includes input data 100 and two system software engines, an intra-cloud software engine 101, and an inter-cloud software engine 102. In various embodiments, inter-cloud software engine 102 produces network graphs, or graphitis 112. While the 1^{st} engine can be configured to produce yellow alarms 103, the 2^{nd} engine can be configured, with the application of one or more Compound Association Identifiers (CAIs) 104, produce red alarms 105, which, in turn, can produce the output result, 106.

Various embodiments can include a feedback loop. The feedback loop can be used, for example, for training purposes. System output 106 can be fed back via feedback loop 107 in the form of Bayesian Truthing Feedback, 108. Through interface 109, Bayesian Truthing Feedback 108 can be connected with population interface for truthing of priors (targets), and likelihood probabilities, 110; then, feedback loop 107, is closed. The software engine 101 may be supported by a Bayesian Truthing Inference 113.

2.2 Graphitis

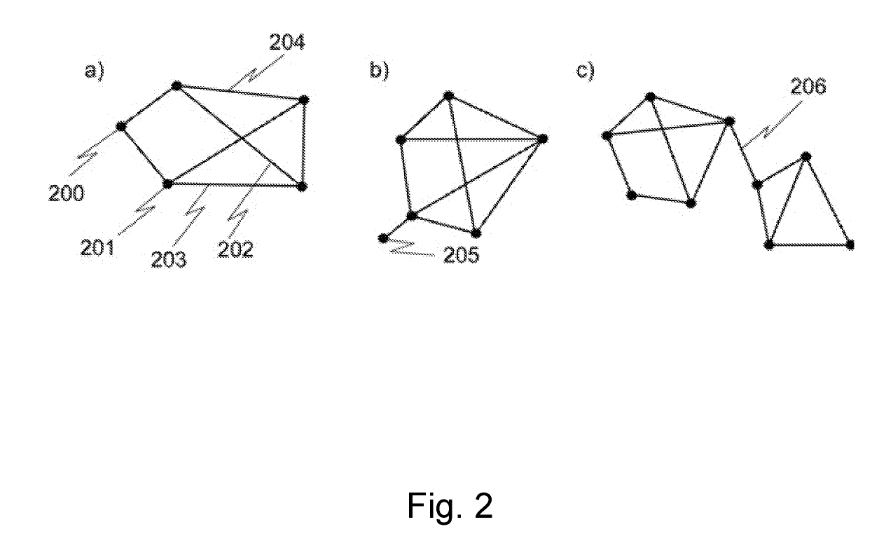

FIG. 2, which comprises FIGS. 2A, 2B and 2C, is a diagram illustrating examples of graphitis in accordance with one embodiment of the technology described herein. Graphitis are network graphs, which can be obtained either exclusively by collecting network nodes and their connections, as shown in FIG. 2A, or inclusively, using event correlation.

The example graphiti shown in FIG. 2A has a typical graph structure with nodes: 200, 201, and edges: 202, 203, 204, etc. The nodes and edges in various embodiments can be used to represent network elements. For example, nodes can be used to represent cyberaddresses, or cyberphone numbers, while edges can represent cyber-connections with a sufficiently large frequency of communication events, exceeding some assigned threshold value. In FIG. 2B, an example graphiti with an appendix 205 is presented. Such an appendix 205 can be used, for example, to represent some special HVIC (High Value Individual Candidate). In the example graphiti shown in FIG. 2C, an extra connection 206 between two graphitis is presented.

2.3 System Architecture

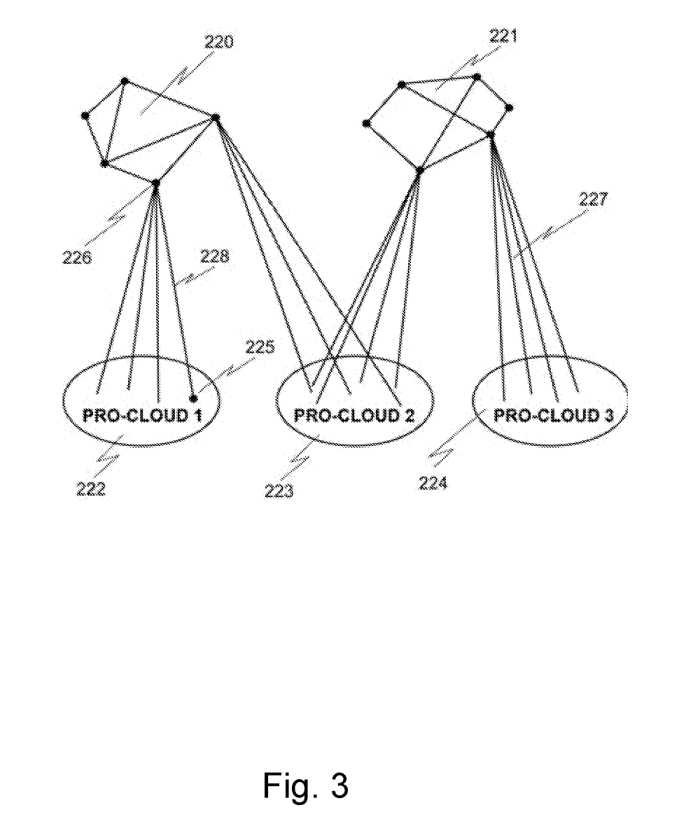

FIG. 3 is a diagram illustrating an example system architecture in accordance with one embodiment of the technology described herein. Referring now to FIG. 3, in this example architecture, the basic feature is Bayesian Inter-Cloud Coherency resulting from the integration of two graphitis 220, 221 with PRO-CLOUDS 222, 223, and 224. A typical number of PRO-CLOUDS is 10-20, while the number of graphitis can be very large, approaching a million, or more, although other quantities of PRO-CLOUDS and graphitis can be accommodated in various embodiments. In the example of FIG. 3, only 2 graphitis are presented for the sake of simplicity.

In the illustrated example, an exemplary HVIC (High Value Individual Candidate) 225 is identified with its cyberaddress 226. The identity between the two can be provided due to a Compound Association Identifier (CAI), with its connection 228. Therefore, the CAI, representing correlation connection 228, is separated from the intra-cloud causation process, in order to avoid contradiction between correlation and causation. The professional clouds (PRO-CLOUDS): 222, 223, and 224, represent different possible HVI (High Value Individual) professions. In the case of an HVI network, expemplary professions are given in Table 2.

Table 2 below is an example identification of selected PRO-CLOUDS. This example assumes 11 IED network member professions, and 11 corresponding PRO-CLOUDS. In various embodiments, the intra-cloud software engine can work, in parallel, with all of the PRO-CLOUDS, at the same time.

TABLE 2
Example PRO-CLOUDS

| | |
|---|---|
| 1. | Financier |
| 2. | Mastermind |
| 3. | Bomb Maker |
| 4. | Material Furnisher |
| 5. | Spiritual Leader |
| 6. | IED Emplacer |
| 7. | Triggerman |
| 8. | Spotter |
| 9. | Bodyguard |
| 10. | Intelligence |
| 11. | Camera Man (PR) |
| 12. | Others |

2.4 ISS Cyberspace, Truthing (Sample) Space and System Envelope

In general, cyberspace is a computer habitat made up of interdependent network and information technology (IT) infrastructures, including the Internet, telecommunication networks, social networks (e.g., facebook), computer systems, as well as embedded processors and controllers. It has cyberaddresses, referred to herein at times as cyberphone numbers (CP#). These can include phone numbers as a simple example, as well as internet addresses, e-mail addresses, etc. Hyperspace, including physical space and cyberspace, generally refers to an abstractive space including geophysical (x, y, z, t) coordinates and cyber-coordinates (ξ, η, . . . ), representing cyberspace. Cyber-coordinates can include discrete coordinates such as cyberphone addresses, and cyberphone numbers (CP#).

In contrast, the (Bayesian) Truthing (Sample) space is a new abstractive space created for purposes such as system experimental validation (truthing) and training. In such a space, the HVIC is a sample unit, while the HVI is a target. Within this space, the Bayesian Truthing Inference (BTI) is introduced as a novel approach to Bayesian inference for ISS purposes. The number of sample units, m, is preferably sufficiently large in order to justify using statistical principles, including both classical statistics and Bayesian statistics.

Classical statistics is based on a null hypothesis typically applied to normal (Gaussian) distributions. In such classical statistics, an anomaly is defined by showing that the null hypothesis occurrence has a very small probability. Bayesian statistics, on the other hand, is based on conditional probabilities, and absolute probabilities (prior known events). The conditional probabilities can be direct (likelihood) and inverse (Bayesian), the latter including, for example PPV (Positive Predictive Value), and NPV (Negative Predictive Value). In some embodiments, Bayesian algebra, or Bayesian statistics, can be applied for system training and experimental validation (truthing). Thus, the ISS can have a well-defined metrics envelope (including Key Performance Parameters (KPPs), or Figures of Merit (FoMs)), as well as inputs and outputs. The inputs can include HVIC data coming from pro clouds, while the outputs can include graphical results (e.g., graphitis), alarms (e.g., yellow/red alarms), and KPP/FoM statistical summaries as well as metadata.

Examples of a system chain structure, system modules (sub-systems) and Bayesian Truthing Inference, as well as system performance and concepts of operation (CONOPS) are described below.

Section 3: Example System Chain Structure (Outer and Inner Network)

3.1 System Chain Structure

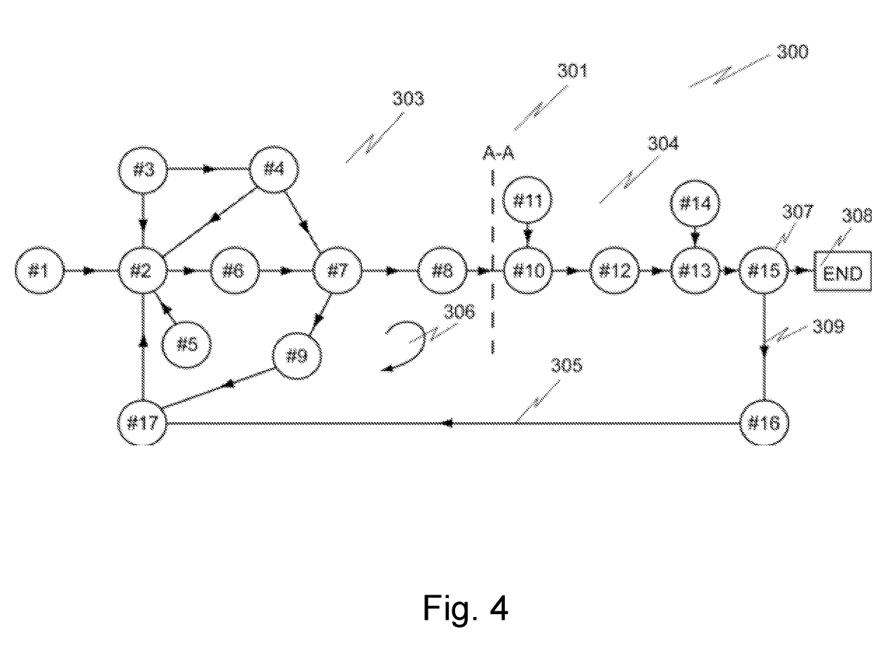

FIG. 4 is a diagram illustrating an example ISS chain structure in accordance with one embodiment of the technology described herein. Referring now to FIG. 4, this example structure includes 17 elemental tasks (modules), or nodes, with all chain connections implemented as unidirectional connections. Modules are numbered as: #1, #2, #3, . . . #17. The example chain structure 300 has demarcation A-A line 301 separating intra-cloud area 303 from inter-cloud (graphiti) area 304. The feedback line 305 unites those areas in the opposite direction, while closed feedback loop, 306, operates clockwise. The #15 module 307 has a switch directing either into final output, end 308, or into feedback loop 309. A list of these 17 example modules is presented in Table 3, while exemplary basic ISS chain features are summarized in Table 4.

TABLE 3
Example Chain Structure Elemental Tasks (Modules)

| No. | Name of Elemental Task | Nearest Neighbors | Type of Module |
|---|---|---|---|
| 1 | Input Data (Clouds) | #2 | Data Base |
| 2 | Intra-Cloud Software Engine | #3, #4, #5, #6, | Engine |
| | | #17, #1 | |
| 3 | Bayesian Truthing Inference (BTT) | #2, #4 | Algorithm |
| 4 | PPV Algorithm | #2, #7, #3 | Algorithm |
| 5 | Pre-Structurization (of Clouds) | #2 | Algorithm (an option) |
| 6 | Cyber-Sensor Output | #2, #7 | Interface |
| 7 | Cost Function Minimization | #4, #6, #8, #9 | Algorithm |
| 8 | HVI Output Data (Yellow Alarm) | #7, #10 | Display/Interface |
| 9 | HVI Intra-Cloud Feedback | #17, #7 | Truthing Algorithm |
| 10 | Graph Engine (Graphiti Fabrication) | #8, #11, #12 | Engine |
| 11 | Network Synthesizer System (NSS) | #10 | Software Sub-System |
| 12 | Graphiti Display | #10, #13 | Display/Interface |
| 13 | Graphiti Experimental Verification | #12, #14, #15 | Truthing Algorithm |
| 14 | Human Interface (Experts), Optional | #13 | Human/Machine |
| | | | Interface |
| 15 | Final Output Data (Automated or | #13, #16, END | Display and Switch |
| | Semi-) | | |
| 16 | Graphical (Truthing) Feedback | #15, #17 | Truthing Algorithm |
| 17 | Automated (or, Semi-Automated) | #2, #16, #9 | Algorithm/Data Base |
| | Injection of Priors | | |

TABLE 4
Example Chain Features

| | | | Elemental Tasks |
|---|---|---|---|
| No | Feature Description | Type of Feature | Related to |
| 1 | Actionable Chain | Actionability | All Tasks (Modules) |
| 2 | Positive Predictive Value (PPV) as | PPV (FoM) | #4 |
| | FoM in #4 | | |
| 3 | Cost Function in #7 | FoM | #4 |
| 4 | Cybersensor Ranking | FoM | #2 |
| 5 | Two Engines #2 and #10 | Engines | #2, #10 |
| 6 | Six (6) Supportive Modules to #2 | Modules | #3, #4, #5, |
| | | | #17, #6, #1 |
| 7 | After #13, Either END or to #16 | Switch | #16 |
| 8 | The 2nd Intra-Cloud Feedback for | Feedback | #9 |
| | HVIs | | |
| 9 | All Edges are Directional | Actionability | All Tasks |
| 10 | Critical Modules: #2 and #10 | Engines | #2, #10 |
| 11 | Engine #2 is supported by Bayesian | Engine #2 | #2, #3 |
| | Algorithm #3 | | |
| 12 | Priors are Added (Automatically) to | Database Interface | #17 |
| | Increase PPV-Value for Training | | |
| 13 | Priors Include: Absolute | Cybersensor | #17 |
| | Probabilities and Likelihood | Structure | |
| | Probabilities (by Experts, or | | |
| | Automatically) | | |
| 14 | Cost Function as Module of | Algorithm | #7 |
| | Difference Between (PPV)TH and | | |
| | (PPV)EXP Should Be Minimized | | |
| | Through Truthing Feedback | | |

3.2 System Engines and Feedback

FIG. 4 depicts an exemplary ISS chain structure that includes two engines: intra-cloud engine #2 303, and inter-cloud (graphiti) engine #10 304. It also has two feedback paths: #15->#16->#17 (global), and #7->#9 (intra-cloud). The intra-cloud engine #2 takes input from a data source, #1. The intra-cloud engine #2 also interacts with chain components #3 and #4 that can be, for example, a Bayesian Truthing Interface and a PVV algorithm, respectively. The intra-cloud engine #2 can also interact with a pre-structuraization of clouds algorithm #5. The intra-cloud engine #2 can then pass output #6 to a cost function minimization algorithm, #7. The cost function minimization algorithm can then pass the output to the inter-cloud engine #10, and/or to the HVI intra-cloud feedback #9.

Still referring to FIG. 4, the inter-cloud engine can be a graphiti engine #10. The graphiti engine #10 can take HVI output data #8 from the intra-cloud engine 303. The graphiti engine #10 can interact with a network synthesizer system (NSS) #11 to display graphical output in a graphiti display #12. The HVI data can then be analyzed through a truthing algorithm #13 and/or human interaction #14. Final output data #15 can then be displayed and/or sent back to the intra-cloud engine through a feedback algorithm or database #17.

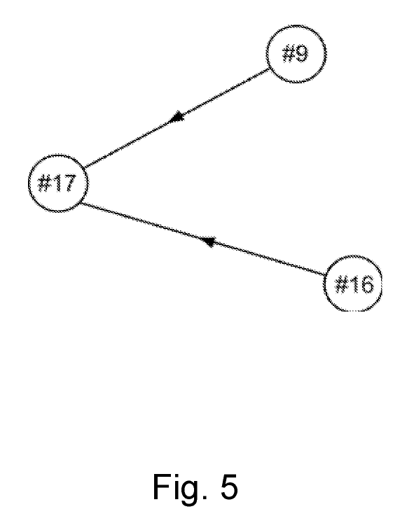

FIG. 5 depicts an example heuristics (learning process) as alternative causation, including three (3) elemental task modules: #9, #16 and #17.

3.3 Intra-Cloud Engine Set

In the example illustrated in FIG. 4, the ISS chain structure can be analogized to a workstation production line, with each elemental task (module) equivalent to workstation, which has an input, a process, and an output. In some instances, however, modules can form a cluster surrounding a central module, such as intra-cloud engine #2, for example.

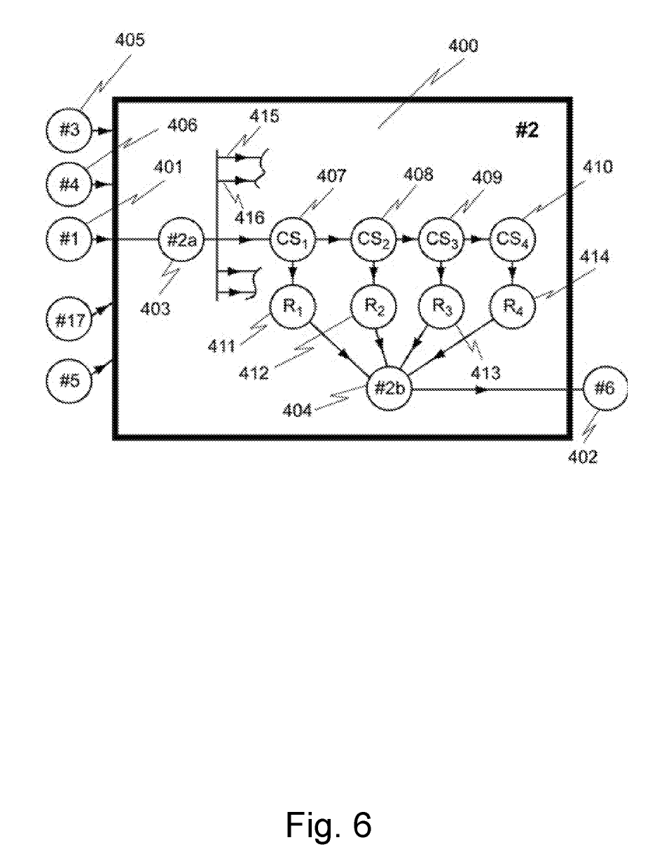

FIG. 6 is a diagram illustrating an example of intra-cloud engine #2 in accordance with one embodiment of the technology described herein. The intra-cloud engine #2 400 has input 401 from module #1, and produces output 402 to module #6. It has also two (2) sub-modules 403, and 404, denoted as #2a and #2b. The 1st sub-module 403 provides HVIC selection, while the 2nd sub-module 404 is a micro-controller producing a Figure of Merit (FoM). In this example, the FoM is a ranking parameter determining whether the HVIC is qualified as an HVI, or not. This decision can be hard (yes/no), or soft (yes/no/maybe). The other modules, such as 405, 401, 406, etc. provide connections to module 400.

3.4 HVI Recommendation Process

The HVI recommendation process in this example is provided by Bayesian cyber-sensors CS1, CS2, CS3, CS4, denoted as 407, 408, 409, and 410, respectively. In some embodiments, they are defined in a narrow sense as Bayesian cyber sensors (BCS), only. The illustrated quantity, four, is exemplary, and other quantities can be used. In various embodiments, each cyber-sensor applies one or more specific Objected-Oriented-Rules (OORs), or its derivative, DOOR, into a given HVIC, within a given PRO-CLOUD. This can be done, for example, to show an HVIC's anomaly against a regular (normal) pattern. In this example, each CS 407, 408, 409, and 410, has a corresponding readout sub-module R1, R2, R3, R4 to produce a ranking. For example, higher anomalies receive higher ranking, and vice-versa. Sensor readouts: R1, R2, R3, R4, are denoted by 411, 412, 413, and 414, respectively. In some embodiments, the rankings can be weighted with a weight, w. The weighting, for example, can be within a range:

0<w<1 (6)

By using voting logic, the weighted combination (e.g., sum) can be produced as a FoM by sub-module 404. This HVI recommendation process can be repeated with other HVICs, in sequence, or in parallel, the latter one through parallel branches 415, 416, etc.

### Example 1

(Cyber-sensor readout anomaly). Consider a financial PRO-CLOUD as an example. Consider further that the goal in this example is to determine whether an anomaly exists for a given HVIC presenting him or herself as a banker. Thus, the ISS can be configured, for example, to check the HVIC's financial assets. If, for example, the ISS finds the HVIC's personal assets below a certain threshold for a given country (e.g., $10,000 in a country such as Canada, for example), then its readout sub-module (e.g., R₂) gives the HVIC a high ranking (i.e., a high anomaly), such as a “9,” in a scale of 0-10. However, if the HVIC's country is a third world country, for example, R₂'s ranking may be much lower (lower anomaly).

### Example 2

Assume the answer for EXAMPLE 1 cannot be found. Then, in this follow-on example, the ISS repeats the process with a similar OOR, or DOOR. If the ISS is not able to find an answer in a predetermined number of tries (e.g., three sequential trials), this itself can be flagged as an anomaly, resulting in a high ranking.

As these examples illustrate, in various embodiments, the process can be configured to (1) identify or determine tests or rules (e.g., OORs or DOORs) associated with validating an HVIC or determining whether an anomaly exists; (2) execute those rules (sequentially or in parallel) to determine a result and rank the result with a range from non-anomoulous to highly anomalous; (3) weight the rankings where appropriate; and (4) make a recommendation regarding whether the HVIC should be considered an HVI based on the rankings (e.g., by summing or otherwise combining the rankings).

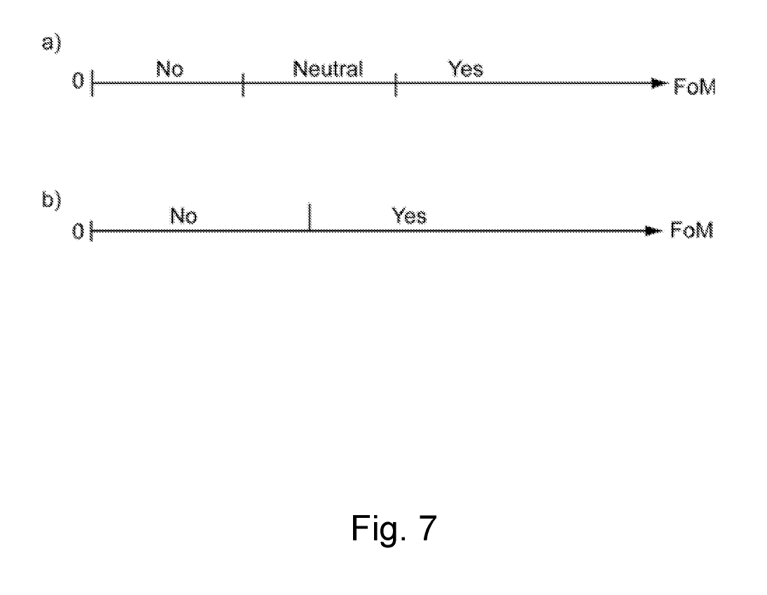

FIG. 7, which comprises FIGS. 7A and 7B is diagram illustrating an example HVI recommendation (decision) process in accordance with one embodiment of the technology described herein. A soft decision example is presented in chart a) of FIG. 7, and a hard decision example is presented in chart b). In the illustrated example, the high FoM value, a weighted sum of a cybersensor's BAEVENTS (Bayesian Anomalous Events), produces a positive decision (yes), while a low value produces negative decision (no). Chart a) of FIG. 7 also illustrates an example of a neutral decision.

3.5 Object-Oriented Rules

The Object-Oriented Rules (OORs) may, in general, be simple computer mini-programs to produce BAEVENTS within a given PRO-CLOUD. Therefore, in various embodiments the OORs may be cloud-specific, or intra-cloud. (However, their daughters, or derivatives (DOORs) can be also inter-cloud). The OORs may be developed using an object-oriented computer language such as, for example, C++, or Java. Table 5 shows example list of OORs, suitable for an Organized Crime Network as an example of adverse network. While non-heuristic OORs are generally developed manually, the heuristic DOORs can be developed semi-automatically, or automatically.

TABLE 5
Example List of Object-Oriented Rules
(OORs), for an Organized Crime Network

| No. | Object-Oriented Rule (OOR) |
|---|---|
| 1 | List of Detainees |
| 2 | List Who Communicates with Given HVIC |
| 3 | List Who the Given Phone Belongs To |
| 4 | List of Organization Where Given HVIC Belongs |
| 5 | List Who has Argued with Given HVIC |
| 6 | List of Arguments Between HVIC1 and HVIC2 |
| 7 | List of All Events Associated with Given HVIC |
| 8 | Search for a Given Keyword |
| 9 | List of the Associations of All People and Events |
| | for Plot Automatic Map |

### Example 3

Apply OOR 8 for two (2) keywords: “GOOD,” and “OO,” including word record: HELLO (1), GOOD BYE (2), BLOOD (3), GOOD (4), and GOODMAN (5).

Considering keyword: “Good,” the match is for the following words: “GOOD BYE” (2), “GOOD” (4), and “GOODMAN” (5).

Considering keyword: “OO,” the match is for four (4) words: (2), (3), (4), and (5).

3.5 Development Method for DOORs

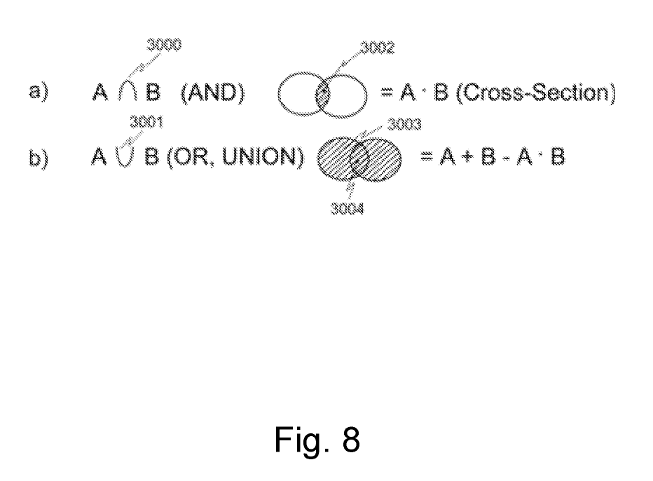

Consider the development of Daughter Object-Oriented Rules (DOORs) as a consequence of applying Boolean logic to Object-Oriented Rules (OORs), the latter developed by software engineers. In contrast, the DOORs can be developed semi-automatically, or automatically within intra-cloud or inter-cloud schemes. The Boolean logic can be developed by using either set theory, or binary numbers algebra. FIG. 8, is a diagram illustrating an example in which the logic “AND,” and “OR” (union) logic operations are shown using set theory. Particularly, the illustration of AND and OR logic operations, using sets A and B, is presented.

In the example illustrated in FIG. 8, as a symbol of AND-operation 3000, and an OR-operation 3004 as a symbol are presented. The hatched area 3002 in FIG. 8 illustrates the result of the AND operation, also called a cross-section. The OR-operation, also called a UNION, is presented as sum of A, B-sets as the hatched area 3003, minus their cross-section (to avoid counting the cross-section, 3004, twice).

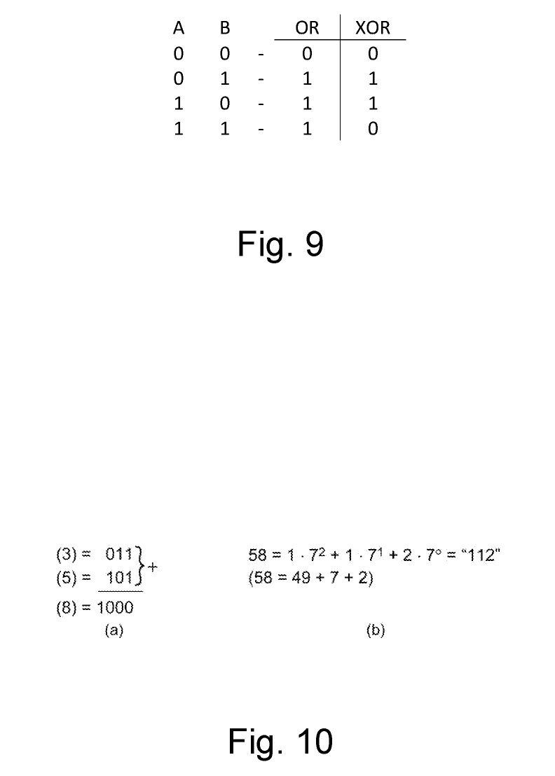

The OR-operation can be understood as “A, or B, or both.” In contrast, the XOR-operation is: “A, or B.” Both operations: OR and XOR, are shown in FIG. 9, using the Boolean algebra.

According to the example of FIG. 9, the logic operations OR and XOR are identical, except the last row with both sets A, and B, equal to 1. FIG. 10 is a diagram illustrating the usefulness of the XOR operation by showing the summation of two integers “3” and “5,” which yields “8,” using regular (modulo-10) algebra. In contrast, the Boolean algebra is modulo-2 arithmetic. FIG. 10 at a) shows the exemplary sum using XOR-logic rule for: “3+5=8”. FIG. 10 at b), in order to show various modulo-algebras, illustrates a scheme of writing the integer “58,” using modulo-7 algebra, for example.

3.6 DOORs Based on AND-Operation

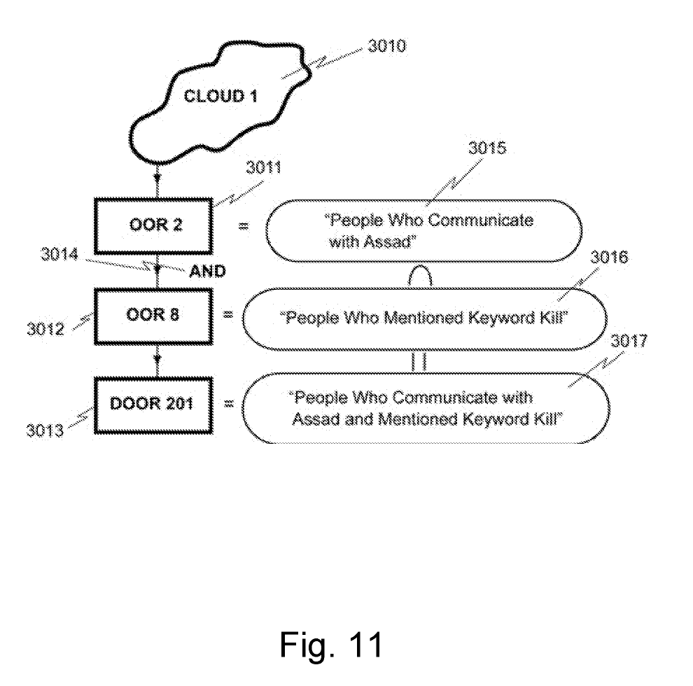

Using Table 5 we can select two OORs: OOR 2 and OOR 8, and apply the AND-operation to them. FIG. 11, is a diagram illustrating an example of creating a DOOR in accordance with one embodiment of the technology described herein. This example illustrates the creation of DOOR 201, for example (the number of each exemplary DOOR is for discussion purposes only) by applying the AND-operation for the following contextual example. The OOR 8 produces a list of people who mentioned the keyword: “kill.” Then, by applying the AND-operation, the DOOR 201 is obtained, which produces the list of people who communicate with person named: “Assad,” while the OOR 8 produces the list of HVICs who communicate with Assad and mentioned keyword: kill. In FIG. 11, the Cloud 1, 3010, delivers data to OOR 2, 3011, and OOR 8, 3012, in order to produce DOOR 201, 3013, by applying AND-operation, 3014. As an example, the OOR 2, 3011, produces list of people who communicate with “Assad”, 3015, while the OOR 8, produces list of HVICs who mentioned keyword “kill”, 3016, resulting in producing by DOOR 201 the list of people who communicate with Assad and mentioned keyword kill, 3017.

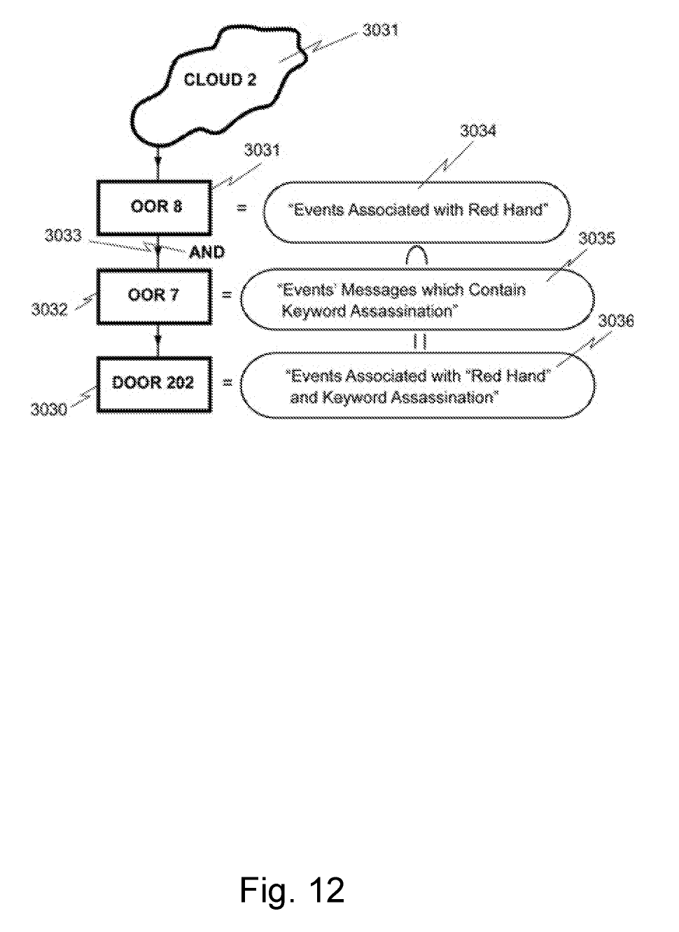

FIG. 12 is a diagram illustrating the example of creating DOOR 202. In this example, the other DOOR 202, 3030 is produced as a combination of OOR 8, 3031, and OOR 7, 3032, using data from Cloud 2, 3031, and based on AND operation 3033. An example is applied for illustration, based on associative sentences 3034, 3035, and 3036.

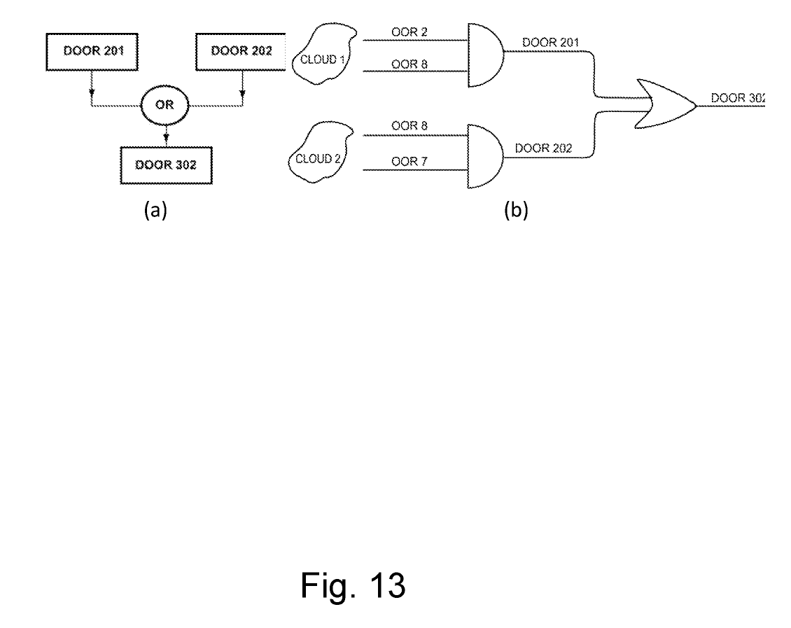

In FIG. 13, part (a), the compound DOOR 302 is produced by on union, or OR-operation applied for DOOR 201 and DOOR 202.

In FIG. 13, part (b), an exemplary equipment logic circuit of FIG. 13A is presented, including also compositions of DOORs 201 and 202, illustrated in FIGS. 11 and 12, with clouds 1 and 2. According to FIG. 13(b), clouds 1 and 2 create a habitat for two pairs of OORs, including their context. In particular, CLOUD 1 creates context for the 1st pair (OOR 2 and OOR 8), while CLOUD 2 creates a context for the 2nd pair. Then, the AND operation for each pair, creates respective DOORs: the 1st OOR pair creates DOOR 201 and the 2nd OOR pair creates DOOR 202 (“201” and “202” numbers are chosen arbitrarily). Finally, the OR operation creates the DOOR 302. The DOOR operations can be done automatically, or semi-automatically.

3.7 Context-Based Synonymous Object

The Context-based Synonymous Object, or CONSYN object concept is a generalization of the OORs (Object-Oriented-Rules), based on object-oriented computer languages such as, for example, C++, Java, or C#. These languages have been created as a response to a practical need: to modify the object attributes, context and other object elements (defined as object structure), without modifying the overall object structure.

In the context of the ISS, the entity may be considered as an individual (e.g., a person), or a thing actually existing, such as, for example, HVI, HVIC, event, object, etc. In particular, an HVI and HVIC may be considered as an object including its context, with such context attributes as: e.g. location (within: x, y, z, t-coordinate system); his/her state (e.g., motion, activity, physical/emotional condition, etc.); reachability (all cyberspace media may be included); environmental conditions or surroundings such as geophysical ones, selection/presentation of cyberinformation, etc.; identification (e.g., various typed of IDs, such as driver license, biometric, his/her name, cyberaddress, individual features/physical and/or mental markings, etc.); other people and objects belonging to the object and its context (e.g., relatives, friends, rats, dogs, etc.); personal preferences; object-specific databases, and other documents belonging to his/her context.

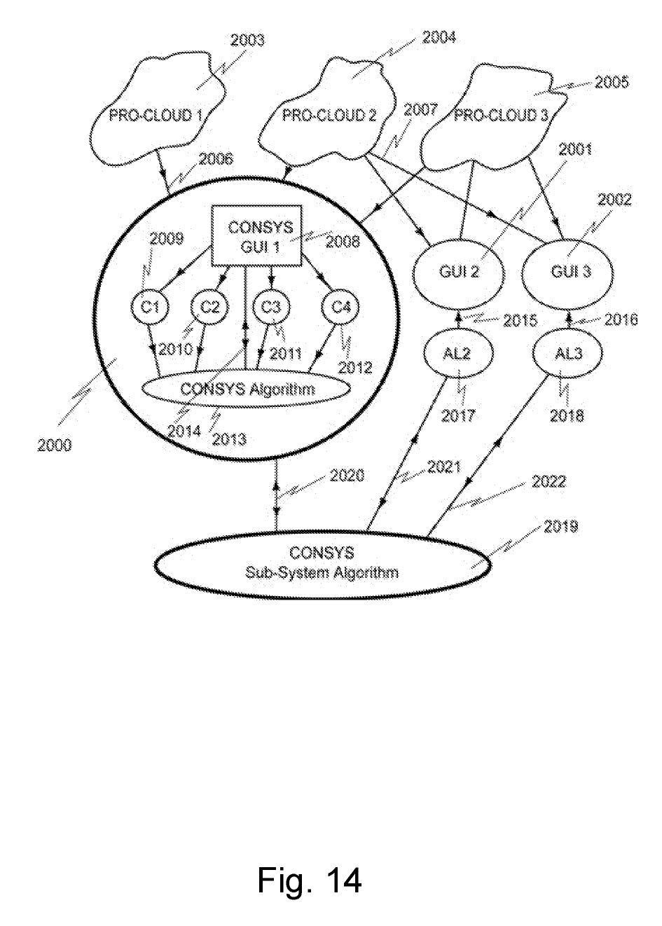

All these object attributes together with the object itself may be used to create a Context-based Synonymous (CONSYN) object status, being used within the ISS chain structure, especially including both software engines. They can be organized within a CONSYN object GUI (Graphical User Interface), together with other (possibly: COTS/GOTS) GUIs, and PRO-CLOUDS, as shown in FIG. 14.

In FIG. 14, an example CONSYN sub-system (algorithm) is illustrated, including an example CONSYN component itself 2000 and other possible exemplary COTS/GOTS GUIs, 2001, and 2002. All these GUIs may be supported by various data from various PRO-CLOUDS, such as, for example, PRO-CLOUDS 2003, 2004, 2005. The supporting connections such as 2006, 2007, and others, shown in FIG. 14, are uni-directional, although bi-directional connections may be used.

In the illustrated example, only some PRO-CLOUDS are supporting a given GUI (e.g., all three (3) PRO-CLOUDS support GUI 1, 2008, while only two (2) PRO-CLOUDS 2004, and 2005, support GUI 2, 2001, and GUI 3, 2002). The CONSYN GUI 2008 supports CONSYN elements: C1, C2, C3, C4. Some of them, such as C1, 2009, can be one of the context elements, discussed in paragraph [00125], including C2, 2010; while, other CONSYN elements, 2011, 2012, can comprise various cybersensors. All these components may be summarized into CONSYN algorithm 2013, which has bi-directional connection with GUI 1. Similarly, GUI 2 2001 and GUI 3 2002 in this example have bi-directional connections 2015 and 2016 with their algorithms 2017 and 2018. The same can be said for bi-directional connections between summary CONSYN algorithm 2019 and partition algorithms such as 2020, 2021, and 2022.

This example illustrates that the CONSYN object concept may be a context-centric one, a feature of this technology, which, itself, has a specific context of the ISS chain structure. The bi-directionality of some connections in FIG. 14 does not violate the actionality principle. This is because it is directly related to the ISS feedbacks which are well-synchronized within the ISS chain structure (i.e., feedback loops are separated in time of operation).

3.8 Link Analysis (Network Synthesizer System)

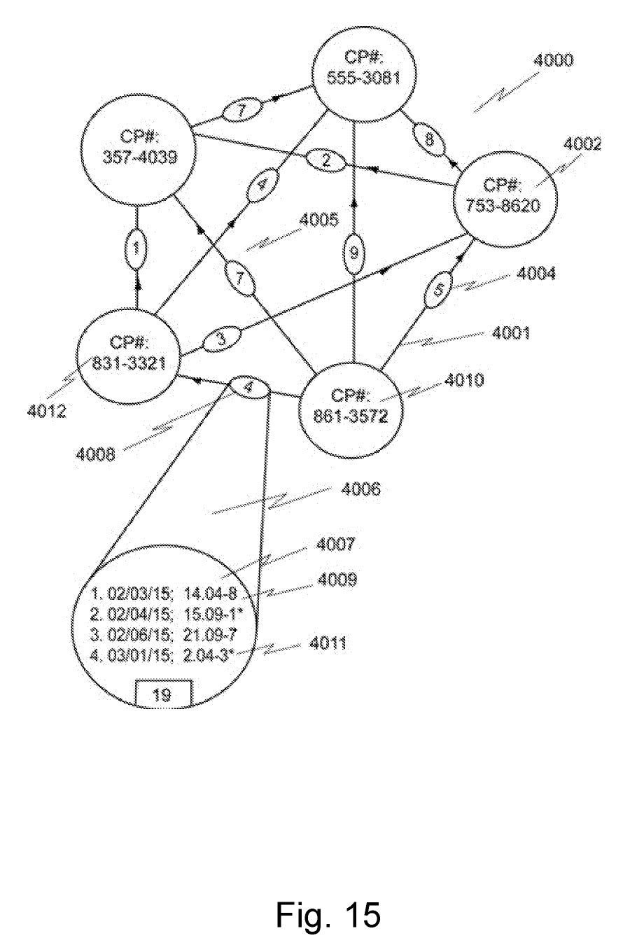

The ISS applies the Network Synthesizer System (NSS), as in module #11 of the ISS (see FIG. 4), for the graphiti; i.e., graph obtained from graph engine #10. In FIG. 15, such a graphiti 4000 is shown, including illustration of Network Synthesizer System (NSS) structure at the 1st layer of complication (the lowest). The 1st layer includes a summary description of the graphiti edges, such as 4001, and nodes, such as 4002. The graphiti nodes may be may be defined by their cyberphone numbers (CP#s). For ease of explanation, illustrated is the simplest cyberphone number case, namely, phone numbers in a shorter form (only seven digits), for simplicity. For example, we use: “555-3081,” instead of a full ten (10) digit number (with area code), such as “320-555-3081,” for example. The edges represent bi-directional phone connections between a given two nodes, characterized at the 1st layer, by a number: “5,” for example, denoted by 4004.

This number represents the total number of telephone conversations per a given interval, such as during one week, for example. While the 1^{st} layer may be represented by the graphiti, 4005, as in FIG. 15, the 2^{nd} layer may be represented by a blow-up 4007 of a given connection, such as 4006, for example. At the 2^{nd} layer, the phone conversations may be represented using more detail including, for example, date (such as number one) with: Feb. 3, 2015—month, day, year of a given telephone conversation, 14.04—an hour and minute of conversation, and “8,” eight (8) minutes of conversation duration. In the exemplary blow-up 4007, four such conversations are described, which agrees with number “4” 4008. The number of minutes illustrates an example of a conversation duration, without an asterisk, such as “8” 4009, which shows conversation initiated by CP# at the arrow direction, 4010. A duration in minutes, such as “3,” with an asterisk, denoted by 4011, may show a conversation initiated by CP#, 4012; i.e., against arrow direction. In the illustrated example, all connections have arrows; thus, this description is well defined.

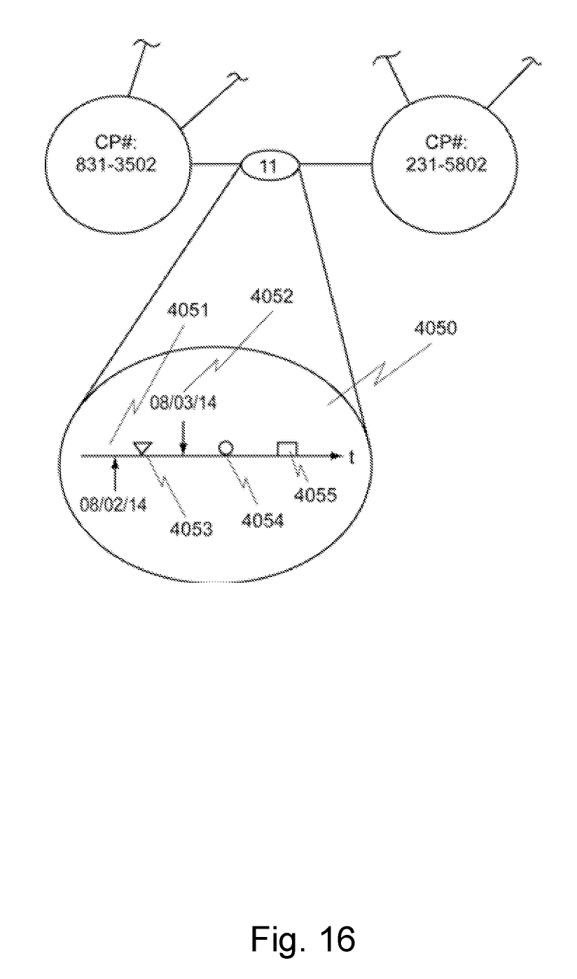

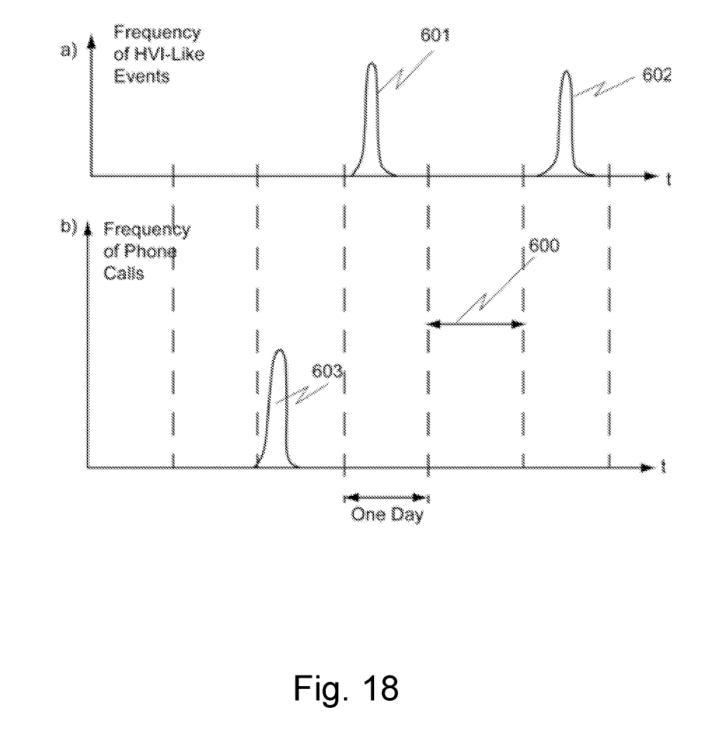

FIG. 16 illustrates an example of a 3^{rd} layer of description. At the 3^{rd} layer of description illustrated in FIG. 16 (the most complex case in this example), the phone call bursts (PCBs) are described, as BAEVENTs, which may be results of Temporal Event Correlation (TEC), or Spatial Event Correlation (SEC), or both, as illustrated in FIG. 18, for TEC case. For the sake of clarity, we consider three PCB types, in three colors: yellow, orange, and red, ending with highest anomaly, such as:

YELLOW BURST:TEC;“◯” (7a)

ORANGE BURST:SEC;“□” (7b)

RED:BOTH(TEC and SEC);“∇” (7c)

In the example of FIG. 16, the burst symbols are shown in blow-up 4050, with a scale showing the burst in one-day intervals, for example, illustrated by dates: 4051 and 4052. The 1^{st} burst BAEVENT is a red one, 4053, according to Eq. (7c). The 2^{nd} is yellow, 4054 and the 3^{rd} is orange, 4055. The further action is described in Section 3.10 (Clock Anomaly).

CONOPS.

The application of specific layers may be regulated by an ISS feedback system, according to Section 3.9, where a Compound Association Identifier (CAI) is described. First, it may be useful to consider a threshold generating occurrence of the connection (below this threshold, the connection does not exist in cyberspace). This stage can be considered as a zero-layer, one of the simplest ones. After the graphiti is defined, in some embodiments any layer of description can be applied, depending on the system of OORs applied for a specific situation.

3.9 Compound Association Identifier and Identification (ID) Method

The Compound association Identifier (CAI) may be developed for indirect association between a given HVIC and its cyberphone number (CP#).

### Example 4

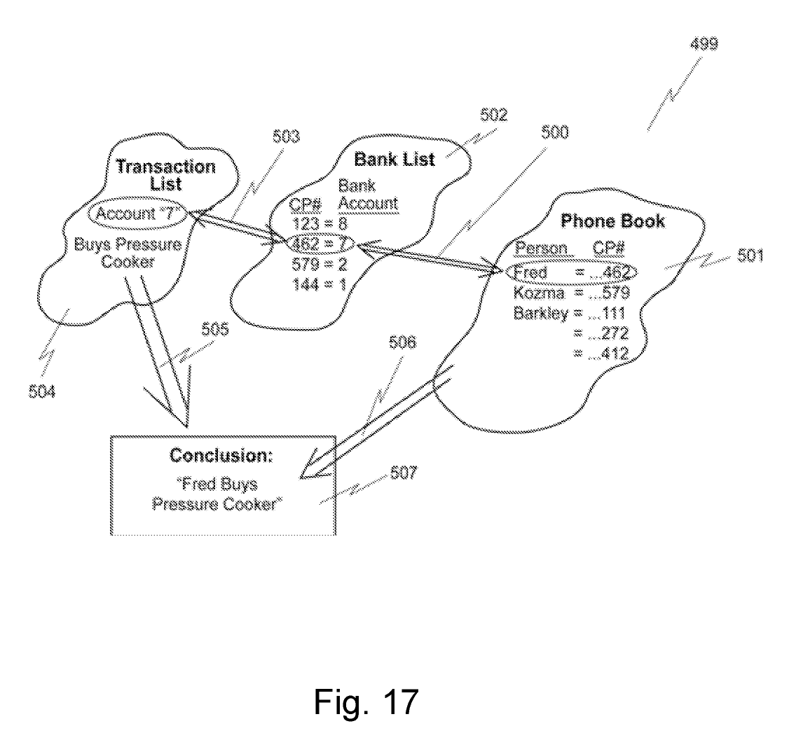

Consider as another example an IED network and a PRO-CLOUD of Bomb Makers as in Table 2, #3. Assume that the HVIC is identified as an HVI and that a goal is to determine whether he or she belongs to a specific graphiti. Further assume that the full list of CP#s, produced by graph engine #10 is available. The process can be configured to search all other PRO-CLOUDS containing CP#s lists. This exemplary situation is shown in FIG. 17, where an example of Compound Association is presented. This example identifies identity between the HVI found by software engine #2, and its CP# found by graph engine #10.

According to the example of FIG. 17, the Compound Association Identifier (CAI) 499, provides an elementary association 500 between two list members having the same CP#462 at Phone Book 501 and Bank List 502. The 2^{nd} elementary association 503 may be found between members having the same bank account “7,” namely, at Bank List 502 and at Transaction List 504. Therefore, the CAI inferences produce the conclusion in block 507 that the HVI's name is Fred, and also that: “Fred buys a pressure cooker,” i.e., that indeed, this HVI is the bomb maker. This is shown by two arrows 505, 506 leading to the conclusion. Also, by identifying Fred's graphiti, the system can be configured to search other possible HVIs communicating through this identified graphiti, as possible IED network members.

3.10 Clock Anomaly

The graph engine #10 operation can also be performed by tracing a clock anomaly (CA). Assume for example that an HVIC Makes a number of calls and that the calls are counted and time-stamped. In various embodiments, the fact that he/she is making many calls does not automatically qualify this person as BAEVENT. However, a burst of telephone calls within a short duration (e.g., within on day) can be qualified as the BAEVENT. Therefore, a given number of calls above a predetermined threshold, within a time window can qualify as a BAEVENT. Likewise a calls/time ratio above a predetermined threshold may also qualify. In circumstances where the burst is in a spatial and/or temporal proximity to an HVI-like event, the likelihood can be increased.

As an example, the burst threshold can be set as ten (10) calls per day, for example, and the threshold can be regulated. If such a phone call burst (PCB) occurs within a time window of a terrorist-attractive event, it can be qualified as a soft BAEVENT (e.g., a medium ranking) in this example. This can be referred to as being the result of Temporal Event Correlation (TEC). If the phone call burst occurs in the geographic vicinity of some characteristic event, then, in this example, there is a Spatial Event Correlation (SEC), resulting in a medium rank, or a soft BAEVENT. If they both (TEC and SEC) arrive for the same HVIC, then this can be classified as a high-ranking BAEVENT.

FIG. 18 is a diagram illustrating an example of a TEC situation in accordance with one embodiment of the technology described herein. Referring now to FIG. 18, in this example, the time Event Correlation (TEC) is shown, by comparing the frequency of HVI-like events (graph (a)), and frequency of phone calls (graph (b)). The time scale in this example is in one-day increments 600, although other time scales can be used. In this example, there are two HVI-like events, 601, and 602, and one Phone Call Burst (PCB), 603. Since one of the characteristic events 601 occurs only one day after the PCB 603 occurred, this can be consider in some implementations as a Temporal Event Correlation, which may result in a soft (e.g., medium ranking) BAEVENT, for example.

3.11 Parametric Decision and Coherent Coupling

In order to avoid a correlation/causation contradiction, various embodiments separate causation and correlation methods within the ISS chain structure, as discussed above in Section 1.0. In particular, within this separation, HVIs may be organized within various kinds of social networks, such as terrorist networks, for example. Accordingly, in various embodiments, dynamic decision processes can be included, which, for example, can be dependent on power (intensity) and coherent coupling between HVIs, or other social network members. Whenever and wherever a decision should be made, there may be a spectrum of decisions to be considered, where one of them, (not necessarily the optimal one) will be selected. This section describes example processes for predicting the selected decision, using novel modeling based on coherent coupling.

In various embodiments, the system can be configured to consider the expected decision as weighted mean, <S>, where S-decision, and < . . . > symbolizes the mean average, while Sᵢ is a decision preferred by ith-member of a social network, and wᵢ is his/her weight, normalized to unity. This weight may be proportional to his/her strength, influence or power (intensity) within the network.

In further embodiments, the decision spectrum within the network for a given decision may be parameterized as a positive integer set (e.g., S₁, S₂, S₃, . . . , where S₁<S₂<S₃, . . . ). A decision parameter can be, for example, a risk factor, a cost factor, etc. The system may be configured such that a higher risk results in a higher S-value, and vice versa.

Coherent coupling may also be used as part of the analysis. Assume, for example, a quantity of N social network members (e.g., i=1, 2, 3, . . . , N) organized in the form of a graph (not graphiti), where i-nodes denote members and edges denote their mutual couplings. For example, edge ij represents a coupling between the ith and jth members. The member's strength, or kernel Kᵢ, can depend on his/her own strength, influence or intensity, Iᵢ, and his/her coherent coupling. The coherent coupling ij-term is proportional to a geometrical mean \sqrt{IᵢIⱼ} among member intensities, as well as to a coherency matrix element Tᵢⱼ. Coherency matrix element Tᵢⱼ may be defined as: Tᵢᵢ=1, and Tᵢⱼ≦1. The number of such coherent couplings for N-number of members is N (N−1)/2. For example, for N=5, we obtain 10 coherent connections.

However, these connections may be bi-directional, and matrix element, Tᵢⱼ, does not need to be equal to Tⱼᵢ, in general. In addition, there may also be, N self-couplings. Therefore, the total number of couplings, may be:

$$[ \frac{N ( N - 1 )}{2} ] ( 2 ) + N = {N}^{2} \qquad ( 8 )$$

3.11.1 Mathematical Model

The decision weighted mean, <S>, is

$$< S >= \frac{{\sum }_{i = 1}^{N} {S}_{i} {K}_{i}}{{\sum }_{i = 1}^{N} {K}_{i}} \qquad ( 9 )$$

where ith-weight, is

$${w}_{i} = \frac{{K}_{i}}{{\sum }_{i = 1}^{N} {K}_{i}} ; 0 ≦ {w}_{i} ≦ 1 , and {\sum }_{i = 1}^{N} {w}_{i} = 1 \qquad ( 10 a ; 10 b ; 10 c )$$

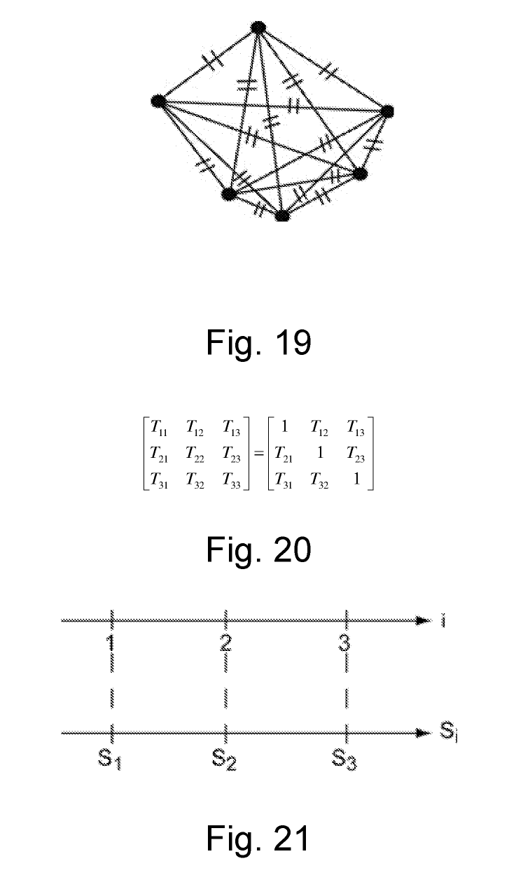

The social network members (i=1, 2, . . . N) may be organized within a graph, as shown in FIG. 19, where edges are denoted with the symbol “∥” to differentiate them from graphiti edges, as in FIG. 2, for example. In the example illustrated in FIG. 19, N=6. Therefore, N(N−1)/2=15, and N²=36.

The strength kernel, Kᵢ, may be defined as:

$${K}_{i} = {\sum }_{j = 1}^{N} {T}_{ij} \sqrt{{I}_{i} {I}_{j}} \qquad ( 11 )$$

where, for diagonal elements of the coherency matrix, Tᵢⱼ, we have:

Tᵢᵢ=1 (12)

while all (real, positive) matrix elements satisfy the inequality:

Tᵢⱼ≦1 (13)
Where the convention used is such that Tᵢⱼ means: the ith-member influencing the jth-member, and Tⱼᵢ is the reverse.

FIG. 20 is a diagram illustrating an example of such a coherency matrix for N=3. In instances where members have identical strengths:

Iᵢ=I=CONSTANT (14)

and, Eq. (7) becomes:

$${K}_{i} = I {\sum }_{j = 1}^{N} {T}_{ij} \qquad ( 15 )$$

and, the weight, is

$${w}_{i} = \frac{{\sum }_{i = 1}^{N} {T}_{ij}}{{\sum }_{i = 1}^{N} {\sum }_{j = 1}^{N} {T}_{ij}} \qquad ( 16 )$$

In other words, the weight depends only on the coherency matrix elements. This represents a crowd-like environment, where N is a large number. In the case where all coupling elements are equal:

Tᵢⱼ=T=const (17)

And the weight simply becomes

$${w}_{i} = \frac{1}{N} \qquad ( 18 )$$

However, this formula is valid only for very strong couplings, since: Tᵢᵢ=1.

Normal Parametric Order.

For purposes of discussion, consider a natural assumption that the coupling is the strongest between members with close parameters. This can be accomplished, for example, by applying a Normal Parametric Order (NPO). FIG. 21 is a diagram illustrating an example of applying an NPO in the case of N=3. Referring now to FIG. 21, in such a case, a monotonic parameterization can be assumed in which:

S₁<S₂<S₃ (19)

as shown in FIG. 21.

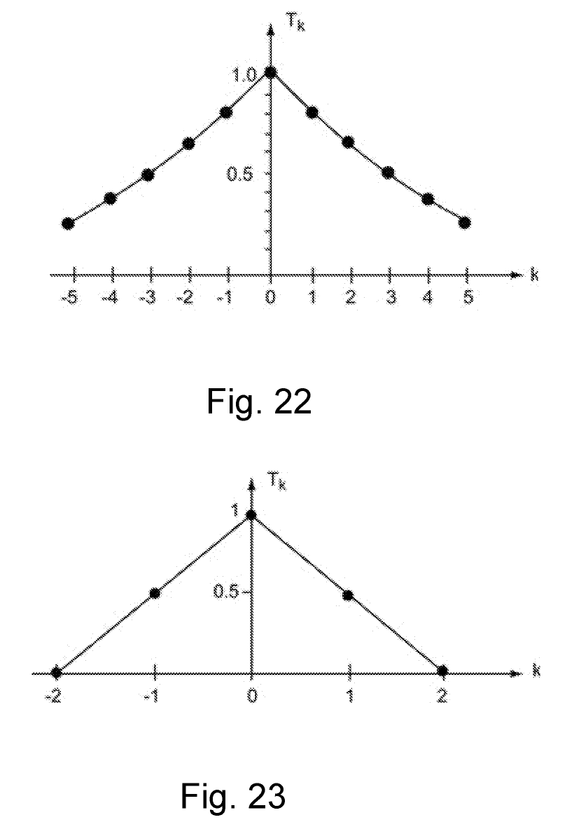

FIG. 22 illustrates an example of a normal parametric order. In the example illustrated in FIG. 22, only three members are considered (i=1, 2, 3), and each member has monotonic preferable decision, as in Eq. (19). This scheme may be generalized to cases in which N>3. In such a case for the NPO, we can introduce a new k-index, in the form:

k=i−j (20)

Thus, the NPO represents space-invariant case, in the form:

Tᵢⱼ=Tᵢ₋ⱼ=Tₖ (21)

Now, the NPO can be defined as the system with the following basic properties for the coherency matrix elements (as shown in FIG. 22):

a) Space invariant (22a)

b) Symmetrical (22b)

c) Monotonic (22c)

In FIG. 22, three (3) basic properties of the Normal Parametric Order (NPO) are illustrated, including: space-invariance; symmetry; and monotonic. The NPO is space invariant because according to Eq. 17, the coherency matrix element, Tₖ, depends only on one index, k, where, for i=j, we have: Tᵢᵢ=Tₒ=1.

Also, the NPO is symmetrical (please, see, Eq. 22(b)) because:

Tₖ=T₋ₖ (23)

The NPO is also monotonic (22c), or constantly decreasing. In contrast, the abnormal or anomalous distribution will violate one or more of those properties. As an example of the NPO distribution, consider another case in which N=3 as illustrated in FIG. 23. In FIG. 23, the space-invariant coherency matrix elements, are:

T₀=1; T₁=T₋₁=0.5; T₂=T₋₂=0 (24a;24b;24c)

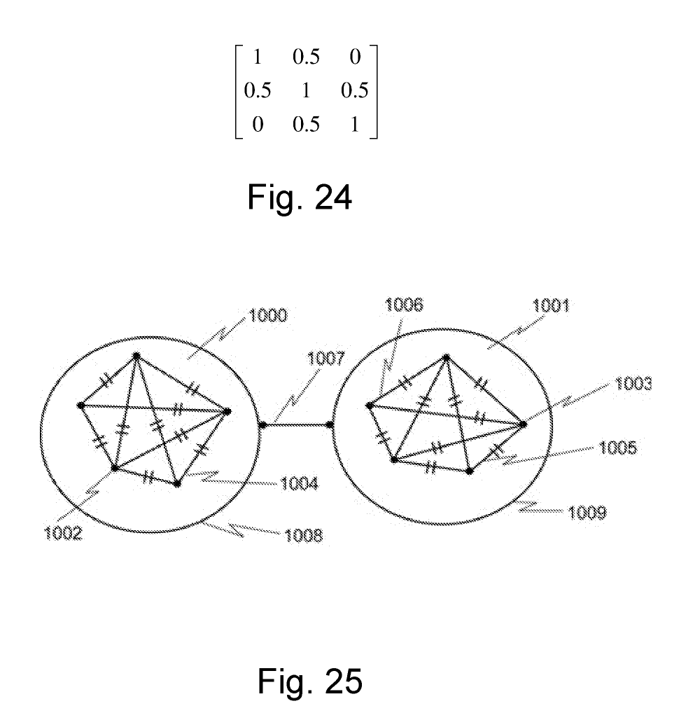

In FIG. 24, the related coherency matrix is shown.

For illustration, we consider two examples, one satisfying Eqs. (24a; 24b; and 24c) and the other one not satisfying this relation. In both cases, the following parametric decision parameter values apply:

S₁=1; S₂=5; S₃=10 (25a;25b;25c)

In the 1^{st} case, the kernel values are:

K₁=T₁₁I₁+T₁₂\sqrt{I₁I₂}+T₁₃\sqrt{I₁I₃}=(1)I+(0.5)I+(0)I=1.5I (26)

K₂=T₂₁\sqrt{I₂I₁}+T₂₂I₂+T₂₃\sqrt{I₂I₃}=(0.5)I+(1)I+(0.5)I=2I (27)

K₃=T₃₁\sqrt{I₃I₁}+T₃₂\sqrt{I₃I₂}+T₃₃I₃=(0)I+(0.5)I+(1)I=1.5I (28)

Thus, the kernel sum, is

K₁+K₂+K₃=1.5I+2I+1.5I=5I (29)

and, the weights, are:

w₁=1.5/5=0.3; w₂=2/5=0.4; w₃=1.5/5=0.3 (30a;30b;30c)

Therefore, the weighted (decision) mean, is

<S>=(1)(0.3)+5(0.4)+10(0.3)=0.3+2+3=5.3 (31)

In the 2^{nd} case, we assume that Eq. (14) is not satisfied. Instead, we assume:

I₁=4Iₒ; I₂=Iₒ; I₃=Iₒ (32a;32b;32c)

Then, we have:

K₁=(1)4Iₒ+(0.5)\sqrt{4IₒIₒ}+(0)\sqrt{4IₒIₒ}=4Iₒ+1Iₒ+0=5Iₒ (33)

K₂=(0.5)(2Iₒ)+(1)(Iₒ)+(0.5)(Iₒ)=2.5Iₒ (34)

K₃=(0)Iₒ+(0.5)Iₒ+(1)Iₒ=1.5Iₒ (35)

and,

K₁+K₂+K₃=5Iₒ+2.5Iₒ+1.5Iₒ=9Iₒ (36)

and, the weights, are

w₁=5/9=0.55; w₂=2.5/9=0.28; w₃==1.5/9=0.17 (37)

As a check, the following relation can be examined:

w₁+w₂+w₃=55+0.28+0.17=1 (38)

Thus, the mean decision, is

<S>=1(0.55)+5(0.28)+10(0.17)=3.61 (39)
i.e., smaller than that from Eq. (30), where: <S>=5.3. We see that higher strength (intensity) of I₁=4I₀ (vs. I₁=Iₒ), created more attraction into decision, S₁ (since, S₁=1), as it is expected.

3.11.2 Anomalous Coupling

Any deviations from the Normal Parametric Order, we classify as Anomalous Coherent Coupling (ACC). Such deviations may be presented in the series form:

Tᵢⱼ=Tᵢⱼ⁽⁰⁾+Tᵢⱼ⁽¹⁾+Tᵢⱼ⁽²⁾+ . . . (40)
where the zero^{th} term, Tᵢⱼ⁽⁰⁾, is related to the NPO and the subsequent terms relate to the anomalous order. They usually are of the 1^{st} order, or higher-order small quantities, but they may sometimes be comparable with the zero-order term. These deviations can violate any of the properties (equations 19a, 19b 19c) of the NPO, or a combination of thereof.

3.11.3 Dynamic Coupling

In addition to the anomalies, the coherent coupling can be a dynamic coupling. In some embodiments, it can be in the form:

Tᵢⱼ=Tᵢⱼ(t) (41)
where t is time. This dynamic coupling can be obtained from some intelligence data, such as data related to personal relations, or any other mutual relations, but typically not from the typical relation of closer opinion=stronger coupling. (It should be noted that the individual strength has already been included in the form of intensities).

For prediction purposes, the process may typically begin with the normal form, and then introduce deviations according to Eq. (40). Then, the weighted mean, <S>, will be evaluated as a function of time; leading to a new or refined conclusion. The coherency matrix (and intensity) can also be changed by design in order to model or evaluate what would happen if conditions were to change.

3.11.4 Inter-Group Coupling

Group interaction can have a similar form to an interaction between individuals. However, in some embodiments, group kernels are introduced as more global figures. These can be in the form:

Kₘ; m=1,2,3, . . . M (42)
where M is the number of groups. The modeling can be similar, but preferably, group kernels are located and identified.

FIG. 25 is a diagram illustrating an example of identifying group kernels in accordance with one embodiment of the technology described herein. In FIG. 25, two exemplary groups 1000 and 1001 are presented in the form of graphs (not graphitis). The nodes, such as 1002, and 1003, for example, represent individuals, while edges, such as 1004, 1005, 1006, for example, represent coherent couplings between nodes. The connection 1007 represents group coupling outside of group boundaries 1008 and 1009 defining a group territory. After finding group kernels, the system applies a generalization of formula (5), which can be in the form:

$$〈 S 〉 = \frac{{\sum }_{m = 1}^{M} {S}_{m} {K}_{m}}{{\sum }_{m = 1}^{M} {K}_{m}} \qquad ( 43 )$$

where M is the number of groups, and m is a group index. The system can be configured to also apply other formulas (e.g., 6-7), in an analogous fashion.

Section 4: Bayesian Truthing Inference (Outer Network)

4.1 Bayesian Inference and Binary Sensors

The experimental validation (truthing) used by the systems and methods described herein is, in some embodiments, based on a Bayesian Truthing Inference (BTI). The BTI is a novel concept derived from Bayesian inference and Binary Sensors formalism. Following signal theory, consider two exclusive events: a signal (target) event, denoted by the capital letter 5; and a no-target event (noise), denoted as N, with so-called prior absolute probabilities, p(S) and p(N), respectively. These can be configured to satisfy the conservation relation:

p(S)+p(N)=1 (44)

The binary event (S, N) is detected by binary sensor, with two exclusive readings. For example two readings can be an alarm (5′) and no alarm (N′). Their probabilities can satisfy the conservation relation:

p(S′)+p(N′)=1 (45)

In the ISS case, the binary sensor decision may be made by sub-module #2b 404, as shown in FIG. 6. For example, this can be done by producing an alarm (e.g., a yellow alarm) sent into Module #6 402, informing Module #6 402 that a given HVIC has been qualified as HVI. A no alarm event can be determined to mean that the given HVIC has not been qualified as HVI. Therefore, a hard decision is made by sensor 404, and this is a binary decision (while a soft decision can be referred to as omniary—i.e., it can have more than 2 states).

Likelihood Probabilities.

The likelihood probabilities are (direct) conditional probabilities about the probability of the binary decisions S′ or N′, assuming that the binary event occurred. It is noted that symbols “S” should not be confused with the parametric decision symbol.

p(S′|S)—probability of detection (POD) (46a)

p(N′|N)—probability of rejection (POR) (46b)

p(S′|N)—probability of false positives (PFP) (46c)

p(N′|S)—probability of false negatives (PFN) (46d)

They satisfy the following conservation relations:

p(S′|S)+p(N′|S)=1 (47)

p(S′|N)+p(N′|N)=1 (48)
The name “false positive,” for example, may be chosen because a positive reading (5′) is false in circumstances where no target event (N) actually occurred.

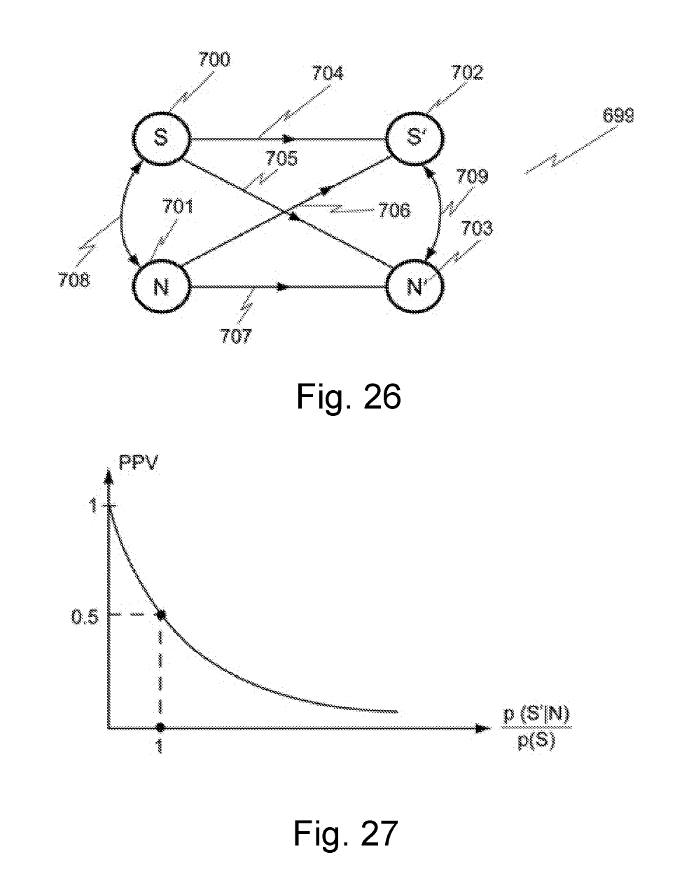

FIG. 26 is an example of a Bayesian Inference causality diagram in accordance with one embodiment of the technology described herein. In the example of FIG. 26, a Bayesian Inference causality diagram 699 is shown for binary sensors. This example illustrates two events (S, N) as causes 700 and 701, and two sensor readouts 702 and 703 as effects. In the illustrated example, this causation relation is well defined, because the causation relations 704, 705, 706, and 707 are unidirectional, while both causes 700 and 701 and effects 702 and 703 are mutually exclusive. Also shown by this example is that diagram 699 represents a probability (Bayesian) network, with the conservation Eq. (44), denoted by 708, and the conservation Eq. (45), 709. Also, the causation connection 704 represents probability of detection p(S′|S) (Eq. (46c)), while the probability of false negatives p(N′|S) (Eq. (46d)), for example, is represented by connection 705.

4.2 Positive Predictive Value and Bayesian Paradox

Using Bayes theorem, inverse conditional probabilities such as p(S|S′), p(N|N′), p(N|S′), and p(S|N′) can also be considered and utilized. Probabilities p(S|S′) p(N|N′) may be important for the evaluation, including that of the Positive Predictive Value (PPV). The Positive Predictive Value can be in the form:

(PPV)=p(S|S′) (49)

and Negative Predictive Value (NPV), in the form:

(NPV)=p(N|N′) (50)

Using Bayes theorem for binary sensors the following relation for (PPV) FOM can be derived:

$$\begin{matrix}( PPV ) = p ( S \vert {S}^{′} ) = \frac{1}{1 + {q}_{1}} \\ where & ( 51 ) \\ {q}_{1} = \frac{p ( {S}^{′} \vert N ) p ( N )}{p ( {S}^{′} \vert S ) p ( S )} & ( 52 )\end{matrix}$$

Because the target events are usually rare, we can write:

p(S)<<1 (53)

thus, p(N)≅1. Also, false negatives are usually low: p(N′|S)<<1; thus,

p(S′|S)≅1 (54)

and Eq. (10) reduces to the following form:

$$( PPV ) = p ( S \vert {S}^{′} ) = \frac{1}{1 + \frac{p ( {S}^{′} \vert N )}{p ( S )}} \qquad ( 55 )$$

This formula may be referred to as the Bayesian Paradox, because, in spite of high value of Probability of Detection, as in Eq. (54), the PPV-critical figure can be low, especially for a low prior (target) population, as in Eq. (53). FIG. 27, illustrates an example Bayesian Paradox. According to FIG. 27, the following relation is satisfied:

$$\frac{p ( {S}^{′} \vert N )}{p ( S )} > 1 ⇒ ( PPV ) < 0.5 \qquad ( 56 )$$

i.e., if the prior probability, p(S), is smaller than the probability of false positives, p(S′|N), then, the (PPV) is smaller than 50%. Thus, in order to obtain high (PPV)-values, the system can be configured to produce a relatively high prior population. In some embodiments, this is much higher than likelihood probability of false positives:

p(S′|N)<<p(S) [symbol] (PPV)≅1 (57)

In contrast to the PPV, the NPV-figure is typically always close to 100%, in practice.

4.3 Bayesian Truthing

4.3.1 Truthing Sampling Space

The Truthing Sampling Space (TSS) is discrete and can be quantized by sample units (such as HVICs, for example) in which the number of samples, m, may be very large:

m>>1 (58)

Nine exemplary truthing parameters can be considered in various embodiments. For purposes of discussion, these example parameters are defined by lower case letters as listed below.

m—number of samples (59a)

s—number of targets(signals) (59b)

n—number of no-targets(noises) (59c)

a—number of alarms (59d)

a₁—number of true alarms (59e)

a₂—number of false alarms (56f)

b—number of no-alarms (59g)

b₁—number of true no-alarms (59h)

b₂—number of false no-alarms (59i)

Using these parameters, Bayesian probabilities, such as a prior (target) probability, for example, can be defined:

$$p ( S ) = {lim}_{m -> ∞} \frac{s}{m} \qquad ( 60 )$$

Based on this method, the previous statistical relations can be derived using truthing parameters such as:

n+s=m (61a)

a+b=m (61b)

a=a₁+a₂ (61c)

b=b₁+b₂ (61d)

a₁+b₂=s (61e)

b₁+a₂=n (61f)

Among these six (6) example statistical relations, five (5) of them are independent, while the total number of truthing parameters is nine (9):

m,s,n,a,a₁,a₂,b,b₁,b₂ (62)

Therefore, four (4) parameters are free, while the remaining five (5) can be found by solving the five (5) independent Eqs. (61a,b,c,d,e & f).

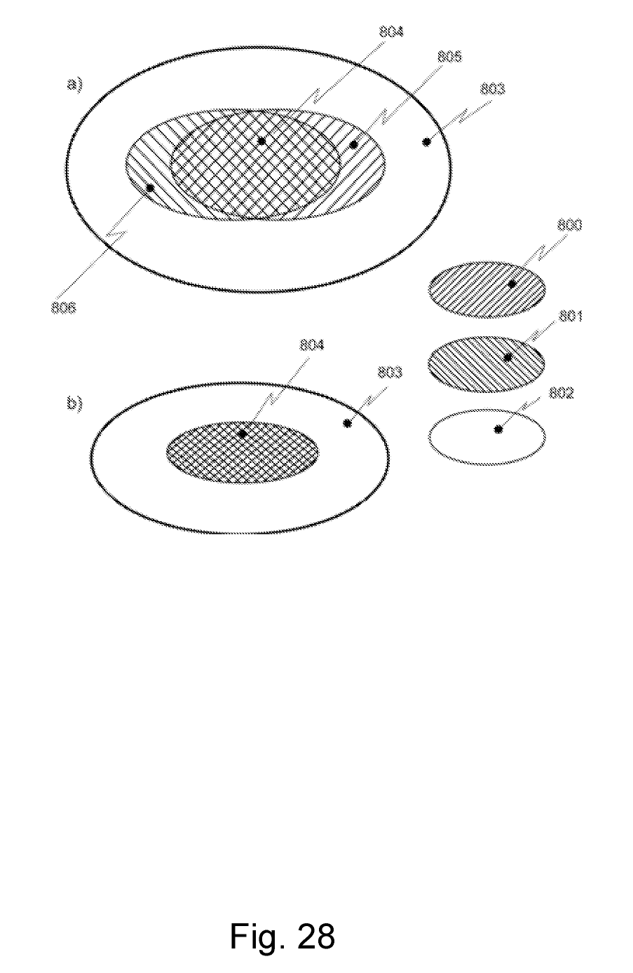

In FIG. 28, examples of Bayesian Truthing Sets are illustrated, including a non-ideal system (a) and an ideal system (b). The example target set 800 is north/east-south/west shaded; while the alarm set 801, is north/west-south/east shaded. A no-target & no-alarm set 802 represents true no-alarms. Therefore, the crosshatched set 804 represents true alarms (a₁). On the other hand, the no-alarm set, 803, represents true no-alarms (b₁). Then, the set 805 is the target set which is not alarmed; i.e., false no-alarms (b₂), while the set 806 is the noise set, which is alarmed (i.e., false alarms (a₂)).

In FIG. 28 with the ideal system b), however, there are no single-hatched sets (a₂=b₂=0); thus, representing the ideal system. Also, using FIG. 28 for the non-ideal system a), the conservation relations (58e) and (58f) can be identified. For example, symbolically this can be written as

“804”+“805”=“800” (63)

which is equivalent to Eq. (61c), because symbolically:

a₁=“804,” b₂=“805,” s=“800” (64a;64b;64c)

4.4 Bayesian Truthing Theorem (BTT)

The Bayesian Truthing Theorem (BTT) can be easily derived, using the truthing parameters in Eq. (62). Using parameters from Eq. (62), the likelihood probabilities can be rewritten in the form:

$$\begin{matrix}p ( {S}^{′} \vert S ) = \frac{{a}_{1}}{s} & ( 65 a ) \\ p ( {N}^{′} \vert S ) = \frac{{b}_{2}}{s} & ( 65 b ) \\ p ( {S}^{′} \vert N ) = \frac{{a}_{2}}{n} & ( 65 c ) \\ p ( {N}^{′} \vert N ) = \frac{{b}_{1}}{n} & ( 65 d )\end{matrix}$$

Substituting these into Eq. (52) yields:

$${q}_{1} = \frac{p ( {S}^{′} \vert N ) p ( N )}{p ( {S}^{′} \vert S ) p ( S )} = \frac{( \frac{{a}_{2}}{n} ) ( \frac{n}{m} )}{( \frac{{a}_{1}}{s} ) ( \frac{s}{m} )} = \frac{{a}_{2}}{{a}_{1}} \qquad ( 66 )$$

Therefore, the PPV-para meter, is

$$( PPV ) = \frac{1}{1 + {q}_{1}} = \frac{1}{1 + \frac{{a}_{2}}{{a}_{1}}} = \frac{{a}_{1}}{a} \qquad ( 67 )$$

which is the Bayesian Truthing Theorem (BTT), the basic Bayesian formula for the ISS evaluation. It can be written as:

$$( PPV ) = p ( S \vert {S}^{′} ) = \frac{NUMBER OF TRUE ALARMS}{TOTAL NUMBER OF ALARMS} \qquad ( 68 )$$

It should be noted that this formula can be used without knowledge of the Bayesian inference; because the number of alarms, true and false, can be directly found from experimentation.

In a similar way, the NPV-figure can be derived, as

$$( NPV ) = \frac{{b}_{1}}{b} = \frac{NUMBER OF TRUE NO - ALARMS}{TOTAL NUMBER OF NO - ALARMS} \qquad ( 69 )$$

### Where NPV is the Negative Predictive Value.

4.5 Analogy Between X-Ray Luggage Inspection and the ISS

The Binary Sensor concept has broad applicability, and it can be used in applications such as, for example, ATR (Automatic Target Recognition); QC (Product Inspection); Homeland Security (X-Ray Luggage Inspection against Explosives); Legal (Judicial Verdict); Medicine (X-Ray Breast Cancer Diagnosis); Software (ISS); to name a few. In any case, the target is typically some anomalous sample such as, for example, Luggage with Explosives, a Positive Cancer Diagnosis, a Defective Product, HVI, etc. The case of x-ray luggage inspection at airport terminals is perhaps the easiest case to explain, and will be used herein by way of example. Therefore, Table 6 presents a comparison between the x-ray luggage inspection and the ISS.

TABLE 6
Comparison of Statistical and Truthing*⁾ Parameters for X-Ray
Luggage Inspection and Integrative Software System (ISS)

| | | | | Integrative |
|---|---|---|---|---|
| | | | X-Ray Luggage | Software System |
| No | Parameter Name | Symbol | Inspection | (ISS) |
| 1 | Sample (Number) | m | One Luggage | HVIC** |
| 2 | Target | S | Luggage with | HVI*** |
| | | | Explosives | |
| 3 | Noise (No Target) | N | Luggage with No | Non-Adverse |
| | | | Explosives | Person |
| 4 | Target (Number) | s | Targets' Number | Targets' Number |
| 5 | Alarm | S′ | System Alarm | System Alarm |
| 6 | True/False Alarm | a₁/a₂ | True/False Alarms' | True/False |
| | (Number) | | Number | Alarms' Number |

*⁾“Truthing” name is introduced by analogy to radar truthing, where target/clutter mockups/natural objects have been tested at the ground by airborne radar.
**High-value-individual “candidate.”
***High-value-individual (IED network member, for example).

4.6 Numerical Examples Illustrating ISS Bayesian Truthing

For explanation by way of example of an ISS Bayesian Truthing, consider a number of numerical examples illustrating orders of magnitude of basic truthing parameters, by applying (arbitrarily) four (4) free parameters.

### Example 5

Consider a sample size m=10⁷ (large sample); p(S)=10⁻⁶ (rare events); p(S′|N)=10⁻⁵; p(N′|S)=10⁻³. In this example,

$$\begin{matrix}p ( S ) = \frac{s}{m} ⇒ s = mp ( s ) = ( {10}^{7} ) ( {10}^{- 6} ) = 10 \\ and & ( 70 ) \\ p ( {N}^{′} \vert S ) = \frac{{b}_{2}}{s} ⇒ {b}_{2} = sp ( {N}^{′} \vert S ) = ( 10 ) ( {10}^{- 3} ) = {10}^{- 2} & ( 71 )\end{matrix}$$

Eq. (71) shows, that, in spite of relatively large false negatives (10⁻³), target misses almost never occur (b₂<<1).

Furthermore:

n=m−s=10⁷−10=9999990 (72)

and,

P(S′|N)=10⁻⁵ [symbol] a₂=np(S′|N)=(9999990)(10⁻⁵)≅100 (73)

and,

b₁=n−a₂=9999990−100=9999890 (74)

thus,

b=b₁+b₂=9999890+10⁻²=b₁ (75)

Therefore, because b₂<<1, then, b≅b₁, and, indeed the Negative Predictive Value is as follows

(NPV)≅1 (76)

In order to find the PPV-figure, however, we need to find the numbers of true alarms, a₁, and total number of alarms, a, in the form:

a=m−b=10⁷−9999890=110 (77)

while,

a₁=a−a₂=110−100=10 (78)

thus, the PPV-figure is low:

$$( PPV ) = \frac{{a}_{1}}{a} = \frac{10}{110} = 0.09 = 9 \% \qquad ( 79 )$$

In fact, this value could be anticipated by applying the Bayesian Paradox formula with an approximate q₁-value, which can (directly) be found from the input data:

$${q}_{1} = \frac{p ( {S}^{′} \vert N )}{p ( S )} = \frac{{10}^{- 5}}{{10}^{- 6}} = 10 \qquad ( 80 )$$

so, approximately, the PPV-value, is

$$( PPV ) = \frac{1}{1 + {q}_{1}} \tilde{=} \frac{1}{1 + 10} = 0.09 \qquad ( 81 )$$

which coincides with Eq. (67).

For further checking, the conservation formula yields:

a+b=110+9999890=10⁷ (82)

### Example 6

Assume m=10⁷, s=10, a₂=b₂=10⁻². This time, we are applying only truthing parameters. Thus, calculation of the Bayesian figures: PPV and NPV is much simpler; because,

a≅a₁; h≅b₁ (83a; 83b)

thus,

(PPV)=(NPV)≅1 (84)
and the system is close to ideal one (almost no false negatives and no false positives).

4.7 Relations Between Non-Diagonal Statistical and Truthing Parameters

The non-diagonal Bayesian statistical parameters are probabilities of false positives and false negatives. By analogy, the non-diagonal Bayesian truthing parameters can be defined as the Probability of a False Alarm (PFA) and the Probability of a False no-Alarm (PFnA), in the form:

$$\begin{matrix}( PFA ) = \frac{{a}_{2}}{m} & ( 85 a ) \\ and & \\ ( PFnA ) = \frac{{b}_{2}}{m} & ( 85 b )\end{matrix}$$

Then:

$$\begin{matrix}{b}_{2} = m ( \frac{n}{m} ) ( \frac{{b}_{2}}{s} ) = mp ( N ) p ( {N}^{′} \vert S ) & ( 86 ) \\ and , & \\ {a}_{2} = m ( \frac{n}{m} ) ( \frac{{a}_{2}}{n} ) = mp ( N ) p ( {S}^{′} \vert N ) & ( 87 )\end{matrix}$$

Therefore, the following relations between non-diagonal truthing and statistical parameters can be derived:

$$\begin{matrix}( PFA ) = \frac{{a}_{2}}{m} = p ( N ) p ( {S}^{′} \vert N ) & ( 88 ) \\ ( PFnA ) = \frac{{b}_{2}}{m} = p ( S ) p ( {N}^{′} \vert S ) & ( 89 )\end{matrix}$$

These relations are non-singular, because, for statistical purposes, the prior probability can neither equal 1 nor 0:

0<p(S)<1 (90)
Therefore, the ideal system, with both zero false negatives and zero false positives, is possible, by satisfying the relations

(PFA)=(PFnA)=p(S′|N)=p(N′|S)=0 (91)

Also, because targets are usually rare events:

P(S)<<1 [symbol] p(N)≅1 (92)

thus, according to Eq. (88), we obtain:

(PFA)≅p(S′|N) (93)
i.e., the Probability of False Alarm (PFA) is (almost) equal to Probability of False Positives (PFP).

However, according to Eq. (89), the Probability of False no-Alarm, PFnA, is much smaller than the Probability of False Negatives (PFN):

(PFnA)<<p(N′|S) (94)

This is why in Example 5, the result is b₂<<1, in spite of the fact that the PFN is rather high (10⁻³).

4.8 Lossless Multi-Alarm Method

In spite of the fact that the ideal system can be realized theoretically as in Eq. (88), practically, there is a trade-off between false positives and false negatives. Therefore, very often, the target misses are low, while the PFA is high. Therefore, in various embodiments, a multi-step (multi-alarm) cascade Lossless Multi-Alarm (LMA) method can be applied. Thus, assuming:

$$\begin{matrix}{b}_{1} \tilde{=} b & ( 95 ) \\ with , & \\ ( PPV ) = \frac{{a}_{1}}{a} << 1 & ( 96 )\end{matrix}$$

the LMA method can be applied.

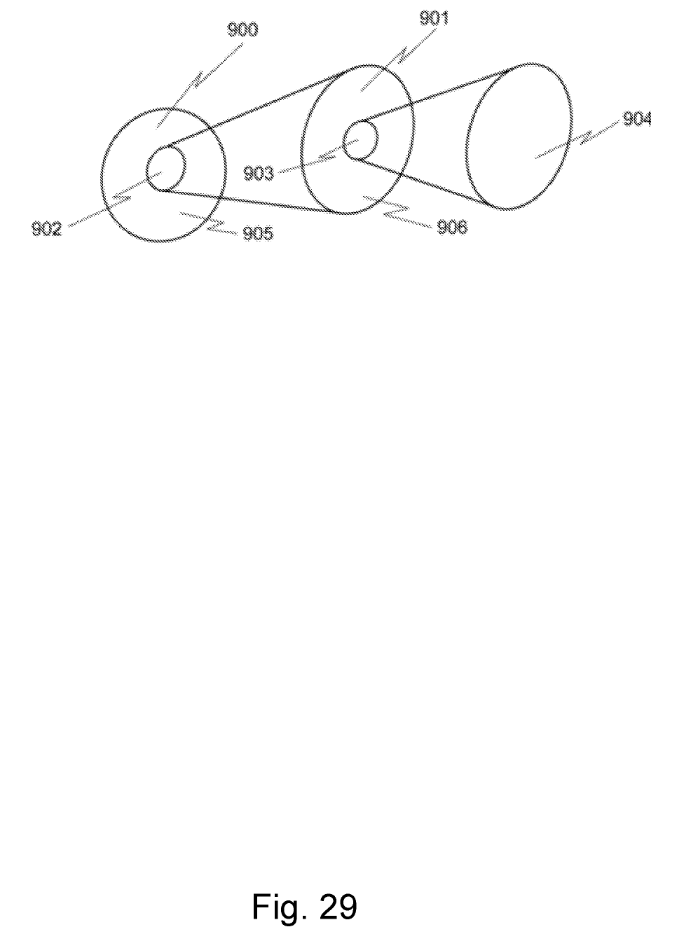

FIG. 29 is a diagram illustrating an example methodology of an LMA method. This example includes two (2) sampling spaces 900 and 901. Assuming Eqs. (95-96) are satisfied, the 1^{st} alarm, 902, is produced with (almost) zero false negatives (b₂<1), but high false positives ((PPV)<<1). Then, the 2^{nd} sampling space 901 does not have (almost) target misses; i.e., the whole target (prior) population is preserved. Then, the 2^{nd} alarm 903 is produced, in order to reduce false positives. This results in the output 904 as a high (PPV)-value. Therefore, a two-sensor method, including Sensor 1 905 and Sensor 2 906 is better than a single-sensor method, if we are able to differentiate sensor technology into two sensor subsystems.

Such a situation may be realized in medical diagnostics, for example, based on x-ray breast cancer inspection (Sensor 1, 905). In order to avoid a biopsy in the second step, the patients with a positive cancer diagnosis after Sensor 1 (satisfying conditions 95-96) are sent to some other specialized diagnosis shown by Sensor 2, 906. This diagnosis can be, for example, ultrasound. Then, patients with output 904 satisfying a high PPV-value are finally sent to the biopsy.

Section 5: System Performance Components (Outer Network)

This section discusses some exemplary critical performance components for effective performance of the ISS (some of which have already been discussed in previous sections).

5.1 Cost Function

The training of an Integrative Software System may be provided with the help of a cost function, CF, defined as:

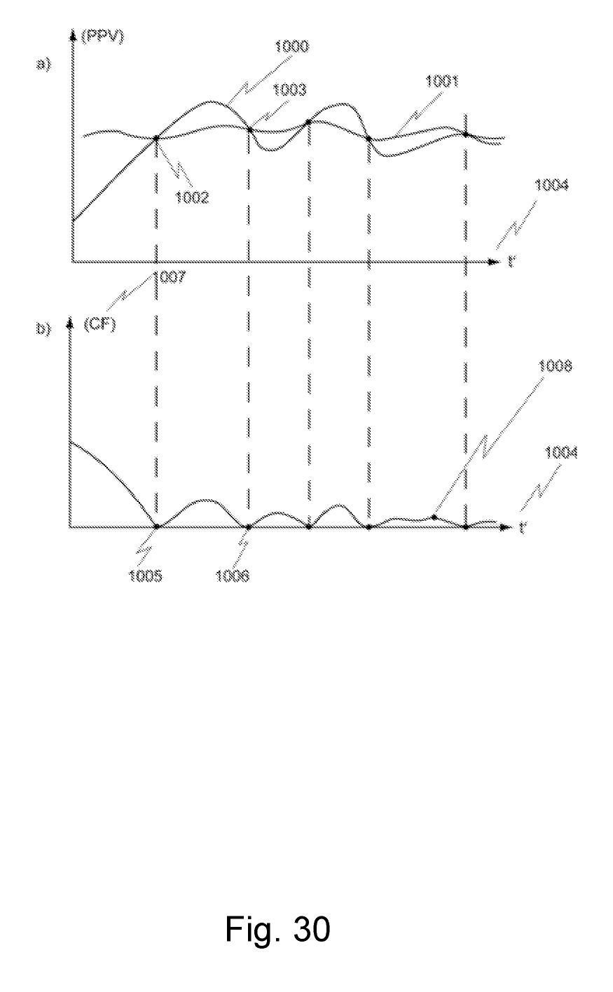

(CF)=|(PPV)_{TH}−(PPV)_{EXP}| (97)

where | . . . | is a modulus (absolute value) operation. The (PPV)_{TH} is based on a Bayesian Paradox formula (in the simplest case, equal to this formula). This parameter can be obtained only with help of Bayesian inference, including a statistical parameter, such as a PFP. It may be obtained either automatically as linear regression from training data, or semi-automatically with help of expert queries. Therefore, theoretically, this parameter is based on prior absolute and likelihood probabilities. It depends on prior population, p(S), and system performance, defined mostly by p(S′|N)−(PFP) value. Increased training in the target population also increases the (PPV)_{TH} parameter. Then, for a constant prior population influx, the (PPV)_{TH} parameter remains constant, or varies slowly. In contrast, the (PPV)_{EXP} parameter may be strongly fluctuating. In some embodiments, the system is configured to increase its value by training (it can be defined as ratio of red alarms to yellow alarms), until it stabilizes, as shown in FIG. 30.

In FIG. 30 at chart a), both (PPV)-parameters are shown, including (PPV)_{EXP}-parameter, 1000, and (PPV)_{TH}, 1001, with the nodes 1002, 1003, etc., defining a crossing of these two functions during a training process. This is characterized by time the scale t′ denoted as 1004. These nodes, 1002 and 1003, for example, correspond to (CF) function's 1007 zero values 1005 and 1006, respectively. This illustrates that the CF-function fluctuates with fluctuations decreasing as time t′ increases. In the case of well-performed training, these fluctuations decrease asymptotically to zero, as shown by part of CF-curve 1008 (chart b)).

The introduction of a (PPV)_{TH} support function (during the ISS training) is analogous to applying mockup prey as an attraction to dogs in the initial stage of a dog race.

5.2 System Feedback

At least two (2) feedback mechanisms are introduced in FIG. 4. The 1^{st} one is a local feedback path and includes a switch at module #7, which performs a cost function minimization. This feedback can be configured to regulate and minimize cost function fluctuations, as in FIG. 30. This can be achieved, for example, by regulating (increasing/decreasing) prior population and system performance (e.g., by adding mockups, or natural objects).

The 2^{nd} feedback in this example is global feedback (#15, #16, #17, #2), which maximizes global (PPV) as a ratio of red alarms to yellow alarms, by regulating (PPV)_{EXP} function. This can be accomplished, for example, in the following form (the other form derivatives are also possible; this one is the simplest one):

$${( PPV )}_{EXP} = \frac{NUMBER OF RED ALARMS}{TOTAL NUMBER OF YELLOW ALARMS} \qquad ( 98 )$$

This feedback can be configured in some embodiments to minimize fluctuations of the (CF) function, as shown in FIG. 30.

5.3 Dual Engine Connection

Two basic system engines #2 and #10, as illustrated in the example of FIG. 4, can be configured to work in parallel, producing independent results. This can be done, for example, in order to maximize the system performance quality and efficiency. The intra-cloud engine #2 produces HVIs, which may be selected from HVICs, as yellow alarms. The inter-cloud engine #10 can be configured to produce graphitis, with CP# as graphiti nodes. One goal in various embodiments is to identify a maximum number of the HVIs with CP#, in order to produce real alarms. This can be done, for example, by Dual Engine Connection (DEC), which is a sub-module of engine #10.

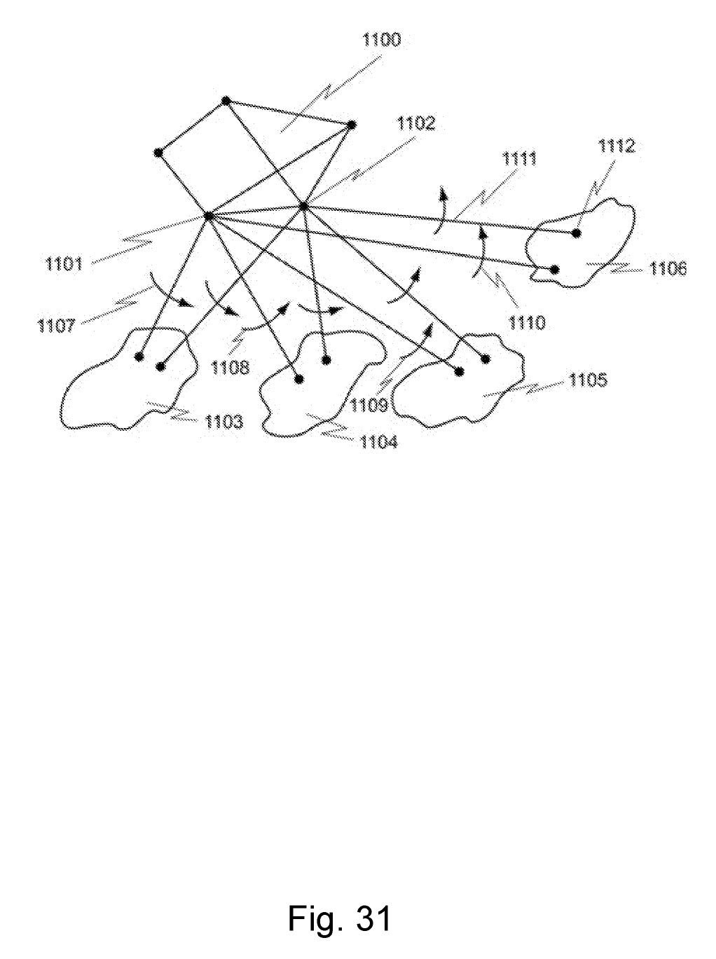

The DEC method is a kind of compound association, specialized for producing HVI-CP# pairs (HVI-CP pairs). FIG. 31 is a diagram illustrating a DEC method in accordance with one embodiment of the technology described herein. In the illustrated example, the DEC is an inter-cloud association.

Referring now to FIG. 31, in this example a sample graphiti 1100 is applied with two possible nodes 1101 and 1102 applied as an example. Important in some embodiments, is that those two nodes can be applied in parallel as well as many other nodes, depending only on computing processing power. Also four (4) exemplary clouds (or databases) 1103, 1104, 1105, and 1106, may be applied. The nodes, such as 1101 and 1102 may be identified by their Cyberphone numbers (CP#).

The graphiti operation may be produced by a graph engine #10. In parallel, the intra-cloud engine #2 may be configured to select HVIs as yellow alarms. Finding the dual engine connection (DEC) between such a CP# and an HVI, if successful, produces a red alarm, or pre-alarm, if the training feedback is applied. Such a connection can be readily located in the case of a regular person who does not try to hide his/her identity. However, in the case of the HVIC who purposely hides his/her identity, the situation may be more complex. One challenge may be that such an HVIC, or HVI can assume multiple identities with multiple IDs, such as: various names, driver's licenses, passports, CP#s, etc., which he or she might use only a few times. Nevertheless, he/she is using them sometimes (including at times when a given graphiti exists within the ISS computer system). Therefore, if the target population is temporarily more narrowly defined, as in FIG. 29, for example, the DEC can be identified, and the successful HVI-CP pair can be produced. This is why each CP#, representing a given graphiti (such as 1101, for example) may be configured to be “searching” all clouds (1103, 1104, 1105, 1106, etc.) at the same time, through all available lists of CP#s and equivalent names. Example lists can include, for example, phone books, financial transactions, buy/sell lists, affiliation lists, etc. This scanning process, which may in some embodiments be relatively fast, is illustrated by arrows, including the following arrows for node, 1101. These include arrows, such as: 1107, 1108, 1109, 1110; same with the 2^{nd} node, 1102, and other nodes. Finally, some successful DEC pairs can be found, such as 1111, for example, by identifying the CP# of node 1102, with HVI 1112.

Section 6: Network Inner Coherency (Inner Network)

6.1 Inner Network Coherency

A summary of network inner coherency is now discussed. Examples of this are described in greater detail in Sections 3.11 and Section 7. The inner coherency of an (adverse) network, such as a terrorist or organized crime network, is introduced in order to further improve the network search and detection. The network members may, for example, be either individuals, (or HVICs), or groups of individuals, called Groups of Interest (GOIs).

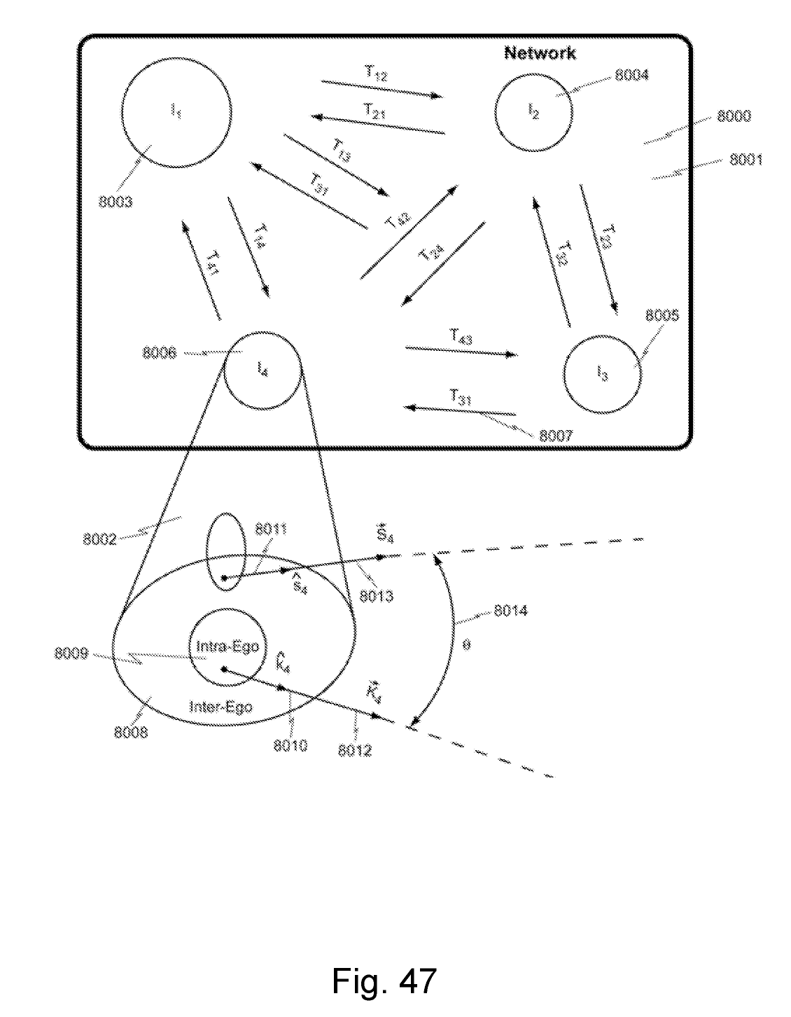

FIG. 47 is a diagram illustrating an example of an inner coherency structure of adverse/hostile network 8000. The example illustrated in FIG. 47 includes inter-GOI coherency coupling 8001 and intra-GOI coherency coupling 8002. The inter-GOI coherency includes examples of the GOI's self-strengths (intensities) I₁, I₂, I₃, I₄, denoted as 8003, 8004, 8005 and 8006 respectively. Accordingly, the number of network GOIs is N=4 in this example. Their sphere size illustrates their individual strength, referred to as an I-value. As such, I₁>I₂, for example. The inter-GOI coherence coupling, such as 8007 for example, is represented by coherency matrix non-diagonal elements Tᵢⱼ; i≠j; together with intensities (Iᵢ) constructing either diagonal kernels Kᵢ or non-diagonal kernels Hᵢ. The matrix elements are generally non-symmetrical, such that T₁₂≠T₂₁, in general. The intra-GOI structure 8002 in this example includes an inter-ego sphere 8008 and intra-ego sphere 8009 including unit-vectors 8010 and 8011, respectively. These unit vectors 8010 and 8011 construct parallel kernel vectors 8012 and 8013, respectively with θ-angle 8014 between them determining moral skew factor defined as cos(θ). For zero-skew (θ=0) the intra-GOI structure is ignored by analogy to “total daltonist” black and white view of any colorful object or complete color blindness.

Further in the example of FIG. 47, both unit vectors, \vec{s₄} and \vec{k₄} (for 4^{th} GOI), are embedded on unit vector base with dimensionality determined by moral senses. This base can be orthogonal or non-orthogonal, by analogy to physical colors and RGB colors, respectively. Also, by analogy to animal vision, the base dimensionality can differ. For example, for human vision, the number of color primaries is (typically) three (3), while for animal vision the number of color primaries can be a number other than three (3). For example, the European starling has four (4) color primaries, the mantis shrimp (12), the honeybee (3), while bichromatic insects have two (2) color primaries.

The moral skew factor, cos(θ), provides a more objective view of the GOI's moral spectrum, which allows for more precise parametric decision synopsis. This is because the parametric decision projection can be different within intra-GOI (intra-ego) as opposed to that within inter-GOI (inter-ego) views, varying from the same views (θ=0) to a completely opposite (orthogonal) view projection (θ=90°). Then, the impact of this decision on the overall network decision (defined by weighted average, <S>) can be different. This is why the inter-ego/intra-ego interactions have a vectorial character defined in the simplest case by scalar product of vectors \vec{S} and \vec{K} (or, rather, \vec{Sᵢ} and \vec{Kᵢ}). The simple explanation of this vectorial (not scalar) character is the fact that “we see ourselves differently from how other people see us.”

Therefore, the decision process may be more objective if it includes both inter-ego (inter-GOI), and intra-ego (intra-GOI) projections to model the process.

6.2 Comparison of Diagonal and Non-Diagonal Kernel Vectors

The parametric decision weighted average formula for a diagonal kernel vector (e.g., defined by Eq. (140)) may be more compact and a more natural generalization of equivalent scalar formula (5). Nevertheless, Eq. (145), representing the parametric decision weighted average formula for a non-diagonal kernel vector, is more basic than the diagonal one, and perhaps better represents the moral skew effect (MSE) as explained below.

It is natural to assume that the unit vector, ŝ, representing the direction of the parametric decision vector \vec{S}, is inclined to intra-ego senses, such as self-interest, power, libido, etc. It is also natural to assume that unit vector, ŝ, represents a member (individual/GoI) strength, while the unit vector, \hat{k}, represents mutual coherency couplings, which may be defined by non-diagonal coherency matrix, Rᵢⱼ, is more inclined to inter-ego (moral) senses (tastes). Therefore, Eq. (141) May in various applications better represent the moral skew factor/effect than Eq. (136), the latter one representing diagonal kernel vector, \vec{Kᵢ}.

6.3 Moral Skew Effect and Psychoanalysis

The Moral Skew Effect (MSE) was approximately derived from basic psychoanalysis concepts, such as those represented by Freud, Adler, Yung, Fromm, and others. In particular, the Freudian conflict between the super-ego and the id is approximately equivalent to the ISS relation between the inter-ego and the intra-ego (or the left and right brain hemispheres). Moreover, it is evident that the moral senses represent the inter-ego point of view, while self-interest senses represent the intra-ego point of view. Furthermore, the basic self-interest senses include the libido (Freud), power (Adler), and group security (Fromm) (which, of course, to some extent overlap each other), as well as some archetypes (Yung). Also, sub-consciousness, related to intra-ego senses (tastes), can be individually related or they can be GoI-like (Fromm). Therefore, the MSE psychoanalytic point of view provides a more effective prognostic of certain particular social events, described by the parametric decision process.

Section 7: Inner Network Analysis (Inner Network)

7.1 Inter-Adverse Vs. Intra-Friendly

While the organized crime and terrorist networks are adverse to outsiders (i.e., inter-network-adverse) they are, of course, friendly amongst themselves (i.e., intra-network-friendly). The latter aspect of the same organization (or, inner network) or the “second side of the same coin” is the subject of this section. This may be viewed, for example, as an extension and generalization of Section 3.11. The Bayesian Truthing Inference (BTI) may also be relevant here, where causation problems arrive in a sense of Bayesian (directed and inverse) probabilities, while binary sensing is generalized here to omninary sensing. The conditional (Bayesian) probabilities characterize an “if, then” relation in which A-cause and B-effect, can be described in the form:

p(B|A) (99)

This is a generalization of the Binary Sensor (BI) relation, such as: (PFP)=p(S′|N), for example. In this section, some specific exemplary BTI techniques are applied, such as, for example, a Lossless Multi-Alarm method.

In order to prognose (prognosis is a less certain form than prediction) certain events such as, for example, an uprising in some country (or, state), strategic influence of emerging states, role of social media, or effects of social messages, the system may be configured to apply human learning/reasoning process. However, in order to prognose such events by machine learning/reasoning processes, either semi-automatically or automatically, it may be beneficial to significantly narrow the context, such as for example, by using the parametric decision learning/reasoning, introduced in Section 3.11. This parametric decision approach is generalized, in this section. Automatic training by minimization of the cost function (which is similar to that in Section 5.1, recognizing that the form of cost function may be different) may also be applied.

7.2 Parametric Statistical Ensemble

In Section 3.11, this document analyzes a single parametric decision space, such as:

Sᵢ:S₁,S₂,S₃, . . . ,S_{N} (100)

where: i-index of certain individual, or group of interest (GoI).

The 2^{nd} l-index is assigned to decision value:

Sₗ:S₁,S₂,S₃, . . . ,S_{L} (101)

Therefore, a given decision location may be related to l-indices, while the decision location may be related to i-indices. In Section 3.11, for example, Eq. (8) is related to i-indices, while Eq. (13) is related to l-indices. Because a mostly Normal Parametric Order (NPO) has been applied, as in FIG. 21, this indexing ambiguity does not create problem. Otherwise, care should be taken with this ambiguity. (However, the general avoidance of this ambiguity may create double indexing). In this section, the indexing is further generalized by introducing multiple parametric decision spaces, using upper indices, such as:

Sᵢ⁽¹⁾:S₁⁽¹⁾,S₂⁽¹⁾, . . . ,S_{N}⁽¹⁾ (102)

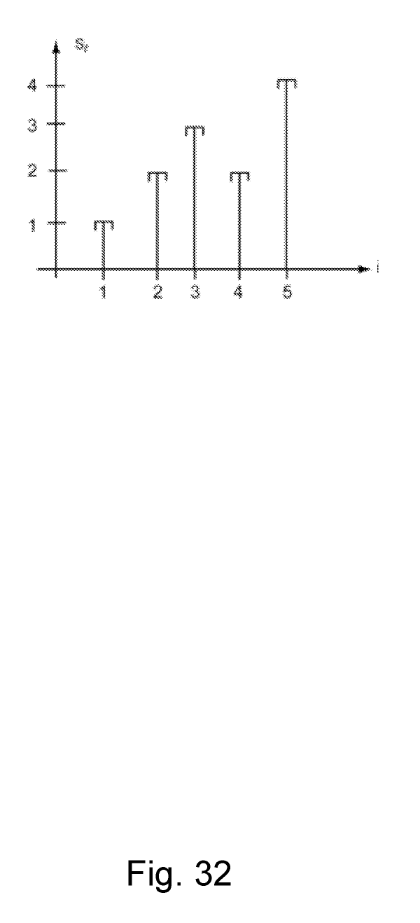

for example. FIG. 32 is a diagram illustrating an example of a relation between i-indexing and l-indexing, in order to keep in mind and control this ambiguity.

In FIG. 32, for the 4^{th}-position (i=4), an S₂-value is provided. In order to avoid ambiguity, a different symbol, for example V, may be used for the decision value. Then, for the 4^{th} position, as above, the following relation would be obtained according to FIG. 32:

S₄=V₂ (103)

For ease of discussion, however, the notation used in FIG. 32 is maintained, keeping in mind that only Eq. (103) precisely describes this double-indexing situation.

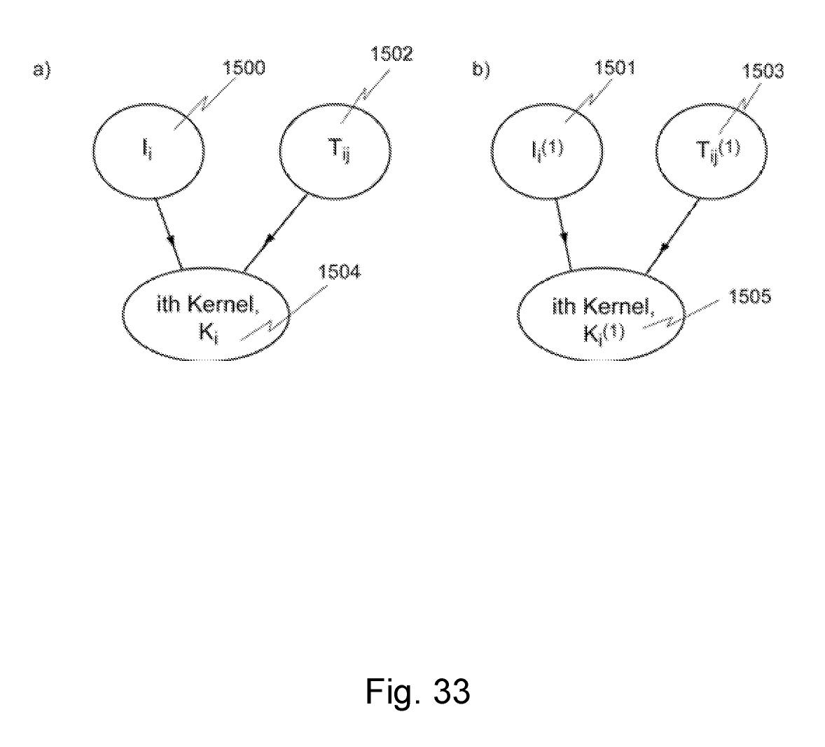

FIG. 33 is a diagram illustrating an example generalization from a single parametric space, such as in Section 3.11, to a multitude of parametric spaces. This can be shown, for example, using the kernel notation as an example. In FIG. 33, the single parametric space notation is shown at a), as in Eq. (100); and the multiple parametric space notation is shown at b), as in Eq. (102). In particular, the intensity 1500 does not have an upper index, while the intensity 1501 does have an upper index “1,” belonging to parametric space 1. Likewise, the same can be said for the “with coherency” matrix elements 1502 and 1503, as well as kernels 1504 and 1505.

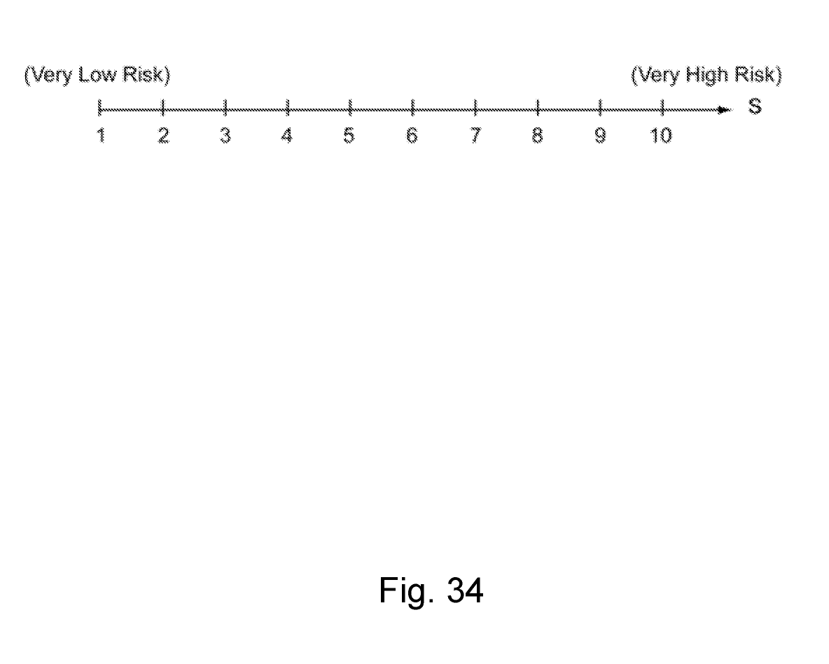

Examples of a multitude of parametric spaces have been introduced because, for a certain set/class of decisions, a given parameter space may be more useful than the other. For example, if a terrorist bombing is planned it could be planned in a “more risky” or “less risky” fashion. Thus, a decision within the IED network may be made based on some kind of voting logic process. This voting will be made among the terrorist network members. For example, there may be eight voting members (N=8), with indices: i=1, 2, 3, . . . , 8. These members will typically have certain strength intensities I₁, I₂, . . . I₈, and mutual couplings Tᵢⱼ, where Tᵢⱼ does not need to be equal to Tⱼᵢ and Tᵢᵢ=1. In this particular case, the decision spectrum, or decision scale may be made from “very low risk” to “very high risk,” as shown in FIG. 34.

As this example serves to illustrate, the decision space scale from “very low risk” to “very high risk,” for example, would be less adequate than the (RISK)-parametric decision scale.

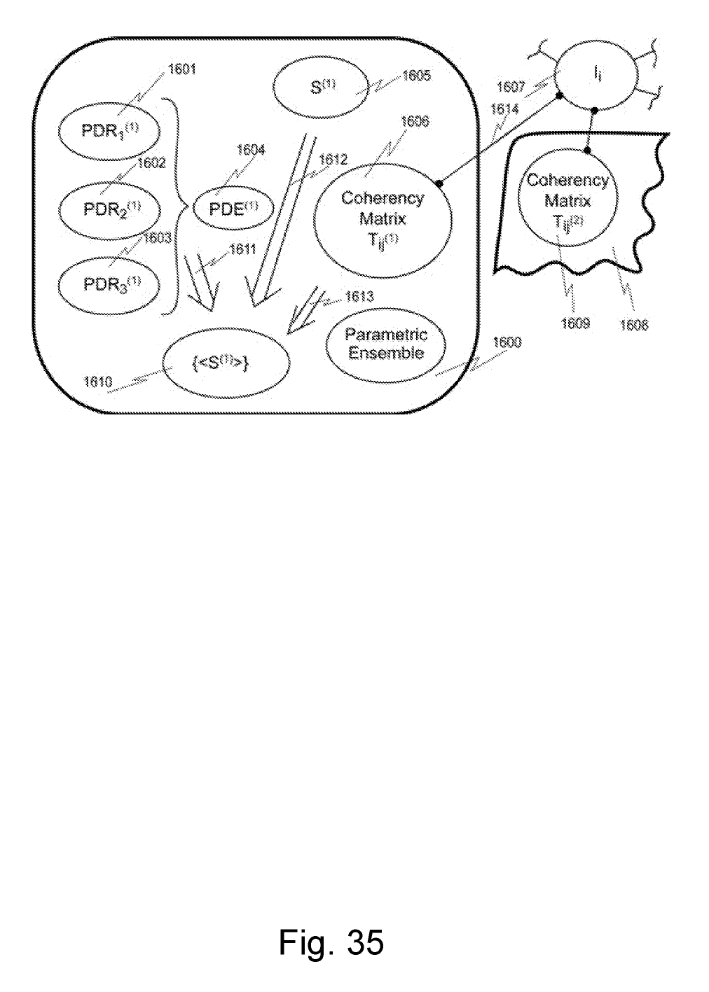

FIG. 35 is a diagram illustrating an example of a parametric statistical ensemble 1600 including various Parametric Decision Realizations

PDR₁⁽¹⁾:PDR₂⁽¹⁾,PDR₃⁽¹⁾, . . . (104)

representing such decision processes. As discussed above (terrorist bombing, for example), these decision processes could be denoted as PDR₂, while an upper index (1) may be used to denote the (RISK) parametric decision, for example, as shown in FIG. 34. Therefore, these PDRs 1601, 1602, 1603 may constitute a Parametric Decision Ensemble PDE(1) denoted as 1604, while the parametric decision scale S(1) may be denoted by 1605, as well as coherency matrix elements 1606. While these two classes of parameters 1605 and 1606 may have specific values assigned to ensemble 1600, the intensities Iᵢ denoted as 1607 may be rather invariant. Accordingly, they do not have an upper index (1). Therefore, the intensities 1607 can constitute other Parametric Decision Ensembles (PDEs), such as, for example, PDE⁽²⁾ 1608 with its coherency matrix elements 1609.

The statistical weighted mean value, <S⁽¹⁾>, may be ensemble-averaged, in the form:

{<S⁽¹⁾>} (105)

where { . . . } is the symbol of ensemble average. This ensemble-averaged weighted mean, 1610, is result of four (4) connections (first three illustrated by arrows) 1611, 1612, 1613, and 1614, resulting in a mean average for each PDR, as defined by Eq. (8). The ensemble-average (possibly weighted) may result in Eq. (105).

7.3 Parametric Prognosis

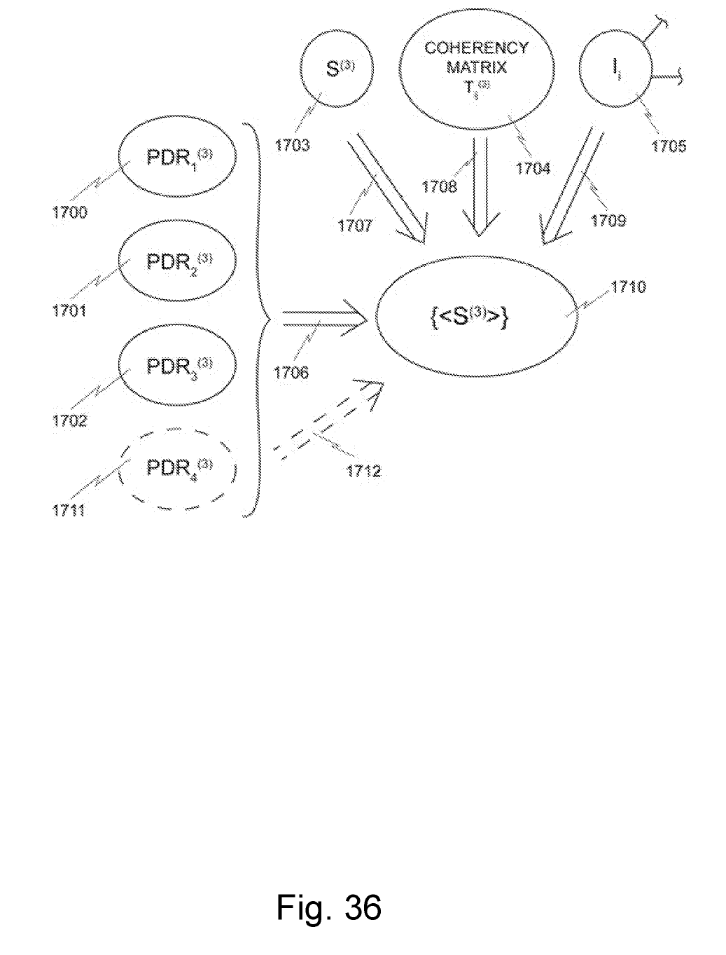

FIG. 36 is a diagram illustrating an example of a simple parametric prognosis in accordance with one embodiment of the technology described herein. Particularly, the example illustrated in FIG. 36 may be obtained by applying a Parametric Decision Ensemble, such as that illustrated in FIG. 35.

In the example of FIG. 36, the already constituted ensemble 3, with three realizations, 1700, 1701, and 1702, is shown. This ensemble has parametric scale, 1703, a coherency matrix structure, 1704, and an intensity structure, 1705. All these ensemble elements may be used to produce four (4) connections (causations), 1706, 1707, 1708, 1709, which, in turn, can produce the ensemble average, 1710. Then, if the new realization, 1711, also belongs to this ensemble, it can be inferred that the new connection, 1712, produces the same (or similar) result, 1710. This simple parametric prognosis can work approximately, assuming that one of the constituted realizations, 1700, 1701, 1702, has been experimentally verified recently, for checking purposes.

A more complex, but also a more precise parametric prognosis can be obtained using the cost function minimization process. This process can be similar to that shown in FIG. 30, except that the cost function definition is now different. For example, it may be defined as a module of difference between weighted mean experimental and theoretical values. In various embodiments, the Parametric Cost Function (PCF) is given by

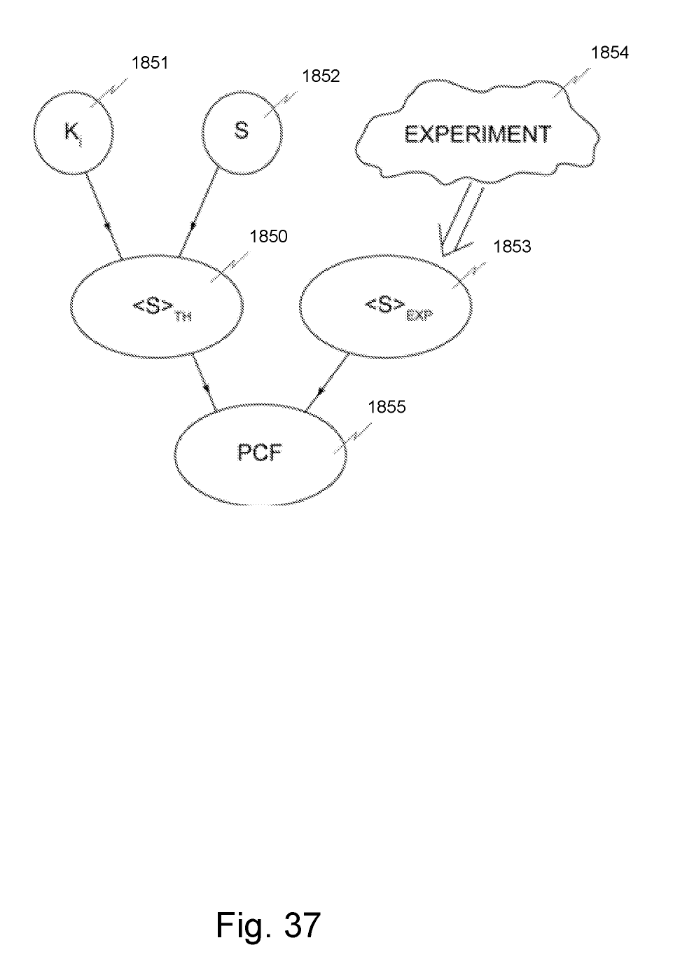

(PCF)=|<S>_{TH}−<S>_{EXP}| (106)

where | . . . | is module symbol, and the procedure is illustrated in FIG. 37, where ensemble indices have been omitted, for clarity.

In FIG. 37, the theoretical parametric mean value, 1850, may be constructed from kernel, 1851, and a parametric scale, 1852. This can be done, for example, based on Eqs. (8), (9), and (13), by using either intelligence knowledge or an expert query. Then, an experimental value, 1853, may be obtained by experiment, 1854, for example, using the method as in FIG. 35. Then, Eq. (106) is applied, in order to obtain the PCF, 1855. Then, the PCF minimization procedure may be applied in a manner similar to that illustrated in FIG. 30.

7.3.1 Parametric Intensity Prognosis

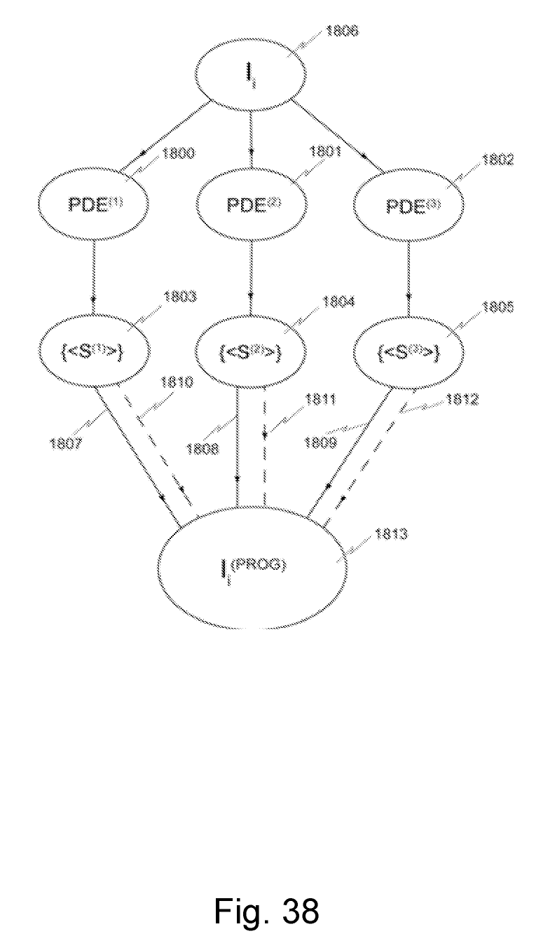

FIG. 38 is a diagram illustrating an example of a more global procedure of prognosis parametric intensity set in accordance with one embodiment of the technology described herein. The example shown in FIG. 38 may be accomplished by applying a premise that the strength intensity set, is (entirely or almost) invariant to parametric scale. This set is defined in this example by three (3) exemplary parametric ensembles, 1800, 1801, and 1802. These ensembles may be used to generate three ensemble averages, 1803, 1804, and 1805, respectively. It can be assumed as an approximation that all three results have been generated on the same parametric intensity set, 1806. Therefore, using an inverse procedure, characterized by connections, 1807, 1808, 1809, 1810, 1811, and 1812, the prognosed value, 1813, can be obtained through computation. The prognosed value may be obtained fairly close to the real value, 1806. In this example, the continuous lines 1807, 1808, 1809, denote a procedure based on the PCF-minimization, while the broken lines 1810, 1811, 1812, denote a procedure obtained without PCF-minimization.

7.4 Coherent Coupling Engineering

The parametric ensemble engineering (PEE) concept, in general, and Coherent Coupling Engineering (CC-Engineering) concept, in particular, may be applied in order to probe and construct various parametric ensemble models, either theoretically (by design), or practically (by experiment), or both. The term CC-engineering arises from the fact that coherent coupling matrix elements, Tᵢⱼ, are easiest to manipulate, because they are most flexible, or most space/time-variant, while parametric intensities, Iᵢ, are rather rigid, and may in some circumstances be rather difficult to manipulate. In general, the typical parametric ensemble may contain four-types of data:

STRUCTURAL:(Kᵢ;Iᵢ,Tᵢⱼ) (107a)

INPUT:Context,Ensemble Realizations (107b)

PARAMETRIC:S (107c)

OUTPUT:<S>,{<S>} (107d)

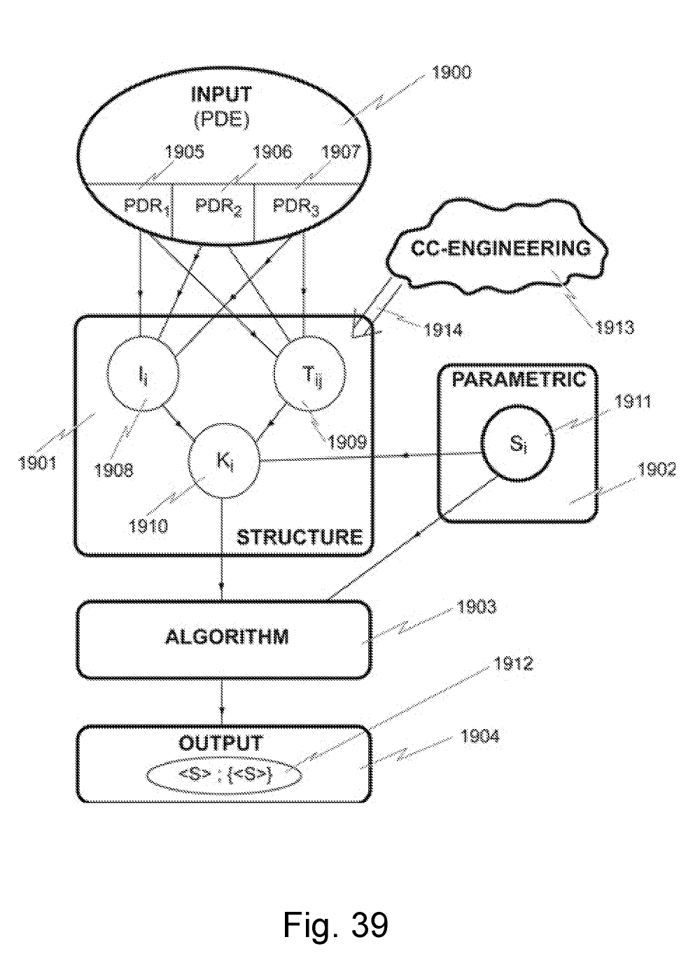

FIG. 39 is a diagram illustrating an example of these for data types in accordance with one embodiment of the technology described herein. Referring now to FIG. 39, example of a Parametric Decision Ensemble (PDE) architecture, and CC-Engineering is shown. This example includes an Input data interface, 1900; sub-system structure, 1901; a parametric interface, 1902; an algorithm, 1903, and an output data interface, 1904. The input interface, 1900, may be configured to insert input data, in the form of Parametric Decision Realizations (PDRs), such as: PDR₁, 1905, PDR₂, 1906, and PDR₃, 1907. This input data description may be inserted into a sub-system structure, 1901; thus, defining the parametric intensity set, Iᵢ, 1908, and coherent coupling matrix elements, Tᵢⱼ, 1909, summarized into kernel, 1910, for the ith-member. This process may be repeated for each ith-member, up to a quantity of N members. The parametric S-set, 1911, may be introduced in parallel to both the structure, 1901, and sub-system algorithm, 1903. After algorithmic computing, the output data, 1912, may be produced.

CC-Engineering Procedure.

The CC-Engineering interface 1913 in this example introduces variations of Tᵢⱼ-matrix components, 1909, according to a pre-described procedure. In this way, both engineering and probing scenarios may be realized. The connection 1914 is directed mostly to CC-matrix elements, Tᵢⱼ, because they may be very flexible and time/space-variant, depending on type of stimulation (this is a characteristic feature of members' mutual relations, defined by Coherency Matrix, Tᵢⱼ). In a similar way, the system may be configured to provide probing by synchronizing various PDRs, with related variations of Tᵢⱼ-matrix elements, as discussed below.

Coherency Matrix Variations.

In order to better understand how the weighted mean, <S>, a change under stimulation (probing), the weight, wᵢ, changes may be analyzed as defined previously in the form:

$${w}_{i} = \frac{{K}_{i}}{{\sum }_{i = 1}^{N} {K}_{i}} ; i = 1 , 2 , 3 , … , N \qquad ( 108 )$$

Then, by differentiating (in approximation of small changes) this formula, the following expression for wᵢ-change, Δwᵢ, may be derived:

$$\begin{matrix}Δ {w}_{i} = \frac{Δ {K}_{i}}{{\sum }_{i = 1}^{N} {K}_{i}} + {K}_{i} [ - {( \frac{1}{{\sum }_{i = 1}^{N} {K}_{i}} )}^{2} {\sum }_{i = 1}^{N} Δ {K}_{i} ] = \\ = \frac{Δ {K}_{i}}{{\sum }_{i = 1}^{N} } - {w}_{i} ( \frac{{\sum }_{i = 1}^{N} Δ {K}_{i}}{{\sum }_{i = 1}^{N} {K}_{i}} )\end{matrix} \qquad ( 109 )$$

Therefore, the relative change (in %), is

$$\frac{Δ {w}_{i}}{{w}_{i}} = \frac{Δ {K}_{i}}{{w}_{i} {\sum }_{i = 1}^{N} {K}_{i}} - \frac{{\sum }_{i = 1}^{N} Δ {K}_{i}}{{\sum }_{i = 1}^{N} {K}_{i}} \qquad ( 110 )$$

and, finally, the following expression for weight relative change may be obtained:

$$\frac{Δ {w}_{i}}{{w}_{i}} = \frac{Δ {K}_{i}}{{K}_{i}} - \frac{{\sum }_{i = 1}^{N} Δ {K}_{i}}{{\sum }_{i = 1}^{N} {K}_{i}} \qquad ( 111 )$$

Thus, the relative weight change for the ith-member is a difference of two terms: the 1^{st} local term depends on relative change of the ith-kernel only, while the 2^{nd} global term, depends on all ensemble values. As this example illustrates, those terms are small quantities of the same order, and they have opposite signs. Thus, sometimes, they may cancel or almost cancel each other.

7.5 Application Scenarios for PDE Systems

Three (3) application scenarios are presented for illustration of the PDE systems, including such diverse areas as: social geopolitics, social media, and Organized Crime Networks, for example. All of them may be applied for the same PDE modeling, following FIGS. 35 and 39.

SCENARIO #1 (Social Geopolitics). Emerging States.

Question: What is the current strength of a number of emerging states (countries)?

In order to answer this question, the system may be configured to apply a Parametric Intensity Prognosis scheme, such as that shown in FIG. 38, with multi-parametric space. In such a case, a number of equations defining the weighted means <S> may be used. It can be assumed that each equation represents a single Parametric Decision Ensemble (PDE). It can be further assumed that a number of states (not only emerging ones) to be considered is equal to 100; i.e., N=100

Then, a number of the PDEs, should be also equal to at least 100. If the number of the PDEs is not sufficient, the system may be configured to apply Parametric Decision Realizations (PDRs), and ensemble averages may be replaced by weighted means (by “realization”, we mean a given ensemble realization), in the form (M is a number of PDRs):

<S⁽¹⁾>=f₁(Iᵢ⁽¹⁾,Tᵢⱼ⁽¹⁾,S⁽¹⁾) (112a)

<S⁽²⁾>=f₂(Iᵢ⁽²⁾,Tᵢⱼ⁽²⁾,S⁽²⁾) (112b)

<S⁽³⁾>=f₃(Iᵢ⁽³⁾,Tᵢⱼ⁽³⁾,S⁽³⁾) (112c)

. .

. .

<S^{(M)}>=f_{M}(Iᵢ^{(M)},Tᵢⱼ^{(M)},S^{(M)}) (112d)

where, in the simplest case, all functions f_{( . . . )}, are identical:

f₁=f₂=f₃= . . . =f_{M} (113)

and, represented by Eqs. (8), (9), and (10), in the form:

$$\begin{matrix}< {S}^{( m )} >= {\sum }_{i = 1}^{N} {w}_{i}^{( m )} {S}_{i}^{( m )} ; {w}_{i}^{( m )} = \frac{{K}_{i}^{( m )}}{{\sum }_{i = 1}^{N} {k}_{i}^{( m )}} & ( 114 a ) \\ and , & \\ {K}_{i}^{( m )} = {\sum }_{j = 1}^{N} {T}_{ij}^{( m )} \sqrt{{I}_{i}^{( m )} {I}_{j}^{( m )}} & ( 114 b )\end{matrix}$$

i.e., the f-function, is

$$f ( {I}_{i}^{( m )} , {T}_{ij}^{( m )} , {S}^{( m )} ) = {\sum }_{i = 1}^{N} {w}_{i}^{( m )} {S}_{i}^{( m )} \qquad ( 115 )$$

It can be assumed that all coherency matrix elements are known, and that these may be found from experiment (e.g., by observing a large number of geopolitical situations). It may also be assumed that all S-parameters have been given (assigned, for each particular geopolitical situation). Also, a further assumption may be that all weighted averages have been found (i.e., by studying all available geopolitical documents, journals, etc.). Therefore, the number of unknowns is N:

I₁,I₂,I₃, . . . I_{N} (116)

This is because it can be assumed as before that the parametric intensities are rather space/time invariant (at least within a given time internal); i.e., their upper indices have been cancelled, as in Eq. (116). Now, assuming that:

M≧N (117)

then, the problem is numerically solvable. Therefore, as a result, the strengths of all states (not only emerging states) may be determined as defined by their parametric intensities, as in Eq. (113). For example, if it is determined that:

I₅₀>I₇₂ (118)

then, the 50^{th}-country is stronger than the 72^{nd} country (state), at least, within the system of ensembles and situations, considered within this application scenario.

SCENARIO #2 (Social Media). Impact of Messages

Question: What is impact of specific social messages transmitted through the Internet?

In order to answer this question, which is simpler than that in SCENARIO #1, the system may be configured to apply the Simple Parametric Prognosis scheme, such as that shown in FIG. 36, for example. It can be assumed that, from experience, that parametric intensities, and coherent couplings, Tᵢⱼ, are known. These can be those of all centers of influence for a given PDE, which represents the specific message in question. Based on previous experience, the ensemble average of the parameter of interest (POI) may be numerically calculated. This POI could represent, for example, risk, cost, speed, radicalization level, etc. Then, in this simplest case, the ensemble average obtained from previous experience may be used. For example, if the PDE of Interest (PDEol) is denoted by upper index (3), as in FIG. 36, then our answer, is

{<S⁽³⁾>} (119)

The higher this value is, the higher the impact according to a given parametric scale.

In the more complex cases, a structure for Parametric Cost Function (PCF) may be applied as in FIG. 37, for example.

SCENARIO #3. (Organized Crime Network).

Election of the Leader.

Question: Who, among the Organized Crime Network members, will be elected as a new leader?

This problem is similar to that of SCENARIO #1, and that it may be a multi-step analysis. In the 1^{st} step, the system applies the same approach as in SCENARIO #1. As an output, the system obtains a narrow set of leader candidates. Then, in the 2^{nd} step, the system applies the methodology of the Lossless Multi-Alarm (LMA) method, as shown in FIG. 29. This means, that, in the 1^{st} step, the system should preferably have very low target losses, or the Probability of False no-Alarm (PFnA) is very low; while the Probability of False Alarm (PFA), or Probability of False Positives (PFP), are high. In the 2^{nd} step, the system defines new kernel components, Kᵢ, using available police search data. These Kᵢ-components, especially including coherency matrix elements, Tᵢⱼ, are more precisely defined than in the 1^{st} step because they are limited to a narrower context; i.e., a much lower number of the leader candidates are considered in the 2^{nd} step. As a final result, the system obtains one final candidate for the leader position.

7.6 Phenomenology of PDE System

7.6.1 Origin of the Systems and Methods Described Herein

For purposes of explanation, consider in more detail the phenomenology of the Parametric Decision Ensemble (PDE) system and method. Because the PDE concept is a rather complex one, the phenomenology of this system may be explained using two analogies: physical and social. The origins of the PDE concept can be traced to physical optics (optical interference), moral psychology, animal vision, and Bayesian Truthing Inference (BTI)—the latter one in a more actional sense, by applying Lossless Multi-Alarm Method, illustrated in FIG. 29, for example. The physical optics origin is demonstrated by applying the truncated interference term, in kernel definition, as in Eq. (10). (“Truncated” means that trigonometric oscillatory term has been omitted.) The moral psychology origin requires further explanation.

Moral Psychology Origin.

Moral psychology applies moral analogs of human tastes such as: sweet, sour, dry, and salty. These “moral tastes” are, for example: care, liberty, fairness, loyalty, authority, and sanctity. Their composition defines human morality, which can be categorized, for example, within three (3) basic political categories: liberal, libertarian, and conservative. (While, in the single individual case, the moral psychology subject may be considered; in the social group case, the moral sociology subject is considered.)

In order to better understand the PDE system, it is useful to consider two analogies:

A. Physical (Thermodynamic Gas of Particles)

B. Social (Moral Sociology)

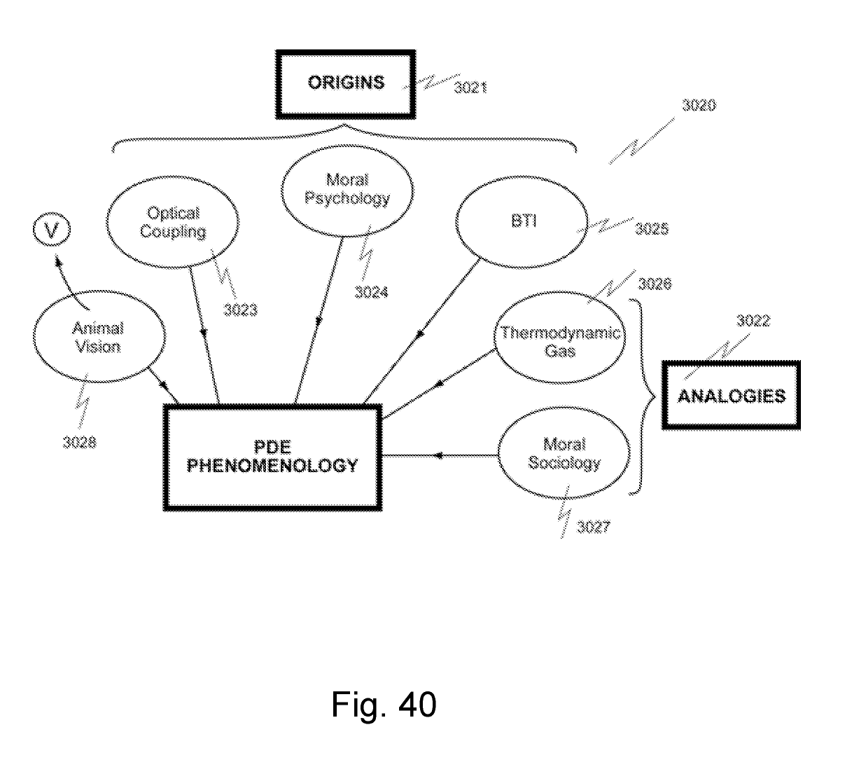

FIG. 40 is a diagram illustrating an example of the phenomenology of the PDE system. Referring now to FIG. 40, in this example the PDE Phenomenology 3020 is illustrated as including the PDE concept origins 3021 and analogies 3022. The PDE concept origins 3021 may include optical coupling, 3023, applicable for kernel, Kᵢ, definition; moral psychology 3024 helpful in defining parametric space; Bayesian Truthing Interference (BTI) 3025 producing some actionable techniques for the PDE system; and animal vision 3028. The PDE concept analogies 3022 may include thermodynamic gas analogy 3026 and moral sociology analogy 3027; i.e., moral psychology concept applicable to social group.

Animal Vision Origin.

Animal vision origin may also contribute to the PDE concept by producing a vectorial base. The vectorial base may be both orthogonal and non-orthogonal, for a Parametric Decision Vector, \vec{S}. The analog of an orthogonal base may be obtained from physical colors, defined by wavelengths; while the non-orthogonal base may be obtained from RGB (Red-Green-Blue) colors such as those of an animal vision model 3028.

7.6.2 Thermodynamic Gas Analogy

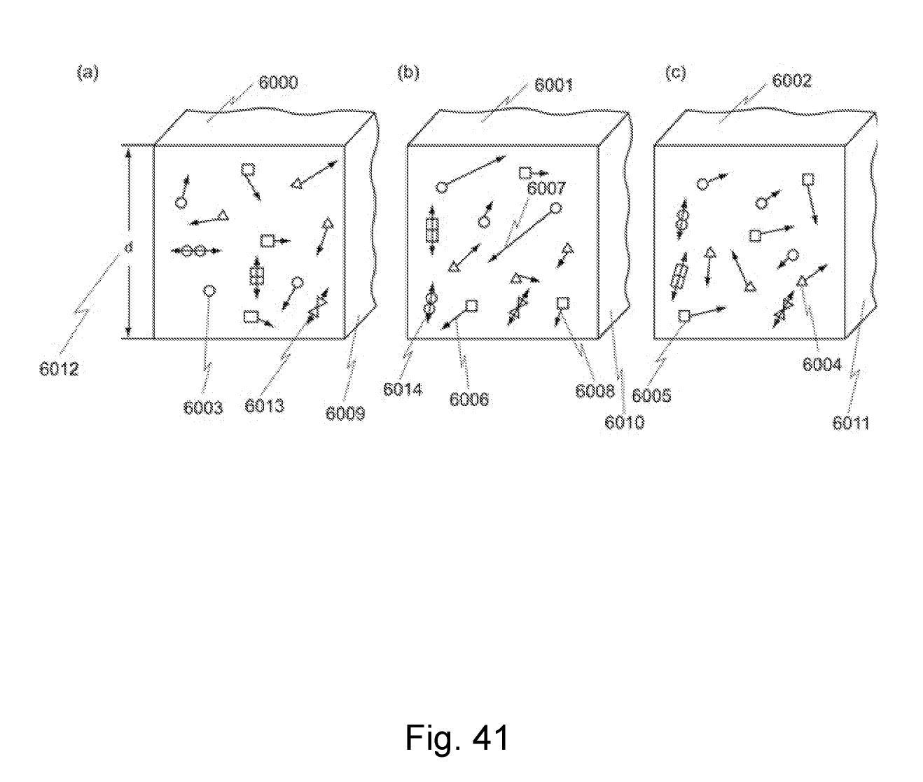

In FIG. 41, examples of three (3) gas mixtures, 6000, 6001, and 6002, illustrated in FIGS. 41(a), 41(b), 41(c), are shown. These examples represent three types of molecules, and are denoted by denoted by circle 6003; triangle 6004 and square 6005, respectively. In this example, each molecule moves with velocity vector, \vec{v} denoted by an arrow, such as 6006, for example. The arrow's direction represents a velocity direction, while speed value, v, or |\vec{v}|, is represented by the arrow length. For example, velocity 6007 is larger than velocity 6008.

In this example, these three (3) gases have the same number of three (3) types of molecules, and are located in the same size cubes 6009, 6010, and 6011, with the same volume equal to d³, where d-linear cube size, 6012. The molecules refract from cube walls, and collide with other molecules. The collisions are denoted by molecule pairs, such as 6013, for example, and double arrows, such as 6014, represented by Coherency Matrix elements, Tᵢⱼ, for example.

For analogy purposes, v²-speed square may be used as an analog of the S parameter

v² [symbol] S (120)

because the v²-parameter is valid for all three cubes, the analogy should be restricted to the single parametric space, and single ensemble, only. The 2^{nd} analog must be between molecule mass, mᵢ, and kernel Kᵢ:

mᵢ [symbol] Kᵢ (121)

Thus, this example illustrates that there are only three (3) types of kernels due to graphical symbol limitation. However, the i-index is applied to all molecules in the cube; thus, N is the number of all molecules in the cube (here, N=15). By way of analogy, it can be seen that each cube represents a Parametric Decision Realization (PDR), while all three of them represent a single ensemble (PDE).

Because this is discussed in terms of a thermodynamic gas model, (for purposes of analogy), some thermodynamic function (or, function of state) may be considered as an analog of either weighted mean: <S>, or ensemble average: {<S>}. For example, assume the simplest case when all molecules are identical and there is no interaction between them:

Iᵢ=constant; Tᵢⱼ=0 (122ab)

Then, the average kinetic energy, is

$$〈 {E}_{k} 〉 = \frac{1}{N} {\sum }_{i = 1}^{N} \frac{{mv}_{i}^{2}}{2} = \frac{3}{2} kT \qquad ( 123 )$$

where N is the number of particles, T is the absolute temperature (in Kelvin degrees), and k is Boltzmann's constant. Therefore, an analogy may be drawn between <S> and the absolute temperature thermodynamic function.

However, in the case in which condition (122a) is not satisfied, this simple analogy becomes more complicated because the PDE mean has the form:

$$〈 S 〉 = \frac{{\sum }_{i = 1}^{N} {I}_{i} {S}_{i}}{{\sum }_{i = 1}^{N} {I}_{i}} \qquad ( 124 )$$

By way of simplification, instead of Eq. (124), the following simple formula may be considered:

$$〈 S 〉 = \frac{\sum {I}_{i} {S}_{i}}{{\sum }_{i} {I}_{i}} \qquad ( 125 )$$

which is defined as exactly equivalent to Eq. (124). Therefore, the summary term in the denominator precludes application of the thermodynamic gas analog. In order to save this analogy, the charged gas particles may be considered. Thus, the interactive kernel term may be an analog to potential energy term, Uᵢⱼ, in the form:

$$A \frac{{q}_{i} {q}_{i}}{{r}_{ij}} ⇔ {T}_{ij} \sqrt{{I}_{i} {I}_{j}} \qquad ( 126 )$$

where, qᵢ—particle charge, rᵢⱼ—mutual distance, and A-proportionality constant. However, the summary term in denominator, is

$${\sum }_{i} {K}_{i} \qquad ( 127 )$$

which precludes this analogy. Indeed, this summary term Eq. (127) is a global term that more fits to wave optics rather than to mechanical model such as thermodynamic gas, for example. This is not surprising, because at the beginning the optical coupling model was applied.

7.6.3 Moral Sociology Analogy

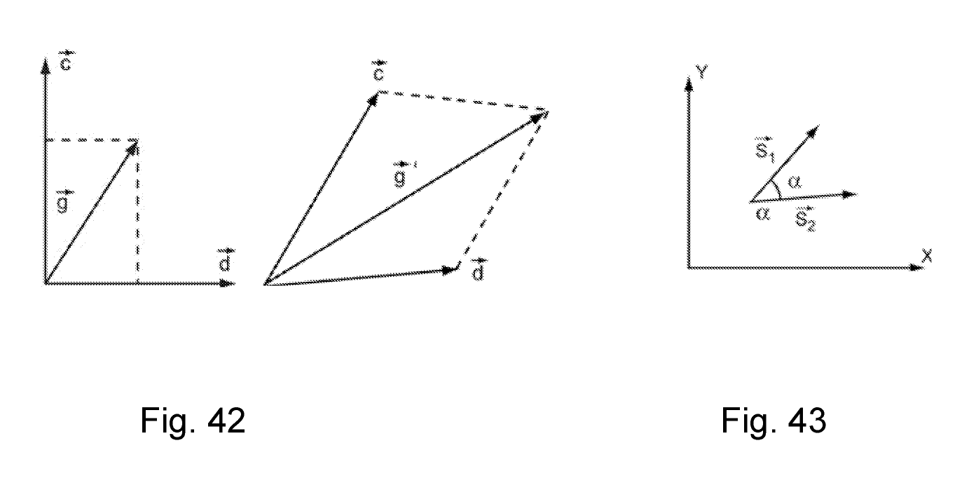

The moral sociology scenario be considered as a generalization of moral psychology for social groups (groups of interest), rather than for individuals. After studying this analogy further, however, it may be concluded that this analogy fits well to narrow contexts such as scenarios #1 and #3 (i.e., when the goal is to select some strong candidates). Moreover, this analogy provides an important clue, which comes from an animal vision analogy 3028 such as that, for example, shown in FIG. 40. In order to obtain a broader context analogy, it is important to the treat decision parameter, S, as a vector, \vec{S}, and/or tensor Sₖₗ, embedded onto the orthogonal, or non-orthogonal base of several moral tastes, with the addition of some primitive tastes, such as power, security and/or libido, for example. The analogy between a non-orthogonal parametric base, and RGB animal (including, human) vision where any color is defined in non-orthogonal base (this is, because, the RGB-spectra overlap each other), as shown in FIG. 42, for 2D-space, for simplicity.

For the PDE, the Parametric Decision Vector (PDV) base may be six-dimensional, seven or eight-dimensional, or higher. Some parametric decisions made be stronger if the base unit vectors tend to the same direction. Also, the scalar product of such vectors, may have a lower value even if these vectors are large but close to normal to each other, as shown in FIG. 43.

This is because the scalar product of two vectors: \vec{S}₁, and \vec{S}₂, is

\vec{S}₁·\vec{S}₂=|\vec{S}₁∥\vec{S}₂| cos α (128)

where α-angle between these two vectors, as shown in FIG. 43.

7.7 Moral Skew Factor

7.7.1 Inter-Ego Vs. Intra-Ego

In the previous sections, inter-group coherent coupling was introduced in an environment based on an interaction between group/network members. In this section, a more internal type of coherency related to moral psychology/sociology (or, psychoanalysis) (i.e., intra-individual relations) is introduced. This new type of coherency may be used to define a moral skew factor. In the case of a single individual, for example, this skew factor may be a consequence of a Freudian conflict between left and right brain hemispheres, defined by Freud as a conflict between the id and the super ego. In a broader cycle analytical sense, this conflict is referred to as the conflict between inter-ego and intra-ego.

In various embodiments, this conflict may be manifested as a skew effect between parametric decision, Sᵢ, and kernel, Kᵢ. This moral skew factor may be mathematically modeled as a scalar product of two vectors \vec{Sᵢ} and \vec{Kᵢ}: wherein a higher skew higher skew results in a higher angle, θ, between these vectors. In the extreme case, the scalar product, \vec{Sᵢ}·\vec{Kᵢ}, can be equal to zero, even if the vectors' values (lengths), |\vec{Sᵢ}| and |\vec{Kᵢ}|, are large. This is when, θ=90°.

7.7.2 Unit Vector Bases

Both vectors \vec{Sᵢ} and \vec{Kᵢ} may be defined in the same unit vector base which can be either orthogonal, or non-orthogonal, constructed of unit vectors; in 3D-space, for example:

êₓ, ê_{y}ê_{z};|êₓ|=|e_{y}|=|ê_{z}|=1 (129ab)

The unit-vector-space may be multi-dimensional, with the number of dimensions being equal to two, three, or higher. For example, for five (5)-dimensions, the unit-vector-space is 5D-space, or 5-space.

7.7.3 Primary Color Analogies

Primary color analogies are very useful to illustrate differences between orthogonal and non-orthogonal unit-vector-bases. For example, physical quasi-monochromatic colors, defined by central wavelengths, are orthogonal. However, the animal vision is based on RGB (red-green-blue) color primaries, or RGB primary colors, with overlapping wavelength spectra. This phenomenon, in vector functional analysis, is equivalent to the fact that functional vectors representing overlapping spectra are not orthogonal to each other; thus, creating a non-orthogonal unit vector base (vector functional analysis is applied in quantum mechanics, for example).

7.7.4 Scalar Product of Parametric Decision and Kernel Unit Vectors

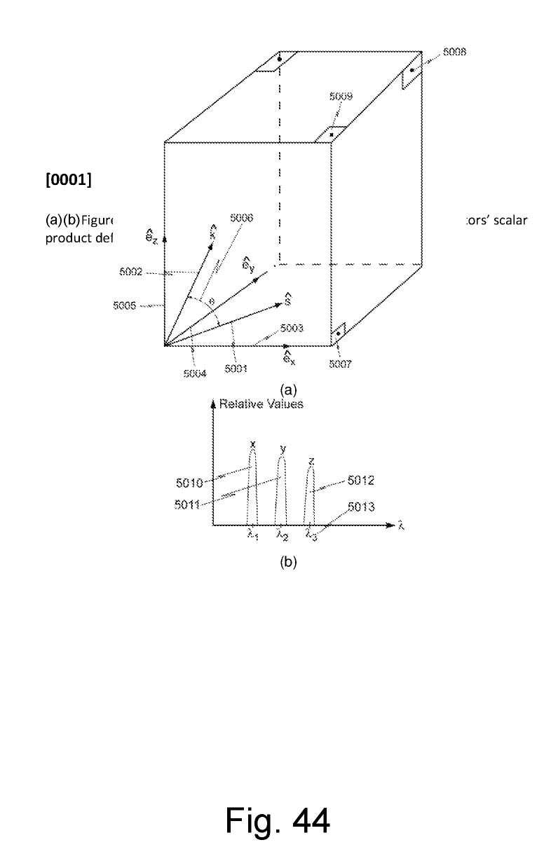

FIG. 44 is a diagram illustrating an example of a scalar product of a parametric decision and kernel unit vectors in an orthogonal base. In FIG. 44, the scalar product a) of two unit vectors ŝ 5001 and \hat{k} 5002 is presented in an orthogonal base having three unit vectors êₓ 5003; ê_{y} 5004; and ê_{z} 5005, thus creating a 3D-space. These vectors 5001 and 5002 are skewed by angle θ 5006. This base is orthogonal because all three angles between the unit vectors 5003, 5004 and 5005 are right-angles (orthogonal) such as 5007, 5008 and 5009 for example.

The primary color analogy is illustrated at b) and includes three orthogonal (non-overlapping) wavelength spectra 5010, 5011, and 5012. The horizontal axis, λ, represents central wavelength values such as λ₁, λ₂, and λ₃, for example. The exemplary λ₃-central wavelength 5013 can represent the 630 nm wavelength (red color), for example.

In such an orthogonal base, the unit vector, ŝ, is represented by:

ŝ=aₓêₓ+a_{y}ê_{y}+a_{z}ê_{z} (130)

where:

aₓ²+a_{y}²+a_{z}²=1 (131)

and:

|êₓ|=|ê_{y}|=|ê_{z}|=1; êₓ·ê_{y}=0;

êₓ·ê_{z}=0; ê_{y}·ê_{z}=0 (132a; 132b; 132c; 132d)

Eq. (131) describes the unit vector property; Eq. (132a), describes unit base vectors; and Eqs. (132b,c,d) describe orthogonality of unit base vectors. Similarly, the unit vector \hat{k} is represented by:

\hat{k}=bₓêₓ+b_{y}ê_{y}+b_{z}ê_{z} (133)

where:

bₓ²+b_{y}²+b_{z}²=1 (134)

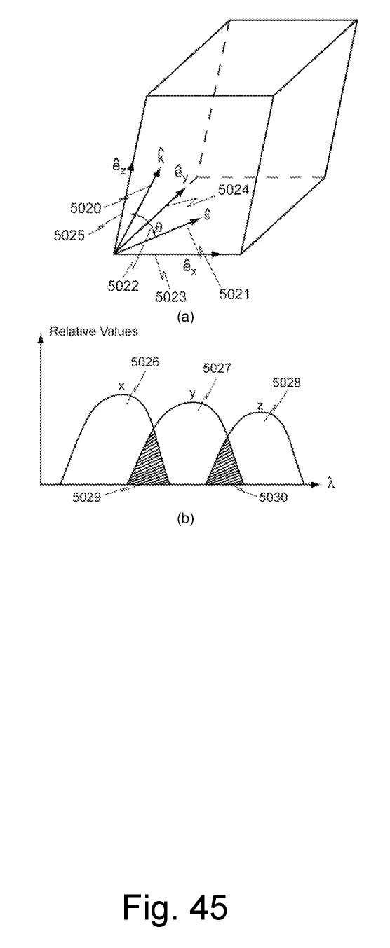

In FIG. 45, the scalar product of ŝ and \hat{k}-vector is presented in a non-orthogonal base.

FIG. 45 illustrates the scalar product a) of two unit vectors, \hat{k}, and ŝ, 5020, and 5021, skewed by angle θ 5022. In this example, this is embedded on non-orthogonal unit vector base, when the base unit vectors 5023, 5024, and 5025 are not orthogonal (not perpendicular).

The primary color analogy b) is also illustrated, where color primaries 5026, 5027, and 5028 are overlapping, with overlapping hatched areas 5029, and 5030. Equations describing the unit vectors s and k are similar to Eqs. (130-132), except, Eqs. (132bcd) are not satisfied.

For clarity of description, the further mathematics, based on vector algebra, are provided for the orthogonal base.

The scalar product of two unit vectors, ŝ and \hat{k}, is

ŝ·\hat{k}≐aₓbₓ+a_{y}b_{y}+a_{z}b_{z}=|ŝ∥\hat{k}|cos θ=cos θ (135)

This is, because, according to Eqs. (127) and (130)

|ŝ|=|\hat{k}|=1 (136)

i.e., ŝ and \hat{k}-vectors are, indeed, unit vectors.

7.7.5 Scalar Product of Parametric Decision and Kernel Vectors

The scalar product of a Parametric Decision vector and a kernel vector is not automatically a generalization of the previous section describing scalar product of equivalent unit vectors. In fact, it requires further analysis, presented below.

7.7.6 Diagonal and Non-Diagonal Kernel Vectors

Diagonal Kernel Vector.

The diagonal kernel vector is defined as such vector that the coherency matrix has usual diagonal form, defined previously:

\vec{Kᵢ}= [symbol] ·Kᵢ (137)

where Kᵢ is kernel scalar, defined by Eq. (11) and [symbol] is unit vector defined by Eq. (133). In parallel, the parametric decision vector, \vec{Sᵢ}, is defined as:

\vec{Sᵢ}= [symbol] ·Sᵢ (138)

where Sᵢ is parametric decision scalar, as in Eq. (5), and [symbol] is unit vector defined by Eq. (130).

Therefore, the scalar product of kernel vector, \vec{Kᵢ}, and parametric decision vector \vec{Sᵢ}, is

\vec{Sᵢ}·\vec{Kᵢ}=SᵢKᵢ cos θᵢ (139)

where θᵢ is moral skew factor for ith network member, and the weighted average, is

$$〈 S 〉 = \frac{{\sum }_{i = 1}^{N} {S}_{i} {K}_{i} cos {θ}_{i}}{{\sum }_{i = 1}^{N} {K}_{i} cos {θ}_{i}} = \frac{{\sum }_{i = 1}^{N} {{S}^{->}}_{i} \cdot {{K}^{->}}_{i}}{{\sum }_{i = 1}^{N} {K}_{i} cos {θ}_{i}} \qquad ( 140 )$$

Ignoring the moral skew factor, θᵢ, is, according to the color analogy, equivalent to a “blind vision” ignorance of colors, by seeing only in black-white.

Moral Skew Factor Interpretation.

The moral skew factor interpretation is based on a conflict between inter-ego and intra-ego. According to the ISS model, both inter-ego and intra-ego may be embedded in the unit vector base, [symbol] , [symbol] , [symbol] , . . . , defined by moral senses. The moral senses' base may be a multi-dimensional base with a number and type of dimensions depending. This number and type may depend on individual parametric decision space, etc. (“individuals” may include not only individuals in narrow sense (such as humans), but also in a broader sense, as individuals' group of interest). For example, in recent conventional systems “the righteous man” concept, there are six (6) moral senses such as: cure/harm; liberty/oppression; fairness/cheating; loyalty/betrayal; authority/subversion; and sanctity/degradation. In the ISS language, the moral sense unit vector base, such as the example shown in FIGS. 44 and 45, would be in the 6D-space. However, the moral skew factor concept introduced here is more general and differs in such a sense. Particularly, it adds at least one more dimension, namely, self-interest/altruism. Accordingly, this space would be 7D. The 1^{st} six (6) moral senses may be referred to as inter-ego senses, while the 7^{th}, 8^{th}, etc. self-interest may be referred to as intra-ego senses. In the ISS model, the number of inter-ego senses can be different from six (6), and they can be of different types. In addition, the number of inter-ego senses can be greater than one, and different, in general. Moreover, some embodiments can be distinguished as using a combination with a parametric decision model in such a sense that the parametric decision unit vector, ŝ, is dominated by intra-ego senses (i.e., its intra-ego components: aₓ, a_{y}, a_{z}, etc., are large for those senses). In addition, the kernel unit vector, \vec{K}, may be dominated by inter-ego sense.

Therefore, the moral skew factor is typically going to be large if there is less conflict between the inter-ego and intra-ego senses, and vice versa. The mathematical modeling of this conflict herein is a novel, unifying psychoanalysis concept, with a moral sense sociologic concept and a self-interest moral sense.

Non-Diagonal Kernel Vector.

A new non-diagonal kernel vector as which may be based on non-diagonal coherency matrix, Rᵢⱼ, may be defined as:

$${R}_{ij} = \{ \begin{matrix}{T}_{ij} , & i \neq j \\ 0 , & i = j\end{matrix} \qquad ( 141 )$$

Then, the non-diagonal kernel vector, \vec{H}, has the form:

\vec{H}ᵢ=ŝᵢIᵢ+\hat{k}ᵢGᵢ (142)

where Gᵢ scalar has the form:

$${G}_{i} = {\sum }_{j = 1}^{N} {R}_{ij} \sqrt{{I}_{i} {I}_{j}} \qquad ( 143 )$$

This scalar is called a non-diagonal kernel.

Accordingly, in contrast to a diagonal kernel vector, the intensity scalar, Iᵢ, is attached to the ŝᵢ-unit vector, rather than to the \hat{k}ᵢ-unit vector. Therefore, the scalar product of \vec{S}ᵢ and \vec{H}ᵢ vectors, is

\vec{S}ᵢ·\vec{H}ᵢ=(ŝᵢIᵢ+\hat{k}ᵢGᵢ)(ŝᵢSᵢ)=IᵢSᵢ+GᵢSᵢ cos θᵢ (144)

and Eq. (139) is modified into the following equation:

$$〈 S 〉 = \frac{{\sum }_{i = 1}^{N} {{S}^{->}}_{i} \cdot {{H}^{->}}_{i}}{{\sum }_{i = 1}^{N} ( {I}_{i} + {G}_{i} cos {θ}_{i} )} = \frac{{\sum }_{i = 1}^{N} {S}_{i} ( {I}_{i} + {G}_{i} cos {θ}_{i} )}{{\sum }_{i = 1}^{N} ( {I}_{i} + {G}_{i} cos {θ}_{i} )} \qquad ( 145 )$$

This represents the parametric decision weighting average for the non-diagonal kernel case in accordance with several embodiments. According to Eq. (145) the weight satisfies the normalization condition.

Hybrid Case.

In such a case, elements of diagonal and non-diagonal kernel vector cases are combined. This may be accomplished by applying a weighted average of Eqs. (140) and (145).

7.7.7 Quantitative Analysis of the Moral Skew Factor

For clarity of description, the 2-D orthogonal base is considered. In this example, the base represents only two dimensions: the x-coordinate representing inter-ego moral sense; and the y-coordinate representing intra-ego moral sense. Then, the \hat{k}-unit vector is more inclined to the x-axis, while the ŝ-unit vector is more inclined to the y-axis, as shown in the example of FIG. 46. Assume that a parametric decision auxiliary vector, \vec{s}, has y-component, a_{y}′, 5-times larger than its x-vector component, aₓ′. Assume also that the kernel auxiliary vector, \vec{k}, has an x-component, b_{y}′, 3-times larger than its y-component, b_{y}′.

FIG. 46 is a diagram illustrating the value of such a moral skew factor. In this figure, for clarity of discussion, a whole inter-ego unit vector base has been reduced to single x-coordinate, representing group-interest moral senses (tastes). The same has been done for the intra-ego unit vector base, which has been reduced to single y-coordinate representing the self-interest moral tastes/senses such as power, libido, self-preservation, etc.

In the example shown in FIG. 46, the quantitative analysis of the moral skew factor is illustrated. This example includes auxiliary vector \vec{s} 7000 and auxiliary vector \vec{k} 7001. These auxiliary vectors \vec{s} and \vec{k} are parallel to unit vectors ŝ 7002 and \hat{k} 7003, respectively. The orthogonal base is shown in 2D space represented by unit vectors [symbol] 7004 and [symbol] 7005. Because vector 7000 is arbitrarily chosen to be only parallel to unit vector 7002, it can be assumed that: aₓ′=1 a_{y}′=5. Thus, its module (length) is \sqrt{(aₓ′)²+(a_{y}′)²}=\sqrt{1+25}=\sqrt{26}. Therefore the unit vector ŝ 7002 components are:

$$\hat{s} = ( {a}_{x} , {a}_{y} ) = ( \frac{1}{\sqrt{26}} , \frac{5}{\sqrt{26}} ) \qquad ( 146 )$$

Similarly, the auxiliary vector 7001 has a length \sqrt{(bₓ′)²+(b_{y}′)²}=\sqrt{36+4}=\sqrt{40}; and the unit vector \hat{k} 7003 has the following components:

$$\hat{k} = ( {b}_{x} , {b}_{y} ) = ( \frac{6}{\sqrt{40}} , \frac{2}{\sqrt{40}} ) \qquad ( 147 )$$

Therefore, the moral skew factor, cos(θ), where θ-angle is denoted by 7006, is

$$\begin{matrix}cos θ = \hat{s} \cdot \hat{k} \\ = {a}_{x} {b}_{x} + {a}_{y} {b}_{y} \\ = ( \frac{1}{\sqrt{26}} ) ( \frac{6}{\sqrt{40}} ) + ( \frac{5}{\sqrt{26}} ) ( \frac{2}{\sqrt{40}} ) \\ = ( 0.196 ) ( 0.969 ) ++ ( 0.98 ) ( 0.316 ) \\ = 0.186 + 0.31 + 0.496\end{matrix} \qquad ( 148 )$$

and the moral skew angle is: θ=60.3°.

As confirmation, it can be observed that, according to Eqs. (146) and (147), ŝ and \hat{k} are, indeed, unit vectors. For example, according to Eq. (147), the \hat{k}-vector length is

$$\vert \hat{k} \vert = \sqrt{\frac{36}{40} + \frac{4}{40}} = 1 \qquad ( 149 )$$

Section 8: Example Computer Program Product Embodiments

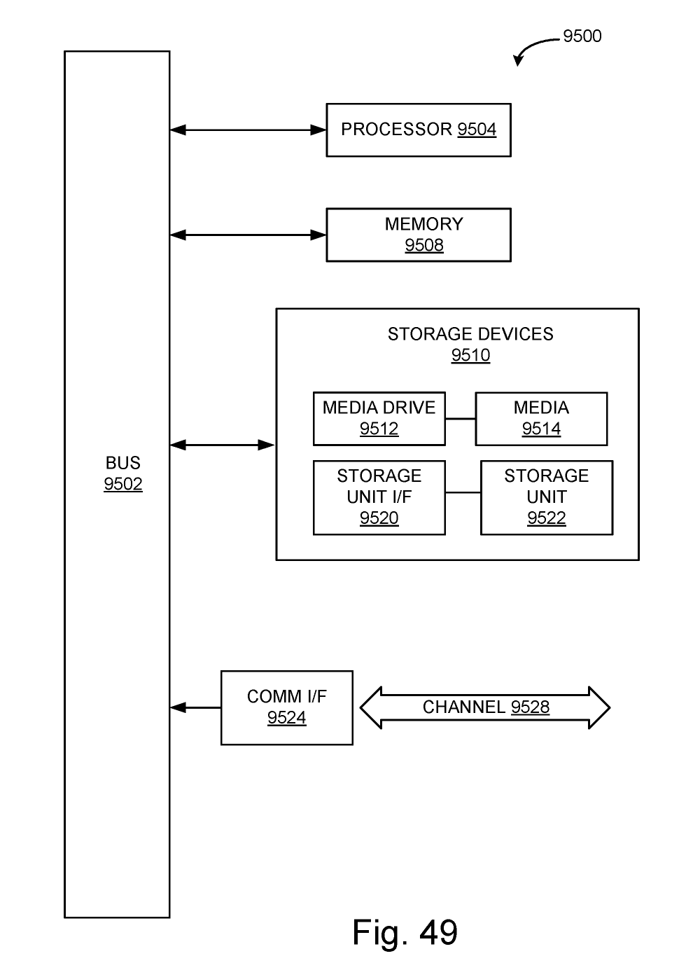

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 49. Various embodiments are described in terms of this example-computing module 9500. After reading this description, it will become apparent to a person skilled in the relevant art how to implement the invention using other computing modules or architectures.

Referring now to FIG. 49, computing module 9500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 9500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 9500 might include, for example, one or more processors, controllers, control modules, or other processing devices, such as a processor 9504. Processor 9504 might be implemented using a general-purpose or special-purpose processing engine such as, for example, a microprocessor, controller, or other control logic. In the illustrated example, processor 9504 is connected to a bus 9502, although any communication medium can be used to facilitate interaction with other components of computing module 9500 or to communicate externally.

Computing module 9500 might also include one or more memory modules, simply referred to herein as main memory 9508. For example, preferably random access memory (RAM) or other dynamic memory, might be used for storing information and instructions to be executed by processor 9504. Main memory 9508 might also be used for storing temporary variables or other intermediate information during execution of instructions to be executed by processor 9504. Computing module 9500 might likewise include a read only memory (“ROM”) or other static storage device coupled to bus 9502 for storing static information and instructions for processor 9504.

The computing module 9500 might also include one or more various forms of information storage mechanism 9510, which might include, for example, a media drive 9512 and a storage unit interface 9520. The media drive 9512 might include a drive or other mechanism to support fixed or removable storage media 9514. For example, a hard disk drive, a floppy disk drive, a magnetic tape drive, an optical disk drive, a CD or DVD drive (R or RW), or other removable or fixed media drive might be provided. Accordingly, storage media 9514 might include, for example, a hard disk, a floppy disk, magnetic tape, cartridge, optical disk, a CD or DVD, or other fixed or removable medium that is read by, written to or accessed by media drive 9512. As these examples illustrate, the storage media 9514 can include a computer usable storage medium having stored therein computer software or data.

In alternative embodiments, information storage mechanism 9510 might include other similar instrumentalities for allowing computer programs or other instructions or data to be loaded into computing module 9500. Such instrumentalities might include, for example, a fixed or removable storage unit 9522 and an interface 9520. Examples of such storage units 9522 and interfaces 9520 can include a program cartridge and cartridge interface, a removable memory (for example, a flash memory or other removable memory module) and memory slot, a PCMCIA slot and card, and other fixed or removable storage units 9522 and interfaces 9520 that allow software and data to be transferred from the storage unit 9522 to computing module 9500.

Computing module 9500 might also include a communications interface 9524. Communications interface 9524 might be used to allow software and data to be transferred between computing module 9500 and external devices. Examples of communications interface 9524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 9524 might typically be carried on signals, which can be electronic, electromagnetic (which includes optical) or other signals capable of being exchanged by a given communications interface 4924. These signals might be provided to communications interface 9524 via a channel 9528. This channel 9528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 9508, storage unit 9520, media 9514, and channel 9528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 9500 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A non-transitory computer readable medium storing one or more sequences of one or more instructions for execution by one or more processors in a processing system to perform a method for determining a dichotomy for a parametric decision process, the instructions when executed by the one or more processors, cause the one or more processors to perform the operations of:
defining a network having a plurality of members an inter-member coherency coupling represented by elements of a coherency matrix, wherein for each i^{th} member the network includes an intensity value, Iᵢ;
determining non-diagonal elements Tᵢⱼ of the coherency matrix in which i≠j and in which i and j represent i^{th} and j^{th} members of the network, respectively;
constructing diagonal kernels Kᵢ or non-diagonal kernels Hᵢ based on the non-diagonal elements Tᵢⱼ of the coherency matrix and intensity values (Iᵢ) of the members.

2. The non-transitory computer readable medium of claim 1, wherein for a given i^{th} member, defining a diagonal kernel vector as a function of its diagonal kernel vector Kᵢ and a unit vector [symbol] as:
\vec{K}ᵢ= [symbol] ·Kᵢ.

3. The non-transitory computer readable medium of claim 2, wherein \hat{k}ᵢ is given by:
\hat{k}ᵢ=bₓêₓ+b_{y}ê_{y}+b_{z}ê_{z}
in which

|êₓ|=|ê_{y}|=|ê_{z}|=1; êₓ·ê_{y}=0;
êₓ·ê_{z}=0; ê_{y}·ê_{z}=0 and
bₓ²+b_{y}²+b_{z}²=1.

4. The non-transitory computer readable medium of claim 2, wherein for the given i^{th} member, defining a parametric decision vector, \vec{Sᵢ}, as a function of parametric decision scalar Sᵢ, and unit vector, [symbol] , as:
\vec{S}ᵢ= [symbol] ·Sᵢ.

5. The non-transitory computer readable medium of claim 2, wherein [symbol] is given by:
ŝᵢ=aₓêₓ+a_{y}ê_{y}+a_{z}ê_{z}
in which

|êₓ|=|ê_{y}|=|ê_{z}|=1; êₓ·ê_{y}=0;
êₓ·ê_{z}=0; ê_{y}·ê_{z}=0 and
aₓ²+a_{y}²+a_{z}²=1.

6. The non-transitory computer readable medium of claim 4, wherein the operation further comprises determining a moral skew factor for the ith network member as cos θᵢ in which
\vec{Sᵢ}·\vec{Kᵢ}=SᵢKᵢ cos θᵢ.

7. The non-transitory computer readable medium of claim 1, wherein wherein the operations further comprise calculating a strength of diagonal kernels Kᵢ as:
$${K}_{i} = {\sum }_{j = 1}^{N} {T}_{ij} \sqrt{{I}_{i} {I}_{j}} .$$
In which Iⱼ is the intensity value of the j^{th} member of the network.

8. The non-transitory computer readable medium of claim 1, wherein the operations further comprise calculating a decision weighted mean, <S>, based on diagonal kernels Kᵢ as:
$$〈 S 〉 = \frac{{\sum }_{i = 1}^{N} {S}_{i} {K}_{i}}{{\sum }_{i = 1}^{N} {K}_{i}} .$$

9. The non-transitory computer readable medium of claim 1, wherein the operations further comprise calculating an i^{th}-weight as
$${w}_{i} = \frac{{K}_{i}}{{\sum }_{i = 1}^{N} {K}_{i}} ; 0 \leq {w}_{i} \leq 1 , and {\sum }_{i = 1}^{N} {w}_{i} = 1.$$

10. The non-transitory computer readable medium of claim 1, wherein the members comprise an individual, a high-value-individual candidate, or a group of interest.

11. The non-transitory computer readable medium of claim 1, wherein matrix elements are non-symmetrical, such that Tᵢⱼ≠Tⱼᵢ.

12. The non-transitory computer readable medium of claim 1, wherein Tij is defined as: Tii=1, and Tij≦1.

13. A non-transitory computer readable medium storing one or more sequences of one or more instructions for execution by one or more processors in a processing system to perform a method for determining a moral skew factor for a parametric decision process, the instructions when executed by the one or more processors, cause the one or more processors to perform the operations of:
defining a network having a plurality of members in which each member comprises an intra-ego influence including a first unit vector, \hat{k}, and an inter-ego influence including a second unit vector, ŝ, representing a member strength,
constructing first and second kernel vectors parallel to said first and second unit vectors, respectively;
computing an angle, θ, between the first and second kernel vectors; and
determining the moral skew factor as cos(θ).

14. The non-transitory computer readable medium of claim 13, further comprising determining an inter-member coherency coupling represented by elements of a coherency matrix, wherein each i^{th} member the network includes an intensity value, Iᵢ.

15. A non-transitory computer readable medium storing one or more sequences of one or more instructions for execution by one or more processors in a processing system to perform a method for determining a moral skew factor for a parametric decision process, the instructions when executed by the one or more processors, cause the one or more processors to perform the operations of:
defining a network having a plurality of members an inter-member coherency coupling represented by elements of a coherency matrix, wherein for each i^{th} member the network includes an intensity value, Iᵢ;
determining non-diagonal elements Rᵢⱼ of the coherency matrix in which i≠j and in which i and j represent i^{th} and j^{th} members of the network, respectively;
determining a non-diagonal pseudo-vector, \vec{G}ᵢ, for the i^{th} member;
determining a parametric decision vector, \vec{S}ᵢ, for the i^{th} member;
computing an angle, θ, between the non-diagonal pseudo-vector and parametric decision vector; and
determining the moral skew factor as cos(θ).

16. The method of claim 15, wherein the operations further comprise determining a projection of non-diagonal pseudo-vector, \vec{G}ᵢ, onto parametric decision vector, \vec{S}ᵢ, and computing a non-normalized weight of the parametric decision vector as a sum of the projection and the intensity Iᵢ for that member.

17. The method of claim 16, wherein the operations further comprise determining whether a member is a high-value member based on the moral skew factor and the non-normalized weight.
